(19) United States
(12) Patent Application Publication
(10) Pub. No.: US 2024/0334448 A1
(43) Pub. Date: Oct. 3, 2024

(54) METHOD AND APPARATUS FOR DETERMINING UNIFIED TRANSMISSION CONFIGURATION INDICATION IN NETWORK COOPERATIVE COMMUNICATION

(71) Applicant: Samsung Electronics Co., Ltd., Suwon-si (KR)

(72) Inventors: Youngrok JANG, Suwon-si (KR); Ameha Tsegaye ABEBE, Suwon-si (KR); Seongmok LIM, Suwon-si (KR); Hyoungju JI, Suwon-si (KR); Kyungjun CHOI, Suwon-si (KR)

(21) Appl. No.: 18/617,998

(22) Filed: Mar. 27, 2024

(30) Foreign Application Priority Data
Mar. 30, 2023 (KR) 10-2023-0042290

(51) Int. Cl. H04W 72/231; H04L 1/1812; H04W 72/1268; H04W 76/20

(52) U.S. Cl. CPC H04W 72/231; H04L 1/1812; H04W 72/1268; H04W 76/20

(57) ABSTRACT

The disclosure relates to a 5G or 6G communication system for supporting a higher data transmission rate. A method performed by a user equipment (UE) in a communication system is provided. The method includes receiving a medium access control (MAC) control element (CE), wherein the MAC CE maps transmission configuration indication (TCI) states to codepoints of a TCI field in downlink control information (DCI), receiving the DCI including the TCI field, and identifying, based on the MAC CE, whether at least one of a first TCI state of the UE and a second TCI state of the UE is updated by a codepoint of the TCI field in the received DCI, and in case that one of the first TCI state and the second TCI state is identified as updated by the codepoint, updating the one of the first TCI state and the second TCI state that is identified as updated by the codepoint, and keeping other of the first TCI state and the second TCI state that is identified as not updated by the codepoint.

### CROSS-REFERENCE TO RELATED APPLICATION(S)

This application is based on and claims priority under 35 U.S.C. § 119 (a) of a Korean patent application number 10-2023-0042290, filed on Mar. 30, 2023, in the Korean Intellectual Property Office, the disclosure of which is incorporated by reference herein in its entirety.

### BACKGROUND

### 1. Field

The disclosure relates to operations of a user equipment (UE) and a base station (BS) in a wireless communication system. More particularly, the disclosure relates to a method of determining a unified transmission configuration indicator in network cooperative communication and an apparatus for performing the same.

### 2. Description of Related Art

5^{th} generation (5G) mobile communication technologies define broad frequency bands such that high transmission rates and new services are possible, and can be implemented not only in “Sub 6 GHz” bands such as 3.5 GHz, but also in “Above 6 GHz” bands referred to as millimeter wave (mm Wave) including 28 GHz and 39 GHz. In addition, it has been considered to implement 6^{th} generation (6G) mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive multi input multi output (MIMO) for mitigating radio-wave path loss and increasing radio-wave transmission distances in mm Wave, supporting numerologies (for example, operating multiple subcarrier spacings) for efficiently utilizing mm Wave resources and dynamic operation of slot formats, initial access technologies for supporting multi-beam transmission and broadbands, definition and operation of BandWidth Part (BWP), new channel coding methods such as a Low Density Parity Check (LDPC) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical (PHY) layer standardization regarding technologies such as Vehicle-to-everything (V2X) for aiding driving determination by autonomous vehicles based on information regarding positions and states of vehicles transmitted by the vehicles and for enhancing user convenience, New Radio Unlicensed (NR-U) aimed at system operations conforming to various regulation-related requirements in unlicensed bands, new radio (NR) UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, Integrated Access and Backhaul (IAB) for providing a node for network service area expansion by supporting a wireless backhaul link and an access link in an integrated manner, mobility enhancement including conditional handover and Dual Active Protocol Stack (DAPS) handover, and two-step random access for simplifying random access procedures (2-step random access channel (RACH) for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting Augmented Reality (AR), Virtual Reality (VR), Mixed Reality (MR) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using Orbital Angular Momentum (OAM), and Reconfigurable Intelligent Surface (RIS), but also full-duplex technology for increasing frequency efficiency of 6G mobile communication technologies and improving system networks, AI-based communication technology for implementing system optimization by utilizing satellites and Artificial Intelligence (AI) from the design stage and internalizing end-to-end AI support functions, and next-generation distributed computing technology for implementing services at levels of complexity exceeding the limit of UE operation capability by utilizing ultra-high-performance communication and computing resources.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide an apparatus and a method of effectively providing services in a mobile communication system.

Additional aspects will be set forth in part in the description which follows and, in part, will be apparent from the description, or may be learned by practice of the presented embodiments.

In accordance with an aspect of the disclosure, a method performed by a user equipment (UE) in a communication system is provided. The method includes receiving a medium access control (MAC) control element (CE), wherein the MAC CE maps transmission configuration indication (TCI) states to codepoints of a TCI field in downlink control information (DCI), receiving the DCI including the TCI field, identifying, based on the MAC CE, whether at least one of a first TCI state of the UE and a second TCI state of the UE is updated by a codepoint of the TCI field in the received DCI, and in case that one of the first TCI state and the second TCI state is identified as updated by the codepoint, updating the one of the first TCI state and the second TCI state that is identified as updated by the codepoint, and keeping (or maintaining) other of the first TCI state and the second TCI state that is identified as not updated by the codepoint.

According to an embodiment of the disclosure, wherein each of the codepoints is mapped to (i) one TCI state for the one of the first TCI state and the second TCI state or (ii) two TCI states respectively for the first TCI state and the second TCI state.

According to an embodiment of the disclosure, wherein in case that the codepoint is mapped to one TCI state for the one of the first TCI state and the second TCI state, the one of the first TCI state and the second TCI state is updated as the one TCI state, and the other of the first TCI state and the second TCI state is kept (or maintained).

According to an embodiment of the disclosure, wherein the method further includes receiving, via higher layer signaling, a configuration of a unified TCI state type indicating joint or separate.

According to an embodiment of the disclosure, wherein in case that the configuration of unified TCI state type indicates joint, the TCI states are joint TCI states for uplink (UL) and downlink (DL) operation, and the first TCI state and the second TCI state are associated with the joint TCI states.

According to an embodiment of the disclosure, wherein in case that the configuration of unified TCI state type indicates separate, the TCI states include DL TCI states for the DL operation and UL TCI states for UL operation, the first TCI state is associated with the DL TCI states or the UL TCI states, and the second TCI state is associated with the DL TCI states or the UL TCI states.

According to an embodiment of the disclosure, wherein the method further includes transmitting a hybrid automatic repeat request acknowledgement (HARQ-ACK) for the DCI on a physical uplink control channel (PUCCH).

According to an embodiment of the disclosure, wherein updating the one of the first TCI state and the second TCI state and keeping (or maintaining) other of the first TCI state and the second TCI state are applied starting from a first slot that is at least symbols corresponding to a beam application time after a last symbol of the PUCCH.

In accordance with another aspect of the disclosure, a user equipment (UE) in a communication system is provided. The UE includes a transceiver, memory storing one or more computer programs, and one or more processors communicatively coupled to the transceiver, and the memory, wherein the one or more computer programs include computer-executable instructions that, when executed by the one or more processors, cause the UE to receive a medium access control (MAC) control element (CE), wherein the MAC CE maps transmission configuration indication (TCI) states to codepoints of a TCI field in downlink control information (DCI), receive the DCI including the TCI field, identify, based on the MAC CE, whether at least one of a first TCI state of the UE and a second TCI state of the UE is updated by a codepoint of the TCI field in the received DCI, and in case that one of the first TCI state and the second TCI state is identified as updated by the codepoint, update the one of the first TCI state and the second TCI state that is identified as updated by the codepoint, and keep (or maintain) other of the first TCI state and the second TCI state that is identified as not updated by the codepoint.

According to an embodiment of the disclosure, wherein each of the codepoints is mapped to (i) one TCI state for the one of the first TCI state and the second TCI state or (ii) two TCI states respectively for the first TCI state and the second TCI state.

According to an embodiment of the disclosure, wherein in case that the codepoint is mapped to one TCI state for the one of the first TCI state and the second TCI state, the one of the first TCI state and the second TCI state is updated as the one TCI state, and the other of the first TCI state and the second TCI state is kept (or maintained).

According to an embodiment of the disclosure, wherein the processor is further configured to receive, via higher layer signaling, a configuration of a unified TCI state type indicating joint or separate.

According to an embodiment of the disclosure, wherein in case that the configuration of unified TCI state type indicates joint, the TCI states are joint TCI states for uplink (UL) and downlink (DL) operation, and the first TCI state and the second TCI state are associated with the joint TCI states.

According to an embodiment of the disclosure, wherein in case that the configuration of unified TCI state type indicates separate, the TCI states include DL TCI states for the DL operation and UL TCI states for UL operation, the first TCI state is associated with the DL TCI states or the UL TCI states, and the second TCI state is associated with the DL TCI states or the UL TCI states.

According to an embodiment of the disclosure, wherein the processor is further configured to transmit a hybrid automatic repeat request acknowledgement (HARQ-ACK) for the DCI on a physical uplink control channel (PUCCH).

According to an embodiment of the disclosure, wherein updating the one of the first TCI state and the second TCI state and keeping (or maintaining) other of the first TCI state and the second TCI state are applied starting from a first slot that is at least symbols corresponding to a beam application time after a last symbol of the PUCCH.

In accordance with another aspect of the disclosure, a method performed by a base station in a communication system is provided. The method includes transmitting, to a user equipment (UE), a medium access control (MAC) control element (CE), wherein the MAC CE maps transmission configuration indication (TCI) states to codepoints of a TCI field in downlink control information (DCI), transmitting, to the UE, the DCI including the TCI field, and in case that one of a first TCI state of the UE and a second TCI state of the UE is updated by a codepoint of the TCI field in the transmitted DCI, updating the one of the first TCI state and the second TCI state that is updated by the codepoint, and keeping (or maintaining) other of the first TCI state and the second TCI state that is not updated by the codepoint.

According to an embodiment of the disclosure, wherein each of the codepoints is mapped to (i) one TCI state for the one of the first TCI state and the second TCI state or (ii) two TCI states respectively for the first TCI state and the second TCI state.

According to an embodiment of the disclosure, wherein in case that the codepoint is mapped to one TCI state for the one of the first TCI state and the second TCI state, the one of the first TCI state and the second TCI state is updated as the one TCI state, and the other of the first TCI state and the second TCI state is kept (or maintained).

According to an embodiment of the disclosure, wherein the method further includes transmitting, to the UE via higher layer signaling, a configuration of a unified TCI state type indicating joint or separate.

According to an embodiment of the disclosure, wherein in case that the configuration of unified TCI state type indicates joint, the TCI states are joint TCI states for uplink (UL) and downlink (DL) operation, and the first TCI state and the second TCI state are associated with the joint TCI states.

In accordance with another aspect of the disclosure, a base station in a communication system is provided. The base station includes a transceiver, memory storing one or more computer programs, and one or more processors communicatively coupled with the transceiver, and the memory, wherein the one or more computer programs include computer-executable instructions that, when executed by the one or more processors, cause the base station to transmit, to a user equipment (UE), a medium access control (MAC) control element (CE), wherein the MAC CE maps transmission configuration indication (TCI) states to codepoints of a TCI field in downlink control information (DCI), transmit, to the UE, the DCI including the TCI field, and in case that one of a first TCI state of the UE and a second TCI state of the UE is updated by a codepoint of the TCI field in the transmitted DCI, update the one of the first TCI state and the second TCI state that is updated by the codepoint, and keep (or maintain) other of the first TCI state and the second TCI state that is not updated by the codepoint.

According to an embodiment of the disclosure, wherein each of the codepoints is mapped to (i) one TCI state for the one of the first TCI state and the second TCI state or (ii) two TCI states respectively for the first TCI state and the second TCI state.

According to an embodiment of the disclosure, wherein in case that the codepoint is mapped to one TCI state for the one of the first TCI state and the second TCI state, the one of the first TCI state and the second TCI state is updated as the one TCI state, and the other of the first TCI state and the second TCI state is kept (or maintained).

According to an embodiment of the disclosure, wherein the processor is further configured to transmit, to the UE via higher layer signaling, a configuration of a unified TCI state type indicating joint or separate.

According to an embodiment of the disclosure, wherein in case that the configuration of unified TCI state type indicates joint, the TCI states are joint TCI states for uplink (UL) and downlink (DL) operation, and the first TCI state and the second TCI state are associated with the joint TCI states.

The above-described various embodiments of the disclosure are merely some of the preferred embodiments of the disclosure, and various embodiments reflecting the technical features of the disclosure may be derived and understood by those skilled in the art based on the following detailed description of the disclosure.

A disclosed embodiment provides an apparatus and a method of effectively providing services in a mobile communication system.

In accordance with another aspect of the disclosure, one or more non-transitory computer-readable storage media storing one or more computer programs including computer-executable instructions that, when executed by one or more processors of a user equipment (UE), cause the UE to perform operations are provided. The operations include receiving a medium access control (MAC) control element (CE), wherein the MAC CE maps transmission configuration indication (TCI) states to codepoints of a TCI field in downlink control information (DCI), receiving the DCI including the TCI field, identifying, based on the MAC CE, whether at least one of a first TCI state of the UE and a second TCI state of the UE is updated by a codepoint of the TCI field in the received DCI, and, in case that one of the first TCI state and the second TCI state is identified as updated by the codepoint, updating the one of the first TCI state and the second TCI state that is identified as updated by the codepoint, and keeping (or maintaining) other of the first TCI state and the second TCI state that is identified as not updated by the codepoint.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates a basic structure of a time-frequency domain in a wireless communication system according to an embodiment of the disclosure;

FIG. 2 illustrates a structure of frames, subframes, and slots in a wireless communication system according to an embodiment of the disclosure;

FIG. 3 illustrates an example of bandwidth part configuration in a wireless communication system according to an embodiment of the disclosure;

FIG. 4 illustrates an example of base station beam allocation according to TCI state configuration in a wireless communication system according to an embodiment of the disclosure;

FIG. 5 illustrates radio protocol structures of a base station and a UE in single cell, carrier aggregation (CA), and dual connectivity (DC) situations in a wireless communication system according to an embodiment of the disclosure;

FIG. 6 illustrates an example of a configuration of a control resource set of a downlink control channel in a wireless communication system according to an embodiment of the disclosure;

FIG. 7 illustrates the structure of a downlink control channel in a wireless communication system according to an embodiment of the disclosure;

FIG. 8 illustrates an example of a method for allocating a TCI state to a physical downlink control channel (PDCCH) in a wireless communication system according to an embodiment of the disclosure;

FIG. 9 illustrates a TCI indication MAC CE signaling structure for a PDCCH demodulation reference signal (DMRS) in a wireless communication system according to an embodiment of the disclosure;

FIG. 10 illustrates an example of beam configuration with regard to a control resource set and a search space in a wireless communication system according to an embodiment of the disclosure;

FIG. 11 illustrates an example of frequency domain resource allocation with regard to a physical downlink shared channel (PDSCH) in a wireless communication system according to an embodiment of the disclosure;

FIG. 12 illustrates an example of time domain resource allocation with regard to a PDSCH in a wireless communication system according to an embodiment of the disclosure;

FIG. 13 illustrates a process for beam configuration and activation with regard to a PDSCH according to an embodiment of the disclosure;

FIG. 14 illustrates a configuration of antenna ports and an example of resource allocation for cooperative communication in a wireless communication system according to an embodiment of the disclosure;

FIG. 15 illustrates an example for a configuration of downlink control information (DCI) for cooperative communication in a wireless communication system according to an embodiment of the disclosure;

FIG. 16 illustrates an enhanced PDSCH TCI state activation/deactivation MAC-CE format according to an embodiment of the disclosure;

FIG. 17 illustrates another MAC-CE format for activating and indicating a joint TCI state or a separate DL or UL TCI state in a wireless communication system according to an embodiment of the disclosure;

FIG. 18 illustrates a beam application time that can be considered when a unified TCI scheme is used in a wireless communication system according to an embodiment of the disclosure;

FIG. 19 illustrates another MAC-CE format for activating and indicating a plurality of joint TCI states or separate DL or UL TCI states in a wireless communication system according to an embodiment of the disclosure;

FIG. 20 illustrates another MAC-CE format for activating and indicating a plurality of joint TCI states or separate DL or UL TCI states in a wireless communication system according to an embodiment of the disclosure;

FIG. 21 illustrates another MAC-CE format for activating and indicating a plurality of joint TCI states or separate DL or UL TCI states in a wireless communication system according to an embodiment of the disclosure;

FIG. 22 illustrates another MAC-CE format for activating and indicating a plurality of joint TCI states or separate DL or UL TCI states in a wireless communication system according to an embodiment of the disclosure;

FIG. 23 illustrates a partial application method and an entire application method for multiple TCI state indications based on a unified TCI scheme in a wireless communication system according to an embodiment of the disclosure;

FIG. 24 illustrates an operation of the UE for a reset method when multiple TCI state indications based on a unified TCI scheme are partially applied in a wireless communication system according to an embodiment of the disclosure;

FIG. 25 illustrates an operation of the BS for a reset method when multiple TCI state indications based on a unified TCI scheme are partially applied in a wireless communication system according to an embodiment of the disclosure;

FIG. 26 illustrates the structure of a UE in a wireless communication system according to an embodiment of the disclosure; and

FIG. 27 illustrates the structure of a base station in a wireless communication system according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

For the same reason, in the accompanying drawings, some elements may be exaggerated, omitted, or schematically illustrated. Furthermore, the size of each element does not completely reflect the actual size. In the drawings, identical or corresponding elements are provided with identical reference numerals.

The advantages and features of the disclosure and ways to achieve them will be apparent by making reference to embodiments as described below in detail in conjunction with the accompanying drawings. However, the disclosure is not limited to the embodiments set forth below, but may be implemented in various different forms. The following embodiments are provided only to completely disclose the disclosure and inform those skilled in the art of the scope of the disclosure, and the disclosure is defined only by the scope of the appended claims. Throughout the specification, the same or like reference signs indicate the same or like elements. Furthermore, in describing the disclosure, a detailed description of known functions or configurations incorporated herein will be omitted when it is determined that the description may make the subject matter of the disclosure unnecessarily unclear. The terms which will be described below are terms defined in consideration of the functions in the disclosure, and may be different according to users, intentions of the users, or customs. Therefore, the definitions of the terms should be made based on the contents throughout the specification.

In the following description, a base station is an entity that allocates resources to terminals, and may be at least one of a gNode B, an eNode B, a Node B, a base station (BS), a wireless access unit, a base station controller, and a node on a network. A terminal may include a user equipment (UE), a mobile station (MS), a cellular phone, a smart phone, a computer, or a multimedia system capable of performing a communication functions. In the disclosure, a “downlink (DL)” refers to a radio link via which a base station transmits a signal to a terminal, and an “uplink (UL)” refers to a radio link via which a terminal transmits a signal to a base station. Furthermore, in the following description, long term evolution (LTE) or long term evolution advanced (LTE-A) systems may be described by way of example, but the embodiments of the disclosure may also be applied to other communication systems having similar technical backgrounds or channel types. Examples of such communication systems may include 5th generation mobile communication technologies (5G, new radio, and NR) developed beyond LTE-A, and in the following description, the “5G” may be the concept that covers the exiting LTE, LTE-A, and other similar services. Furthermore, based on determinations by those skilled in the art, the disclosure may be applied to other communication systems through some modifications without significantly departing from the scope of the disclosure.

Herein, it will be understood that each block of the flowchart illustrations, and combinations of blocks in the flowchart illustrations, can be implemented by computer program instructions. These computer program instructions can be provided to a processor of a general purpose computer, special purpose computer, or other programmable data processing apparatus to produce a machine, such that the instructions, which execute via the processor of the computer or other programmable data processing apparatus, create means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Furthermore, each block of the flowchart illustrations may represent a module, segment, or portion of code, which includes one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

As used in the embodiments of the disclosure, the “unit” refers to a software element or a hardware element, such as a Field Programmable Gate Array (FPGA) or an Application Specific Integrated Circuit (ASIC), which performs a predetermined function. However, the “unit” does not always have a meaning limited to software or hardware. The “unit” may be constructed either to be stored in an addressable storage medium or to execute one or more processors. Therefore, the “unit” includes, for example, software elements, object-oriented software elements, class elements or task elements, processes, functions, properties, procedures, sub-routines, segments of a program code, drivers, firmware, micro-codes, circuits, data, database, data structures, tables, arrays, and parameters. The elements and functions provided by the “unit” may be either combined into a smaller number of elements, or a “unit”, or divided into a larger number of elements, or a “unit”. Moreover, the elements and “units” or may be implemented to reproduce one or more central processing units (CPUs) within a device or a security multimedia card. Furthermore, the “unit” in the embodiments may include one or more processors.

A wireless communication system is advancing to a broadband wireless communication system for providing high-speed and high-quality packet data services using communication standards, such as high-speed packet access (HSPA) of third generation partnership project (3GPP), long-term evolution (LTE) or evolved universal terrestrial radio access (E-UTRA)}, LTE-Advanced (LTE-A), LTE-Pro, high-rate packet data (HRPD) of 3GPP2, ultra-mobile broadband (UMB), Institute of Electrical and Electronics Engineers (IEEE) 802.16e, and the like, as well as typical voice-based services.

As a typical example of the broadband wireless communication system, an LTE system employs an orthogonal frequency division multiplexing (OFDM) scheme in a downlink (DL) and employs a single carrier frequency division multiple access (SC-FDMA) scheme in an uplink (UL). The uplink indicates a radio link through which a user equipment (UE) (or a mobile station (MS)) transmits data or control signals to a base station (BS), and the downlink indicates a radio link through which the base station transmits data or control signals to the UE. The above multiple access scheme may separate data or control information of respective users by allocating and operating time-frequency resources for transmitting the data or control information for each user so as to avoid overlapping each other, that is, so as to establish orthogonality.

Since a 5G communication system, which is a post-LTE communication system, must freely reflect various requirements of users, service providers, and the like, services satisfying various requirements must be supported. The services considered in the 5G communication system include enhanced mobile broadband (eMBB) communication, massive machine-type communication (mMTC), ultra-reliability low-latency communication (URLLC), and the like.

eMBB aims at providing a data rate higher than that supported by existing LTE, LTE-A, or LTE-Pro. For example, in the 5G communication system, eMBB must provide a peak data rate of 20 Gbps in the downlink and a peak data rate of 10 Gbps in the uplink for a single base station. Furthermore, the 5G communication system must provide an increased user-perceived data rate to the UE, as well as the maximum data rate. In order to satisfy such requirements, transmission/reception technologies including a further enhanced multi-input multi-output (MIMO) transmission technique are required to be improved. In addition, the data rate required for the 5G communication system may be obtained using a frequency bandwidth more than 20 MHz in a frequency band of 3 to 6 GHz or 6 GHz or more, instead of transmitting signals using a transmission bandwidth up to 20 MHz in a band of 2 GHz used in LTE.

In addition, mMTC is being considered to support application services such as the Internet of Things (IoT) in the 5G communication system. mMTC has requirements, such as support of connection of a large number of UEs in a cell, enhancement coverage of Ues, improved battery time, a reduction in the cost of a UE, and the like, in order to effectively provide the Internet of Things. Since the Internet of Things provides communication functions while being provided to various sensors and various devices, it must support a large number of Ues (e.g., 1,000,000 Ues/km2) in a cell. In addition, the Ues supporting mMTC may require wider coverage than those of other services provided by the 5G communication system because the Ues are likely to be located in a shadow area, such as a basement of a building, which is not covered by the cell due to the nature of the service. The UE supporting mMTC must be configured to be inexpensive, and may require a very long battery life-time such as 10 to 15 years because it is difficult to frequently replace the battery of the UE.

Lastly, URLLC is a cellular-based mission-critical wireless communication service. For example, URLLC may be used for remote control for robots or machines, industrial automation, unmanned aerial vehicles, remote health care, emergency alert, and the like. Thus, URLLC must provide communication with ultra-low latency and ultra-high reliability. For example, a service supporting URLLC must satisfy an air interface latency of less than 0.5 ms, and also requires a packet error rate of 10-5 or less. Therefore, for the services supporting URLLC, a 5G system must provide a transmit time interval (TTI) shorter than those of other services, and also may require a design for assigning a large number of resources in a frequency band in order to secure reliability of a communication link.

The three 5G services, that is, eMBB, URLLC, and mMTC, may be multiplexed and transmitted in a single system. In this case, different transmission/reception techniques and transmission/reception parameters may be used between services in order to satisfy different requirements of the respective services. Of course, the 5G is not limited to the above-described three services.

In the following description, the term “a/b” may be understood as at least one of a and b.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a Wi-Fi chip, a Bluetooth® chip, a global positioning system (GPS) chip, a near field communication (NFC) chip, connectivity chips, a sensor controller, a touch controller, a finger-print sensor controller, a display drive integrated circuit (IC), an audio CODEC chip, a universal serial bus (USB) controller, a camera controller, an image processing IC, a microprocessor unit (MPU), a system on chip (SoC), an integrated circuit (IC), or the like.

### [NR Time-Frequency Resources]

Hereinafter, the frame structure of a 5G system will be described in more detail with reference to the accompanying drawings.

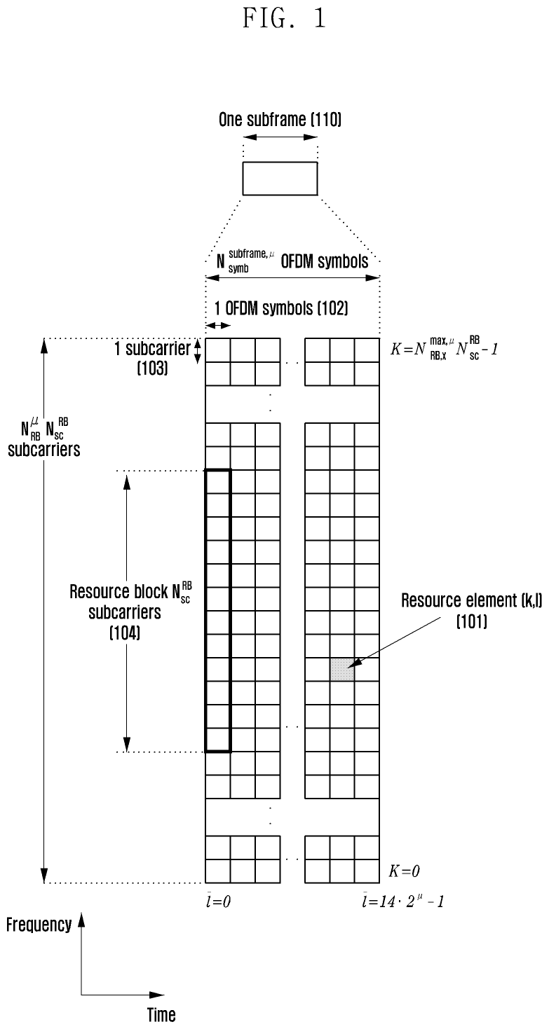

FIG. 1 illustrates the basic structure of a time-frequency domain, which is a radio resource domain used to transmit data or control channels in a 5G system according to an embodiment of the disclosure.

Referring to FIG. 1, the horizontal axis denotes a time domain, and the vertical axis denotes a frequency domain. The basic unit of resources in the time and frequency domains is a resource element (RE) 101, which may be defined as one orthogonal frequency division multiplexing (OFDM) symbol 102 along the time axis and one subcarrier 103 along the frequency axis. In the frequency domain, Nu (for example, 12) consecutive REs may constitute one resource block (RB) 104. In the time axis, one subframe 110 may include a plurality of OFDM symbols 102. For example, the length of one subframe may be 1 ms.

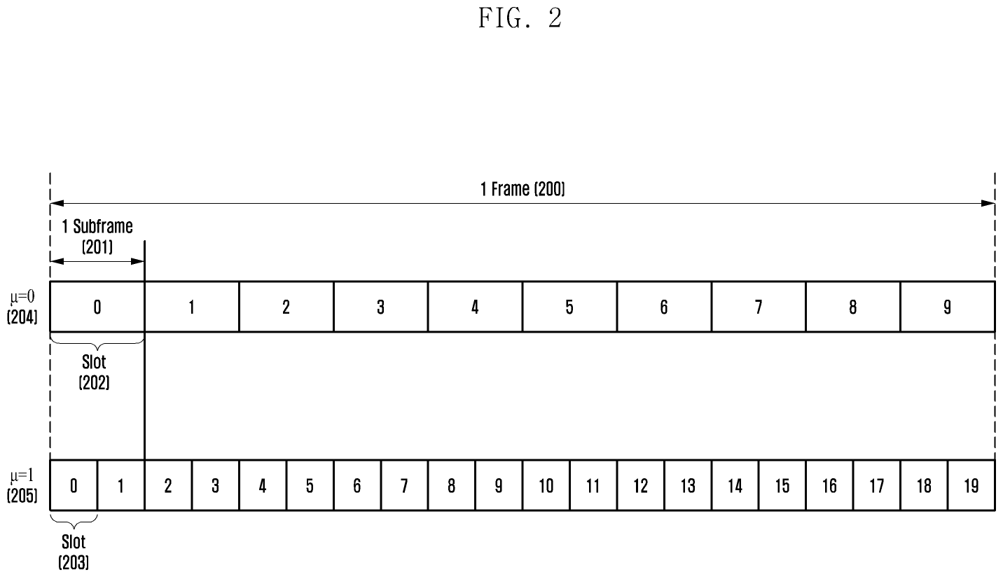

FIG. 2 illustrates the structure of frames, subframes, and slots in a wireless communication system according to an embodiment of the disclosure.

FIG. 2 illustrates an example of the structure of a frame 200, a subframe 201, and a slot 202. One subframe 201 may be defined as 1 ms. Therefore, one frame 200 may include a total of ten subframes 201. One slot 202 or 203 may be defined as 14 OFDM symbols (that is, the number of symbols per one slot N_{symb}^{slot}=14). One subframe 201 may include one slot or multiple slots 202 and 203. The number of slots 202 and 203 per one subframe 201 may differ depending on configuration values u 204 and 205 regarding the subcarrier spacing. The example in FIG. 2 illustrates a case in which the subcarrier spacing configuration value is μ=0 (204), and a case in which μ=1 (205). In the case of μ=0 (204), one subframe 201 may include one slot 202. In the case of μ=1 (205), one subframe 201 may include two slots 203. That is, the number of slots for one subframe (Nₛₗₒₜ^{subframe,μ}) may vary depending on the configuration value μ for a subcarrier spacing, and the number of slots for each frame (Nₛₗₒₜ^{frame,μ}) may vary according thereto. Nₛₗₒₜ^{subframe,μ} and Nₛₗₒₜ^{frame,μ} may be defined according to each subcarrier spacing configuration μ as in Table 1 below:

TABLE 1

| μ | N_{symb}^{slot} | Nₛₗₒₜ^{frame, μ} | Nₛₗₒₜ^{subframe, μ} |
|---|---|---|---|
| 0 | 14 | 10 | 1 |
| 1 | 14 | 20 | 2 |
| 2 | 14 | 40 | 4 |
| 3 | 14 | 80 | 8 |
| 4 | 14 | 160 | 16 |
| 5 | 14 | 320 | 32 |

### [Bandwidth Part (BWP)]

Next, bandwidth part (BWP) configuration in a 5G communication system will be described in detail with reference to the accompanying drawings.

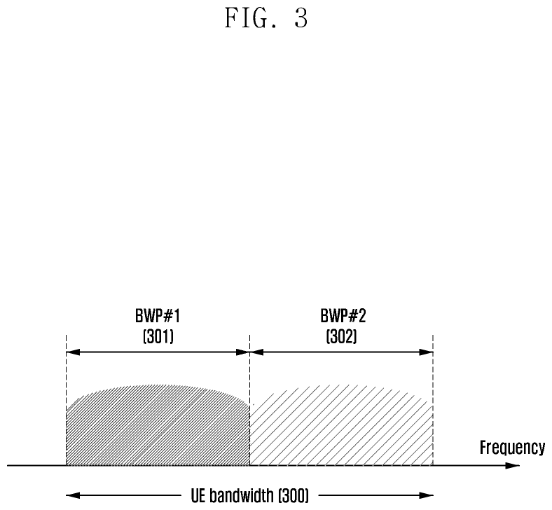

FIG. 3 illustrates an example of bandwidth part configuration in a wireless communication system according to an embodiment of the disclosure.

FIG. 3 illustrates an example in which a UE bandwidth 300 is configured to include two bandwidth parts, that is bandwidth part #1 (BWP #1) 301 and bandwidth part #2 (BWP #2) 302. A base station may configure one or multiple bandwidth parts for a UE, and may configure the following pieces of information with regard to each bandwidth part as given below in Table 1.

TABLE 2

| BWP ::= | SEQUENCE { |
|---|---|
| bwp-Id | BWP-Id, |
| (bandwidth part identifier) | |
| locationAndBandwidth | INTEGER (1..65536), |
| (bandwidth part location) | |
| subcarrierSpacing | ENUMERATED {n0, |
| n1, n2, n3, n4, n5}, | |
| (subcarrier spacing) | |
| cyclicPrefix | ENUMERATED |

```
{ extended }
      (cyclic prefix)
  }
```

Obviously, the above example is not limiting, and various parameters related to the bandwidth part may be configured for the UE, in addition to the above configuration information. The above pieces of information may be transferred from the base station to the UE through upper layer signaling, for example, radio resource control (RRC) signaling. One configured bandwidth part or at least one bandwidth part among multiple configured bandwidth parts may be activated. Whether or not to activate a configured bandwidth part may be semi-statically transferred from the base station to the UE through RRC signaling, or dynamically transferred through downlink control information (DCI).

According to some embodiment, the UE, prior to radio resource control (RRC) connection, may have an initial BWP for initial access configured by the base station through a master information block (MIB). To be more specific, the UE may receive configuration information regarding a control resource set (CORESET) and a search space which may be used to transmit a PDCCH for receiving system information (which may correspond to remaining system information (RMSI) or system information block 1 (SIB1) necessary for initial access through the MIB in the initial access step. The base station may notify the UE of configuration information, such as frequency assignment information, time assignment information, numerology, and the like, relating to control resource set #0 through an MIB. In addition, the base station may notify the UE of configuration information regarding the monitoring cycle and occasion regarding control resource set #0, that is, configuration information regarding control resource set #0, through the MIB. The UE may consider that a frequency domain configured by control resource set #0 acquired from the MIB is an initial bandwidth part for initial access. The identification (ID) of the initial bandwidth part may be considered to be 0.

The bandwidth part-related configuration supported by 5G may be used for various purposes.

According to some embodiments, if the bandwidth supported by the UE is smaller than the system bandwidth, this may be supported through the bandwidth part configuration. For example, the base station may configure the frequency location (configuration information 2) of the bandwidth part for the UE such that the UE can transmit/receive data at a specific frequency location within the system bandwidth.

In addition, according to some embodiments, the base station may configure multiple bandwidth parts for the UE for the purpose of supporting different numerologies. For example, in order to support a UE's data transmission/reception using both a subcarrier spacing of 15 kHz and a subcarrier spacing of 30 kHz, two bandwidth parts may be configured as subcarrier spacings of 15 kHz and 30 kHz, respectively. Different bandwidth parts may be subjected to frequency division multiplexing, and when data is to be transmitted/received at a specific subcarrier spacing, the bandwidth part configured as the corresponding subcarrier spacing may be activated.

In addition, according to some embodiments, the base station may configure bandwidth parts having different sizes of bandwidths for the UE for the purpose of reducing power consumed by the UE. For example, if the UE supports a substantially large bandwidth (for example, 100 MHz) and always transmits/receives data with the corresponding bandwidth, a substantially large amount of power consumption may occur. Particularly, it may be substantially inefficient from the viewpoint of power consumption to unnecessarily monitor the downlink control channel with a large bandwidth of 100 MHz in the absence of traffic. In order to reduce power consumed by the UE, the base station may configure a bandwidth part of a relatively small bandwidth, for example, a bandwidth part of 20 MHz, for the UE. The UE may perform a monitoring operation in the 20 MHz bandwidth part in the absence of traffic, and may transmit/receive data with the 100 MHz bandwidth part as instructed by the base station if data has occurred.

In connection with the bandwidth part configuring method, UEs, before being RRC-connected, may receive configuration information regarding the initial bandwidth part through a master information block (MIB) in the initial access step. To be more specific, a UE may have a control resource set (CORESET) configured for a downlink control channel which may be used to transmit downlink control information (DCI) for scheduling a system information block (SIB) from the MIB of a physical broadcast channel (PBCH). The bandwidth of the control resource set configured by the MIB may be considered as the initial bandwidth part, and the UE may receive, through the configured initial bandwidth part, a physical downlink shared channel (PDSCH) through which an SIB is transmitted. The initial bandwidth part may be used not only for the purpose of receiving the SIB, but also for other system information (OSI), paging, random access, or the like.

### [Bandwidth Part (BWP) Change]

If a UE has one or more bandwidth parts configured therefor, the base station may instruct to the UE to change (or switch) the bandwidth parts by using a bandwidth part indicator field inside DCI. As an example, if the currently activated bandwidth part of the UE is bandwidth part #1 301 in FIG. 3, the base station may indicate bandwidth part #2 302 with a bandwidth part indicator inside DCI, and the UE may change the bandwidth part to bandwidth part #2 302 indicated by the bandwidth part indicator inside received DCI.

As described above, DCI-based bandwidth part changing may be indicated by DCI for scheduling a PDSCH or a physical uplink shared channel (PUSCH), and a UE, upon receiving a bandwidth part change request, needs to be able to receive or transmit the PDSCH or PUSCH scheduled by the corresponding DCI in the changed bandwidth part with no problem. To this end, requirements regarding the delay time (TBWP) required during a bandwidth part change are specified standards, and may be defined, for example, as follows:

TABLE 3

BWP switch delay T_{BWP} (slots)

| μ | NR Slot length (ms) | Type 1^{Note 1} | Type 2^{Note 1} |
|---|---|---|---|
| 0 | 1 | 1 | 3 |
| 1 | 0.5 | 2 | 5 |
| 2 | 0.25 | 3 | 9 |
| 3 | 0.125 | 6 | 18 |

Note 1:
Depends on UE capability.
Note 2:
If the BWP switch involves changing of SCS, the BWP switch delay is determined by the larger one between the SCS before BWP switch and the SCS after BWP switch.

The requirements regarding the bandwidth part change delay time supports type 1 or type 2, depending on the capability of the UE. The UE may report the supportable bandwidth part delay time type to the base station.

If the UE has received DCI including a bandwidth part change indicator in slot n, according to the above-described requirement regarding the bandwidth part change delay time, the UE may complete a change to the new bandwidth part indicated by the bandwidth part change indicator at a timepoint not later than slot n+TBWP, and may transmit/receive a data channel scheduled by the corresponding DCI in the newly changed bandwidth part. If the base station wants to schedule a data channel by using the new bandwidth part, the base station may determine time domain resource allocation regarding the data channel in view of the UE's bandwidth part change delay time (TBWP). That is, when scheduling a data channel by using the new bandwidth part, the base station may schedule the corresponding data channel after the bandwidth part change delay time, in connection with the method for determining time domain resource allocation regarding the data channel. Accordingly, the UE may not expect that the DCI that indicates a bandwidth part change will indicate a slot offset (K0 or K2) value smaller than the bandwidth part change delay time (TBWP).

If the UE has received DCI (for example, DCI format 1_1 or 0_1) indicating a bandwidth part change, the UE may perform no transmission or reception during a time interval from the third symbol of the slot used to receive a PDCCH including the corresponding DCI to the start point of the slot indicated by a slot offset (K0 or K2) value indicated by a time domain resource allocation indicator field in the corresponding DCI. For example, if the UE has received DCI indicating a bandwidth part change in slot n, and if the slot offset value indicated by the corresponding DCI is K, the UE may perform no transmission or reception from the third symbol of slot n to the symbol before slot n+K (that is, the last symbol of slot n+K−1).

### [Regarding CA/DC]

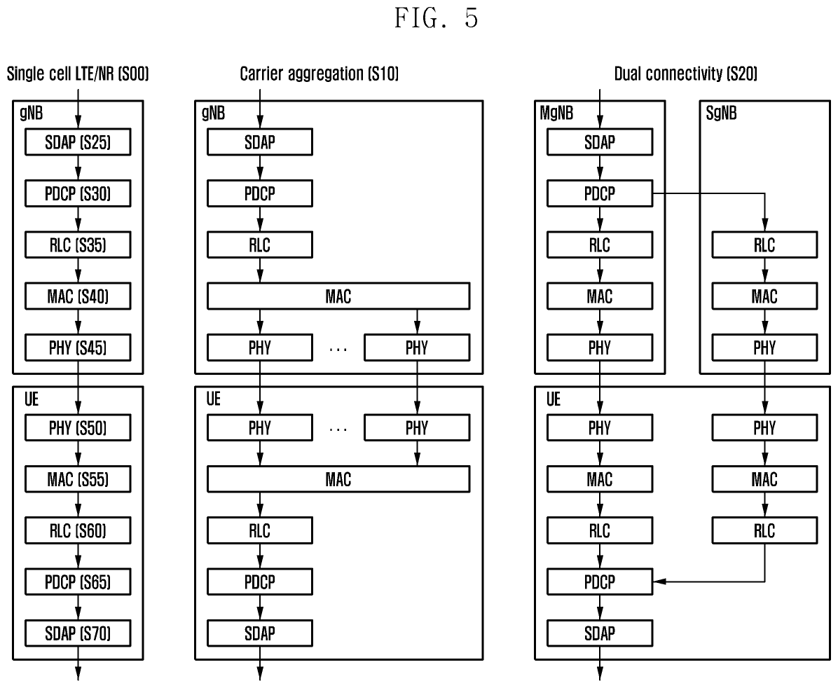

FIG. 5 illustrates radio protocol structures of a base station and a UE in single cell, carrier aggregation, and dual connectivity situations according to an embodiment of the disclosure.

Referring to FIG. 5, the radio protocol of a next-generation mobile communication system includes NR service data adaptation protocols (SDAPs) S25 and S70, NR packet data convergence protocols (PDCPs) S30 and S65, NR radio link controls (RLCs) S35 and S60, and NR medium access controls (MACs) S40 and S55, on UE and NR base stations sides, respectively.

Major functions of the NR SDAPs S25 and S70 may include some of the following functions:
Transfer of user plane data
Mapping between a quality of service (QOS) flow and a data radio bearer (DRB) for both DL and UL
Marking QoS flow ID in both DL and UL packets
Reflective QoS flow to DRB mapping for the UL SDAP protocol data units (PDUs)

With regard to the SDAP layer device, the UE may be configured, through an RRC message, whether to use the header of the SDAP layer device with regard to each PDCP layer device or with regard to each bearer or with regard to each logical channel, or whether to use functions of the SDAP layer device. If an SDAP header is configured, the non access stratum (NAS) QoS reflection configuration 1-bit indicator (NAS reflective QoS) of the SDAP header and the AS QoS reflection configuration 1-bit indicator (AS reflective QoS) thereof may be indicated such that the UE can update or reconfigure mapping information regarding the QoS flow and data bearer of the uplink and downlink. The SDAP header may include QoS flow ID information indicating the QoS. The QoS information may be used as data processing priority for providing efficient services, scheduling information, or the like.

Major functions of the NR PDCPs S30 and S65 may include some of the following functions:
Header compression and decompression: robust header compression (ROHC) only
Transfer of user data
In-sequence delivery of upper layer PDUs
Out-of-sequence delivery of upper layer PDUs
PDCP PDU reordering for reception
Duplicate detection of lower layer service data units (SDUs)
Retransmission of PDCP SDUs
Ciphering and deciphering

### Timer-Based SDU Discard in Uplink

The above-mentioned reordering function of the NR PDCP device refers to a function of reordering PDCP PDUs received from a lower layer in an order based on the PDCP sequence number (SN), and may include a function of transferring data to an upper layer in the reordered sequence. Alternatively, the reordering function of the NR PDCP device may include a function of instantly transferring data without considering the order, may include a function of recording PDCP PDUs lost as a result of reordering, may include a function of reporting the state of the lost PDCP PDUs to the transmitting side, and may include a function of requesting retransmission of the lost PDCP PDUs.

Major functions of the NR RLCs S35 and S60 may include some of the following functions:
Transfer of upper layer PDUs
In-sequence delivery of upper layer PDUs
Out-of-sequence delivery of upper layer PDUs
Error Correction through automatic repeat request (ARQ)
Concatenation, segmentation and reassembly of RLC SDUs
Re-segmentation of RLC data PDUs
Reordering of RLC data PDUs
Duplicate detection
Protocol error detection
RLC SDU discard
RLC re-establishment

The above-mentioned in-sequence delivery function of the NR RLC device refers to a function of successively delivering RLC SDUs received from the lower layer to the upper layer. The in-sequence delivery function of the NR RLC device may include a function of reassembling and delivering multiple RLC SDUs received, into which one original RLC SDU has been segmented, may include a function of reordering the received RLC PDUs with reference to the RLC sequence number (SN) or PDCP sequence number (SN), may include a function of recording RLC PDUs lost as a result of reordering, may include a function of reporting the state of the lost RLC PDUs to the transmitting side, and may include a function of requesting retransmission of the lost RLC PDUs. The in-sequence delivery function of the NR RLC device may include a function of, if there is a lost RLC SDU, successively delivering only RLC SDUs before the lost RLC SDU to the upper layer, and may include a function of, if a predetermined timer has expired although there is a lost RLC SDU, successively delivering all RLC SDUs received before the timer was started to the upper layer. Alternatively, the in-sequence delivery function of the NR RLC device may include a function of, if a predetermined timer has expired although there is a lost RLC SDU, successively delivering all currently received RLC SDUs to the upper layer. In addition, the RLC PDUs may be processed in the received order (regardless of the sequence number order, in the order of arrival) and delivered to the PDCP device regardless of the order (out-of-sequence delivery). In the case of segments, segments which are stored in a buffer, or which are to be received later, may be received, reconfigured into one complete RLC PDU, processed, and delivered to the PDCP device. The NR RLC layer may include no concatenation function, which may be performed in the NR MAC layer or replaced with a multiplexing function of the NR MAC layer.

The out-of-sequence delivery function of the NR RLC device refers to a function of instantly delivering RLC SDUs received from the lower layer to the upper layer regardless of the order, may include a function of reassembling and delivering multiple RLC SDUs received, into which one original RLC SDU has been segmented, and may include a function of storing the RLC SN or PDCP SN of received RLC PDUs, and recording RLC PDUs lost as a result of reordering.

The NR MACs S40 and S55 may be connected to multiple NR RLC layer devices configured in one UE, and major functions of the NR MACs may include some of the following functions:
Mapping between logical channels and transport channels
Multiplexing/demultiplexing of MAC SDUs
Scheduling information reporting
Error correction through hybrid automatic repeat request (HARQ)
Priority handling between logical channels of one UE
Priority handling between UEs by means of dynamic scheduling
MBMS service identification
Transport format selection
Padding

The NR PHY layers S45 and S50 may perform operations of channel-coding and modulating upper layer data, thereby obtaining OFDM symbols, and delivering the same through a radio channel, or demodulating OFDM symbols received through the radio channel, channel-decoding the same, and delivering the same to the upper layer.

The detailed structure of the radio protocol structure may be variously changed according to the carrier (or cell) operating scheme. As an example, assuming that the base station transmits data to the UE based on a single carrier (or cell), the base station and the UE use a protocol structure having a single structure with regard to each layer, such as S00. On the other hand, assuming that the base station transmits data to the UE based on carrier aggregation (CA) which uses multiple carriers in a single TRP, the base station and the UE use a protocol structure which has a single structure up to the RLC, such as S10, but multiplexes the PHY layer through a MAC layer. As another example, assuming that the base station transmits data to the UE based on dual connectivity (DC) which uses multiple carriers in multiple TRPs, the base station and the UE use a protocol structure which has a single structure up to the RLC, such as S20, but multiplexes the PHY layer through a MAC layer.

### [QCL, TCI State]

In a wireless communication system, one or more different antenna ports (which may be replaced with one or more channels, signals, and combinations thereof, but will be referred to as different antenna ports, as a whole, for convenience of description of the disclosure) may be associated with each other by a quasi-co-location (QCL) configuration as in Table 10 below. A TCI state is for publishing the QCL relation between a PDCCH (or a PDCCH DRMS) and another RS or channel. The description that a reference antenna port A (reference RS #A) and another target antenna port B (target RS #B) are QLCed with each other means that the UE is allowed to apply some or all of large-scale channel parameters estimated in the antenna port A to channel measurement form the antenna port B. The QCL is required to associate different parameters, such as 1) time tracking influenced by average delay and delay spread, 2) frequency tracking influenced by Doppler shift and Doppler spread, 3) radio resource management (RRM) influenced by an average gain, and 4) beam management (BM) influenced by a spatial parameter, according to situations. Accordingly, four types of QCL relations are supported in NR as in Table 4 below:

TABLE 4

| QCL type | Large-scale characteristics |
|---|---|
| A | Doppler shift, Doppler spread, |
| | average delay, delay spread |
| B | Doppler shift, Doppler spread |
| C | Doppler shift, average delay |
| D | Spatial Rx parameter |

The spatial RX parameter may refer to some or all of various parameters as a whole, such as angle of arrival (AoA), power angular spectrum (PAS) of AoA, angle of departure (AoD), PAS of AoD, transmit/receive channel correlation, transmit/receive beamforming, and spatial channel correlation.

The QLC relation may be configured for the UE through RRC parameter TCI-state and QCL-info as in Table 5 below. Referring to Table 5, the base station may configure one or more TCI states for the UE, thereby informing of a maximum of two kinds of QCL relations (qcl-Type1, qcl-Type2) regarding the RS that refers to the ID of the TCI state, that is, the target RS. Each piece of QCL information (QCL-Info) that each TCI state includes the serving cell index and the BWP index of the reference RS indicated by the corresponding QCL information, the type and ID of the reference BS, and a QCL type as in Table 4 above.

TABLE 5

| | |
|---|---|
| TCI-State ::= | SEQUENCE { |
| tci-StateId | TCI-StateId, |

(ID of corresponding TCI state)

| | |
|---|---|
| qcl-Type1 | QCL-Info, |

(QCL information of first refernece RS of RS (target RS) referring to
corresponding TCI state ID)

| | | |
|---|---|---|
| qcl-Type2 | QCL-Info | OPTIONAL, -- |

```
Need R
  (QCL information of second refernece RS of RS (target RS) referring to
corresponding TCI state ID)
  ...
}
```

| QCL-Info ::= | SEQUENCE { | |
|---|---|---|
| cell | ServCellIndex | OPTIONAL, -- Need R |

(serving cell index of reference RS indicated by corresponding QCL
information)

| | | |
|---|---|---|
| bwp-Id | BWP-Id | OPTIONAL, -- |

Cond CSI-RS-Indicated
(BWP index of reference RS indicated by corresponding QCL information)

| | |
|---|---|
| referenceSignal | CHOICE { |
| csi-rs | NZP-CSI-RS-ResourceId, |
| ssb | SSB-Index |

```
    (one of CSI-RS ID or SSB ID indicated by corresponding QCL information)
  },
```

| | |
|---|---|
| qcl-Type | ENUMERATED {typeA, typeB, typeC, |

typeD},
...
}

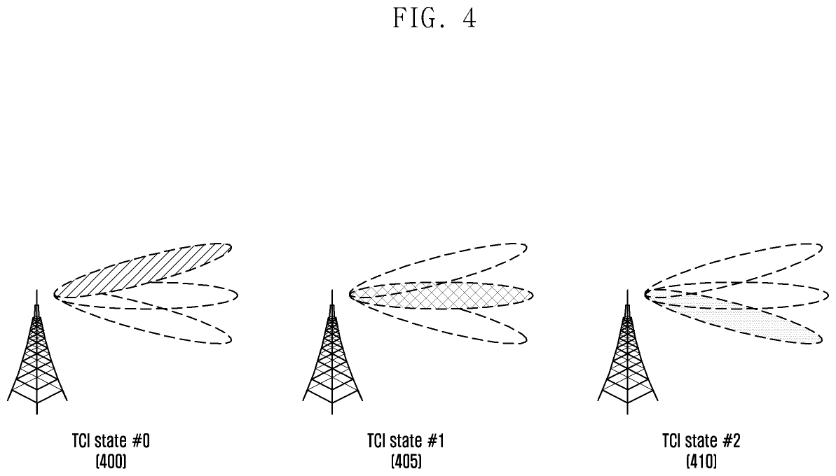

FIG. 4 illustrates an example of base station beam allocation according to TCI state configuration according to an embodiment of the disclosure.

Referring to FIG. 4, the base station may transfer information regarding N different beams to the UE through N different TCI states. For example, in the case of N=3 as in FIG. 4, the base station may configure qcl-Type2 parameters included in three TCI states 400, 405, and 410 in QCL type D while being associated with channel state information reference signals (CSI-RSs) or synchronization signal blocks (SSBs) corresponding to different beams, thereby notifying that antenna ports referring to the different TCI states 400, 405, and 410 are associated with different spatial Rx parameters (that is, different beams).

Tables 6 to 10 below enumerate valid TCI state configurations according to the target antenna port type.

Table 6 enumerates valid TCI state configurations when the target antenna port is a CSI-RS for tracking (TRS). The TRS refers to an NZP CSI-RS which has no repetition parameter configured therefor, and trs-Info of which is configured as “true”, among CRI-RSs. In Table 6, configuration no. 3 may be used for an aperiodic TRS.

TABLE 6
Valid TCI state configurations when the target
antenna port is a CSI-RS for tracking (TRS)

| Valid TCI | | | DL RS 2 | qcl-Type2 |
|---|---|---|---|---|
| state | | | (if | (if |
| Configuration | DL RS 1 | qcl-Type1 | configured) | configured) |
| 1 | SSB | QCL-TypeC | SSB | QCL-TypeD |
| 2 | SSB | QCL-TypeC | CSI-RS (BM) | QCL-TypeD |
| 3 | TRS | QCL-TypeA | TRS (same as | QCL-TypeD |
| | (periodic) | | DL RS 1) | |

Table 7 enumerates valid TCI state configurations when the target antenna port is a CSI-RS for CSI. The CSI-RS for CSI refers to an NZP CSI-RS which has no parameter indicating repetition (for example, repetition parameter) configured therefor, and trs-Info of which is not configured as “true”, among CRI-RSs.

TABLE 7
Valid TCI state configurations when the
target antenna port is a CSI-RS for CSI

| Valid | | | DL RS 2 | qcl-Type2 |
|---|---|---|---|---|
| TCI state | DL | | (if | (if |
| Configuration | RS 1 | qcl-Type 1 | configured) | configured) |
| 1 | TRS | QCL-TypeA | SSB | QCL-TypeD |
| 2 | TRS | QCL-TypeA | CSI-RS (BM) | QCL-TypeD |
| 3 | TRS | QCL-TypeA | TRS (same as | QCL-TypeD |
| | (periodic) | | DL RS 1) | |
| 4 | TRS | QCL-TypeB | | |

Table 8 enumerates valid TCI state configurations when the target antenna port is a CSI-RS for beam management (BM) (which has the same meaning as CSI-RS for L1 reference signal received power (RSRP) reporting). The CSI-RS for BM refers to an NZP CSI-RS which has a repetition parameter configured to have a value of “on” or “off”, and trs-Info of which is not configured as “true”, among CRI-RSs.

TABLE 8
Valid TCI state configurations when the target antenna
port is a CSI-RS for BM (for L1 RSRP reporting)

| Valid | | | DL RS 2 | qcl-Type2 |
|---|---|---|---|---|
| TCI state | DL | | (if | (if |
| Configuration | RS 1 | qcl-Type 1 | configured) | configured) |
| 1 | TRS | QCL-TypeA | TRS (same as | QCL-TypeD |
| | | | DL RS 1) | |
| 2 | TRS | QCL-TypeA | CSI-RS (BM) | QCL-TypeD |
| 3 | SS/PBCH | QCL-TypeC | SS/PBCH | QCL-TypeD |
| | Block | | Block | |

Table 9 enumerates valid TCI state configurations when the target antenna port is a PDCCH DMRS.

TABLE 9
Valid TCI state configurations when the
target antenna port is a PDCCH DMRS

| Valid | | | DL RS 2 | qcl-Type2 |
|---|---|---|---|---|
| TCI state | DL | | (if | (if |
| Configuration | RS 1 | qcl-Type 1 | configured) | configured) |
| 1 | TRS | QCL-TypeA | TRS (same as | QCL-TypeD |
| | | | DL RS 1) | |
| 2 | TRS | QCL-TypeA | CSI-RS (BM) | QCL-TypeD |
| 3 | CSI-RS | QCL-TypeA | CSI-RS (same as | QCL-TypeD |
| | (CSI) | | DL RS 1) | |

Table 10 enumerates valid TCI state configurations when the target antenna port is a PDSCH DMRS.

TABLE 10
Valid TCI state configurations when the
target antenna port is a PDSCH DMRS

| Valid | | | DL RS 2 | qcl-Type2 |
|---|---|---|---|---|
| TCI state | DL | | (if | (if |
| Configuration | RS 1 | qcl-Type 1 | configured) | configured) |
| 1 | TRS | QCL-TypeA | TRS | QCL-TypeD |
| 2 | TRS | QCL-TypeA | CSI-RS | QCL-TypeD |
| | | | (BM) | |
| 3 | CSI-RS | QCL-TypeA | CSI-RS | QCL-TypeD |
| | (CSI) | | (CSI) | |

According to a representative QCL configuration method based on Tables 6 to 10 above, the target antenna port and reference antenna port for each step are configured and operated such as “SSB”-> “TRS”-> “CSI-RS for CSI, or CSI-RS for BM, or PDCCH DMRS, or PDSCH DMRS”. Accordingly, it is possible to help the UE's receiving operation by associating statistical characteristics that can be measured from the SSB and TRS with respective antenna ports.

### [Unified TCI State]

Hereinafter, a method of indicating and activating a single TCI state based on a unified TCI scheme is described. The unified TCI scheme may be a scheme of unifying and managing a TCI state scheme used for uplink reception of a UE and a spatial relation info scheme used for uplink transmission in the conventional Rel-15 and 16 into a TCI state. Accordingly, when receiving an indication from a BS, based on the unified TCI scheme, the UE may perform beam management for uplink transmission by using the TCI state. If the UE receives a configuration of a TCI-State which is higher layer signaling having tci-stateId-r17 from the BS, the UE may perform an operation based on the unified TCI scheme by using the corresponding TCI-State. The TCI-State may exist in two forms such as a joint TCI state or a separate TCI state.

The first form is the joint TCI state, and the UE may receive an indication of TCI states to be applied to both uplink transmission and downlink transmission from the BS through one TCI-State. If the UE receives an indication of the joint TCI state-based TCI-State, the UE may receive an indication of a parameter to be used for downlink channel estimation by using an RS corresponding to qcl-Type1 and a parameter to be used as a downlink reception beam or reception filter by using an RS corresponding to qcl-Type2 within the corresponding joint TCI state-based TCI-State. If the UE receives an indication of the joint TCI state-based TCI-State, the UE may receive an indication of a parameter to be used as an uplink transmission beam or transmission filter by using an RS corresponding to qcl-Type2 within the corresponding joint DL/UL TCI state-based TCI-State. At this time, if the UE receives an indication of the joint TCI state, the UE may receive the application of the same beam to uplink transmission and downlink reception.

The second form is the separate TCI state, and the UE may individually receive indications of the UL TCI state to be applied to uplink transmission and the DL TCI state to be applied to downlink reception from the BS. If the UE receives an indication of the UL TCI state, the UE may receive an indication of a parameter to be used as an uplink transmission beam or transmission filter by using a reference RS or a source RS configured within the corresponding UL TCI state. If the UE receives an indication of the DL TCI state, the UE may receive an indication of a parameter to be used for downlink channel estimation by using an RS corresponding to qcl-Type1 and a parameter to be used as a downlink reception beam or reception filter by using an RS corresponding to qcl-Type2 configured within the corresponding DL TCI state.

If the UE receives indications of the DL TCI state and the UL TCI state together, the UE may receive an indication of a parameter to be used as an uplink transmission beam or transmission filter by using a reference RS or a source RS configured within the corresponding UL TCI state and receive an indication of a parameter to be used for downlink channel estimation by using an RS corresponding to qcl-Type1 and a parameter to be used as a downlink reception beam or reception filter by using an RS corresponding to qcl-Type2 configured within the corresponding DL TCI state. At this time, reference RSs or source RSs configured within the DL TCI state and the UL TCI state which the UE received are different, the UE may individually apply the beam to uplink transmission and downlink reception, based on the received UL TCI state and DL TCI state.

The UE may receive a configuration of a maximum of 128 joint TCI states for each specific bandwidth part within a specific cell from the BS through higher layer signaling, receive a configuration of a maximum of 64 or 128 DL TCI states in the separate TCI states for each specific cell or specific bandwidth part, based on a UE capability report, through higher layer signaling, and the DL TCI states in the separate TCI states and the joint TCI states may use the same higher layer signaling structure. For example, when 128 joint TCI states are configured and 64 DL TCI states in the separate TCI states are configured, the 64 DL TCI states may be included in the 128 joint TCI states.

In the separate TCI states, a maximum of 32 or 64 UL TCI states may be configured for each specific bandwidth part within a specific cell, based on a UE capability report, through higher layer signaling. Like the relationship between the DL TCI states of the separate TCI states and the joint TCI states, the UL TCI states of the separate TCI states and the joint TCI states may also use the same higher layer signaling structure, and the UL TCI states of the separate TCI states may use a higher layer signaling structure which is different from that of the joint TCI states and the DL TCI states of the separate TCI states.

As described above, using the same or different higher layer signaling structures may be defined in the standard, or may be identified through other higher layer signaling configured by the BS, based on a UE capability report containing information on a usage scheme that can be supported by the UE between two schemes.

The UE may receive a transmission/reception beam-related indication through a unified TCI scheme by using one scheme among the joint TCI states and the separate TCI states configured by the BS. The UE may receive a configuration indicating whether to use one of the joint TCI states and the separate TCI states from the BS through higher layer signaling.

The UE may receive a transmission/reception beam-related indication by using one scheme selected from the joint TCI states and the separate TCI states through higher layer signaling, in which case there are two methods of indicating a transmission/reception beam from the BS, such as a MAC-CE-based indication method and a MAC-CE-based activation and DCI-based indication method.

If the UE receives a transmission/reception beam-related indication by using the joint TCI state scheme through higher layer signaling, the UE may receive a MAC-CE indicating the joint TCI states from the BS and perform a transmission/reception beam application operation, and the BS may schedule reception for a PDSCH including the corresponding MAC-CE to the UE through a PDCCH. If the number of joint TCI states included in the MAC-CE is one, the UE may determine an uplink transmission beam or transmission filter and a downlink reception beam or reception filter by using the joint TCI state indicated from 3 ms after transmission of a PUCCH including HARQ-ACK information indicating whether the PDSCH including the corresponding MAC-CE has been successfully received. If the number of joint TCI states included in the MAC-CE is two or more, the UE may identify that a plurality of joint TCI states indicated by the MAC-CE corresponds to respective codepoints in a TCI state field of DCI format 1_1 or DCI format 1_2 from 3 ms after transmission of the PUCCH including HARQ-ACK information indicating whether the PDSCH including the corresponding MAC-CE has been successfully received, and activate the indicated joint TCI states. Thereafter, the UE may receive DCI format 1_1 or 1_2 and apply one joint TCI state indicated by the TCI state field within the corresponding DCI to the uplink transmission and downlink reception beams. At this time, DCI format 1_1 or 1_2 may include downlink data channel scheduling information (with DL assignment) or may not include the same (without DL assignment).

If the UE receives a transmission/reception beam-related indication by using the separate TCI state scheme through higher layer signaling, the UE may receive a MAC-CE indicating the separate TCI states from the BS and perform a transmission/reception beam application operation, and the BS may schedule reception for a PDSCH including the corresponding MAC-CE to the UE through a PDCCH. If the number of separate TCI state sets included in the MAC-CE is one, the UE may determine an uplink transmission beam or transmission filter and a downlink reception beam or reception filter by using the separate TCI states included in the separate TCI state sets from 3 ms after transmission of a PUCCH including HARQ-ACK information indicating whether the corresponding PDSCH has been successfully received. At this time, the separate TCI state sets may be a single or a plurality of separate TCI states that one codepoint in the TCI state field of DCI format 1_1 or 1_2 may have, and one separate TCI state set may include one DL TCI state, one UL TCI state, or one DL TCI state and one UL TCI state. If the number of separate TCI state sets included in the MAC-CE is two or more, the UE may identify that a plurality of separate TCI state sets indicated by the MAC-CE correspond to respective codepoints in the TCI state field of DCI format 1_1 or 1_2 from 3 ms after transmission of the PUCCH including HARQ-ACK information indicating whether the corresponding PDSCH has been successfully received, and activate the indicated separate TCI state sets. At this time, respective codepoints in the TCI state field of DCI format 1_1 or 1_2 may indicate one DL TCI state, one UL TCI state, or one DL TCI state and one UL TCI state. The UE may receive DCI format 1_1 or 1_2 and apply separate TCI state sets indicated by the TCI state field within the corresponding DCI to the uplink transmission and downlink reception beams. At this time, DCI format 1_1 or 1_2 may include downlink data channel scheduling information (with DL assignment) or may not include the same (without DL assignment).

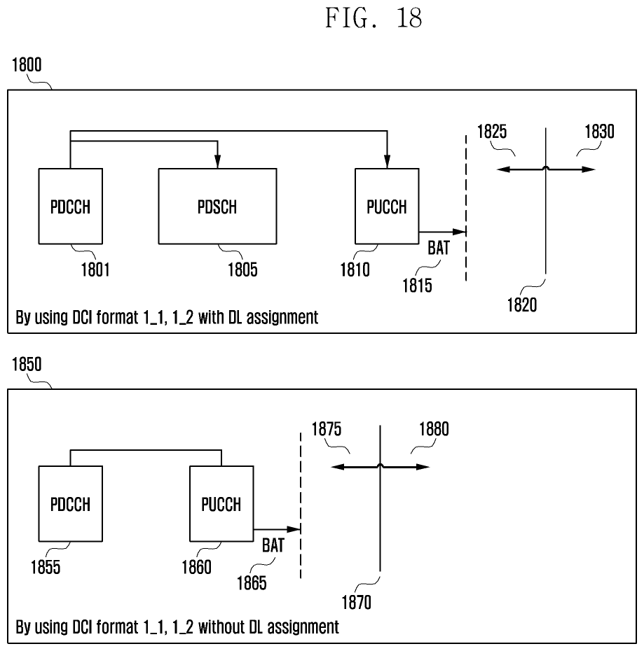

FIG. 18 illustrates a beam application time that can be considered when a unified TCI scheme is used in a wireless communication system according to an embodiment of the disclosure. As described above, the UE may receive DCI format 1_1 or 1_3 that includes downlink data channel scheduling information (with DL assignment) or does not include the same (without DL assignment) from the BS and apply one joint TCI state set or one separate TCI state set indicated by the TCI state field within the corresponding DCI to the update transmission and downlink reception beams.
DCI format 1_1 or 1_2 with DL assignment 1800: if the UE receives DCI format 1_1 or 1_2 including downlink data channel scheduling information from the BS as indicated by reference numeral 1801 and indicates one joint TCI state set or one separate TCI state set based on the unified TCI scheme, the UE may receive a PDSCH scheduled based on the received DCI as indicated by reference numeral 1805 and transmit a PUCCH including HARQ-ACK indicating whether the DCI and the PDSCH have been successfully received as indicated by reference numeral 1810. At this time, the HARQ-ACK may include information indicating whether the DCI has been successfully received and the PDSCH has been successfully received, and the UE may transmit NACK if one of the DCI and the PDSCH has not been received, and may transmit ACK if both of them have been successfully received.
DCI format 1_1 or 1_2 without DL assignment 1850: if the UE receives DCI format 1_1 or 1_2 that does not include downlink data channel scheduling information from the BS as indicated by reference numeral 1855 and indicates one joint TCI state set or one separate TCI state set based on the unified TCI scheme, the UE may assume a combination of at least one of the following matters for the corresponding DCI.

Cyclic redundancy check (CRC) scrambled using a CS-RSNTI is included.

Values of all bits allocated to all fields used as a redundancy version (RV) are 1.

Values of all bits allocated to all fields used as a modulation and coding scheme (MCS) field are 1.

Values of all bits allocated to all fields used as a new data indication (ND) field are 0.

Values of all bits allocated to an FDRA field are 0 in the case of frequency domain resource allocation (FDRA) type 0, values of all bits allocated to the FDRA field are 1 in the case of FDRA type 1, and values of all bits allocated to the FDRA field are 0 in the case wherein the FDRA type is dynamicSwitch.

The UE may transmit a PUCCH including HARQ-ACK indicating whether DCI format 1_1 or 1_2 in which the above-described matters are assumed has been successfully received as indicated by reference numeral 1860.
If a new TCI state indicated through DCI 1801 and 1855 is the same as the TCI state that was previously already indicated and is applied to uplink transmission and downlink reception beams for both DCI format 1_1 or 1_2 with DL assignment 1800 and DCI format 1_1 or 1_2 without DL assignment 1850, the UE may maintain the existing applied TCI state. If the new TCI state is different from the previously indicated TCI state, the UE may determine an application time point of a joint TCI state or separate TCI state set which can be indicated from a TCI state field included in the DCI as a time point 1830 or 1880 after an initial slot 1820 or 1870 after a beam application time (BAT) 1815 or 1865 from transmission of the PUCCH and use the previously indicated TCI-state until the time point 1825 or 1875 before the corresponding slot 1820 or 1870.
For both DCI format 1_1 or 1_2 with DL assignment 1800 and DCI format 1_1 or 1_2 without DL assignment 1850, the BAT is the specific number of OFDM symbols and may be configured through higher layer signaling based on UE capability report information, and numerology for the BAT and a first slot after the BAT may be determined based on the smallest numerology among all cells to which the joint TCI state or separate TCI state set indicated through the DCI is applied.

The UE may apply one joint TCI state indicated through the MAC-CE or the DCI to reception of resource control sets connected to all UE-specific search spaces, reception of a PDSCH scheduled by a PDCCH transmitted from the corresponding control resource sets, transmission of the PUSCH, and transmission of all PUCCH resources.

When one separate TCI state set indicated through the MAC-CE or the DCI includes one DL TCI state, the one separate TCI state set may be applied to reception of control resource sets connected to all UE-specific search spaces and reception of a PDSCH scheduled by a PDCCH transmitted from the corresponding control resource sets and may be applied to all PUSCH and PUCCH resources, based on the previously indicated UL TCI state.

When one separate TCI state set indicated through the MAC-CE or the DCI includes one UL TCI state, the one separate TCI state set may be applied to all PUSCH or PUCCH resources, and may be applied to reception of control resource sets connected to all UE-specific search spaces and reception of a PDSCH scheduled by a PDCCH transmitted from the corresponding control resource sets, based on the previously indicated DL TCI state.

When one separate TCI state set indicated through the MAC-CE or the DCI includes one DL TCI state and one UL TCI state, the DL TCI state may be applied to reception of control resource sets connected to all UE-specific search spaces and reception of a PDSCH scheduled by a PDCCH transmitted from the corresponding control resource sets, and the UL TCI state may be applied to all PUSCH and PUCCH resources.

### [Unified TCI State MAC-CE]

Hereinafter, a method of indicating and activating a single TCI state based on a unified TCI scheme is described. The UE may receive scheduling of a PDSCH including the following MAC-CE from the BS and analyze each codepoint in a TCI state field within DCI format 1_1 or 1_2 after three slots for transmitting HARQ-ACK for the corresponding PDSCH to the BS, based on information within the MAC-CE-received from the BS. That is, the UE may activate each entry of the MAC-CE received from the BS in each codepoint in the TCI state field within DCI format 1_1 or 1_2.

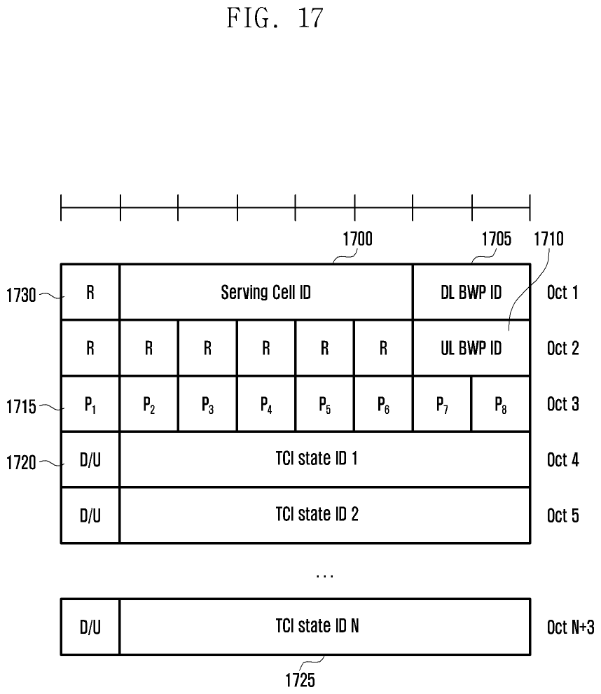

FIG. 17 illustrates another MAC-CE format for activating and indicating a joint TCI state or a separate DL or UL TCI state in a wireless communication system according to an embodiment of the disclosure. The meaning of each field within the corresponding MAC-CE format is described below.
Serving cell ID 1700: this field may indicate a service cell to which the corresponding MAC-CE is to be applied. The length of this field may be 5 bits. If the serving cell indicated by this field is included in one or more of simultaneousU-TCI-UpdateList1, simultaneousU-TCI-UpdateList2, simultaneousU-TCI-UpdateList3, or simultaneousU-TCI-UpdateList4 which is higher layer signaling, the corresponding MAC-CE may be applied to all serving cells included in a list of one or more of simultaneousU-TCI-UpdateList1, simultaneousU-TCI-UpdateList2, simultaneousU-TCI-UpdateList3, and simultaneousU-TCI-UpdateList4 including the serving cell indicated by this field.
DL BWP ID 1705: this field may indicate a DL BWP to which the corresponding MAC-CE is to be applied, and the meaning of each codepoint in this field may correspond to each codepoint of a bandwidth part indicator within DCI. The length of this field may be 2 bits.
UL BWP ID 1710: this field may indicate a UL BWP to which the corresponding MAC-CE is to be applied, and the meaning of each codepoint in this field may correspond to each codepoint of a bandwidth part indicator within DCI. The length of this field may be 2 bits.
Pᵢ 1715: this field may indicate whether each codepoint in the TCI state field within DCI format 1_1 or 1_2 has a plurality of TCI states or one TCI state. If a value of Pᵢ is 1, it may mean that an i^{th} codepoint has a plurality of TCI states, which may imply that the corresponding codepoint may include separate DL TCI states and separate UL TCI state. If a value of Pᵢ is 0, it may mean that an i^{th} codepoint has a single TCI state, which may imply that the corresponding codepoint may include one of the joint TCI state, the separate DCI TCI state, or the separate UL TCI state.
D/U 1720: this field may indicate whether a TCI state ID field within the same octet is a joint TCI state, a separate DL TCI state, or a separate UL TCI state. If this field is 1, the TCI state ID field within the same octet may be the joint TCI state or the separate DL TCI state and, if this field is 0, the TCI state ID field within the same octet may be the separate UL TCI state.
TCI state ID 1725: this field may indicate a TCI state that can be detected by a TCI-StateId corresponding to higher layer signaling. If a D/U field is configured as 1, this field may be used to express the TCI-StateId that can be expressed by 7 bits. If the D/U field is configured as 0, a most significant bit (MSB) of this field may be considered as being reserved, and the remaining 6 bits may be used to express the UL-TCIState-Id corresponding to higher layer signaling. The maximum of TCI states that can be activated may be 8 in the case of the joint TCI state and 16 in the case of the separate DL or UL TCI state.
R: indicates a reserved bit and may be configured as 0.

For the MAC-CE format in FIG. 17, the UE may insert a third octet including fields P₁, P₂, . . . , P₈ into the corresponding MAC-CE regardless of whether unifiedTCI-State Type-r17 in MIMOparam-r17 within ServingCellConfig corresponding to higher layer signaling is configured as joint or separate. In this case, the UE may perform TCI state activation by using the fixed MAC-CE format regardless of higher layer signaling configured by the BS. In another example, for the MAC-CE format in FIG. 17, when unifiedTCI-StateType-r17 in MIMOparam-r17 within ServingCellConfig corresponding to higher layer signaling is configured as joint, the UE may omit the third octet including the fields P₁, P₂, . . . , P₈ in FIG. 17. In this case, the UE may save a maximum of 8 bits of payload of the corresponding MAC-CE according to higher layer signaling configured by the BS. Further, all D/U fields located in first bits from the fourth octet in FIG. 17 may be configured as R fields, and all of the corresponding R fields may be configured as 0 bits.

### [PDCCH: Regarding DCI]

Next, downlink control information (DCI) in a 5G system will be described in detail.

In a 5G system, scheduling information regarding uplink data (or physical uplink shared channel (PUSCH)) or downlink data (or physical downlink shared channel (PDSCH)) is transferred from a base station to a UE through DCi. The UE may monitor, with regard to the PUSCH or PDSCH, a fallback DCI format and a non-fallback DCI format. The fallback DCI format may include a fixed field predefined between the base station and the UE, and the non-fallback DCI format may include a configurable field.

The DCI may be subjected to channel coding and modulation processes and then transmitted through a physical downlink control channel (PDCCH) after a channel coding and modulation process. A cyclic redundancy check is attached to the DCI message payload, and the CRC may be scrambled by a radio network temporary identifier (RNTI) corresponding to the identity of the UE. Different RNTIs may be used according to the purpose of the DCI message, for example, UE-specific data transmission, power control command, random access response, or the like. That is, the RNTI is not explicitly transmitted, but is transmitted while being included in a CRC calculation process. Upon receiving a DCI message transmitted through the PDCCH, the UE may identify the CRC by using the allocated RNTI. If the CRC identification result is right, the UE may know that the corresponding message has been transmitted to the UE.

For example, the DCI for scheduling a PDSCH regarding system information (SI) may be scrambled by an SI-RNTI. The DCI for scheduling a PDSCH regarding a random access response (RAR) message may be scrambled by an RA-RNTI. The DCI for scheduling a PDSCH regarding a paging message may be scrambled by a P-RNTI. The DCI for notifying of a slot format indicator (SFI) may be scrambled by an SFI-RNTI. DCI for notifying of transmit power control (TPC) may be scrambled by a TPC-RNTI. The DCI for scheduling a UE-specific PDSCH or PUSCH may be scrambled by a cell-RNTI (C-RNTI).

DCI format 0_0 may be used as fallback DCI for scheduling the PUSCH, and the CRC may be scrambled by a C-RNTI. DCI format 0_0 in which the CRC is scrambled by a C-RNTI may include, for example, the following pieces of information as given below in Table 11:

TABLE 11

| | |
|---|---|
| - | Identifier for DCI formats - [1] bit |
| - | Frequency domain resource assignment - |

[ ┌log₂ (N_{RB}^{DL,BWP}+ 1) / 2)┐ ] bits

| | |
|---|---|
| - | Time domain resource assignment - X bits |
| - | Frequency hopping flag - 1 bit. |
| - | Modulation and coding scheme - 5 bits |
| - | New data indicator - 1 bit |
| - | Redundancy version - 2 bits |
| - | HARQ process number - 4 bits |
| - | Transmit power control (TPC) command for scheduled PUSCH- |

[2] bits

| | |
|---|---|
| - | Uplink/supplementary uplink indicator (UL/SUL indicator) - 0 or |

1 bit

DCI format 0_1 may be used as non-fallback DCI for scheduling the PUSCH, and the CRC may be scrambled by a C-RNTI. DCI format 0_1 in which the CRC is scrambled by a C-RNTI may include, for example, the following pieces of information as given below in Table 12:

```
TABLE 12
  Carrier indicator - 0 or 3 bits
  UL/SUL indicator - 0 or 1 bit
  Identifier for DCI formats - [1] bits
  Bandwidth part indicator - 0, 1 or 2 bits
  Frequency domain resource assignment
    For resource allocation type 0, ┌N_{RB}^{UL,BWP}/P┐ bits
    For resource allocation type 1, ┌log₂(N_{RB}^{UL,BWP}(N_{RB}^{UL,BWP} + 1)/2)┐
    bits
  Time domain resource assignment -1, 2, 3, or 4 bits
  virtual resource block-to-physical resource block (VRB-to-PRB)
mapping - 0 or 1 bit, only for resource allocation type 1.
    0 bit if only resource allocation type 0 is configured;
    1 bit otherwise.
  Frequency hopping flag - 0 or 1 bit, only for resource allocation type 1.
    0 bit if only resource allocation type 0 is configured;
    1 bit otherwise.
  Modulation and coding scheme - 5 bits
  New data indicator - 1 bit
  Redundancy version - 2 bits
  HARQ process number - 4 bits
  1st downlink assignment index- 1 or 2 bits
    1 bit for semi-static HARQ-ACK codebook;
    2 bits for dynamic HARQ-ACK codebook with single HARQ-
    ACK codebook.
  2nd downlink assignment index - 0 or 2 bits
    2 bits for dynamic HARQ-ACK codebook with two HARQ-
    ACK sub-codebooks;
    0 bit otherwise.
  TPC command for scheduled PUSCH - 2 bits
  sounding reference signal (SRS) resource indicator -
$⌈ {log}_{2} ( {\sum }_{k = 1}^{{L}_{max}} ( \begin{matrix}{N}_{SRS} \\ k\end{matrix} ) ) ⌉ or ⌈ {log}_{2} ( {N}_{SRS} ) ⌉ bits$
    $⌈ {log}_{2} ( {\sum }_{k = 1}^{{L}_{max}} ( \begin{matrix}{N}_{SRS} \\ k\end{matrix} ) ) ⌉ bits for non ‐ codebook based PUSCH$  transmission;
  ┌log₂(N_{SRS})┐ bits for codebook based PUSCH transmission.
  Precoding information and number of layers-up to 6 bits
  Antenna ports - up to 5 bits
  SRS request - 2 bits
  CSI request - 0, 1, 2, 3, 4, 5, or 6 bits
  Code block group (CBG) transmission information - 0, 2, 4, 6, or 8 bits
  Phase tracking reference signal (PTRS)-demodulation reference signal
(DMRS) association- 0 or 2 bits.
  beta_offset indicator- 0 or 2 bits
  DMRS sequence initialization- 0 or 1 bit
```

DCI format 1_0 may be used as fallback DCI for scheduling the PDSCH, and the CRC may be scrambled by a C-RNTI. DCI format 1_0 in which the CRC is scrambled by a C-RNTI may include, for example, the following pieces of information as given below in Table 13:

TABLE 13

| | |
|---|---|
| - | Identifier for DCI formats - [1] bit |
| - | Frequency domain resource assignment - |

[ ┌log₂ (N_{RB}^{DL,BWP} (N_{RB}^{DL,BWP} + 1) / 2)┐ ] bits

| | |
|---|---|
| - | Time domain resource assignment - X bits |
| - | VRB-to-PRB mapping - 1 bit. |
| - | Modulation and coding scheme - 5 bits |
| - | New data indicator - 1 bit |
| - | Redundancy version - 2 bits |
| - | HARQ process number - 4 bits |
| - | Downlink assignment index - 2 bits |
| - | TPC command for scheduled PUCCH - [2] bits |
| - | Physical uplink control channel (PUCCH) resource indicator- 3 bits |
| - | PDSCH-to-HARQ feedback timing indicator- [3] bits |

DCI format 1_1 may be used as non-fallback DCI for scheduling the PDSCH, and the CRC may be scrambled by a C-RNTI. DCI format 1_1 in which the CRC is scrambled by a C-RNTI may include, for example, the following pieces of information as given below in Table 14:

TABLE 14
- Carrier indicator - 0 or 3 bits
- Identifier for DCI formats - [1] bits
- Bandwidth part indicator - 0, 1 or 2 bits
- Frequency domain resource assignment

| | |
|---|---|
| • | For resource allocation type 0, ┌N_{RB}^{DL,BWP} / P┐ bits |
| • | For resource allocation type 1, |
| | ┌log₂ (N_{RB}^{DL,BWP} + 1) / 2)┐ bits |

- Time domain resource assignment -1, 2, 3, or 4 bits
- VRB-to-PRB mapping - 0 or 1 bit, only for resource allocation type 1.

| | |
|---|---|
| • | 0 bit if only resource allocation type 0 is configured; |
| • | 1 bit otherwise. |

```
- PRB bundling size indicator - 0 or 1 bit
- Rate matching indicator - 0, 1, or 2 bits
- ZP CSI-RS trigger - 0, 1, or 2 bits
For transport block 1:
  - Modulation and coding scheme - 5 bits
  - New data indicator - 1 bit
  - Redundancy version - 2 bits
For transport block 2:
  - Modulation and coding scheme - 5 bits
  - New data indicator - 1 bit
  - Redundancy version - 2 bits
- HARQ process number - 4 bits
- Downlink assignment index - 0 or 2 or 4 bits
- TPC command for scheduled PUCCH - 2 bits
- PUCCH resource indicator - 3 bits
- PDSCH-to-HARQ_feedback timing indicator - 3 bits
- Antenna ports - 4, 5 or 6 bits
- Transmission configuration indication- 0 or 3 bits
- SRS request - 2 bits
- CBG transmission information - 0, 2, 4, 6, or 8 bits
- CBG flushing out information - 0 or 1 bit
- DMRS sequence initialization - 1 bit
```

### [PDCCH: CORESET, REG, CCE, Search Space]

Hereinafter, a downlink control channel in a 5G communication system will be described in more detail with reference to the accompanying drawings.

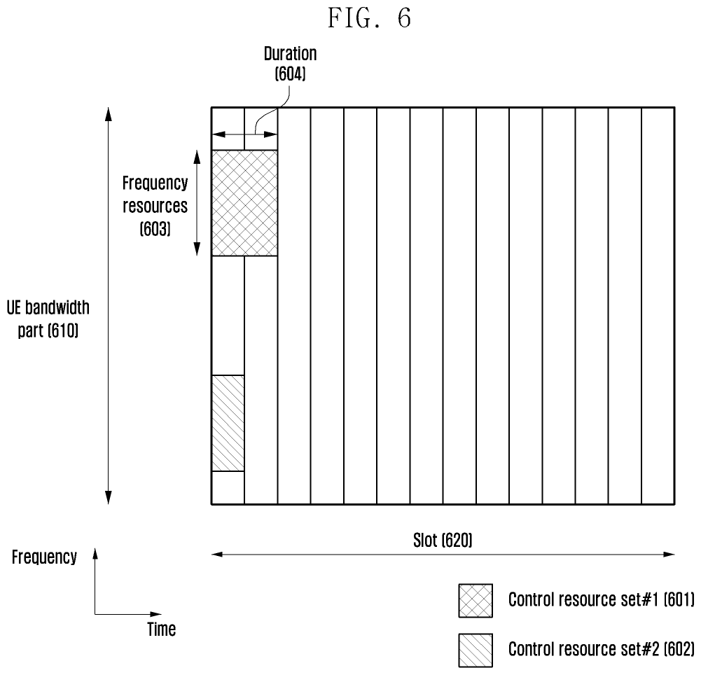

FIG. 6 illustrates an example of a control resource set (CORESET) used to transmit a downlink control channel in a 5G wireless communication system according to an embodiment of the disclosure. FIG. 6 illustrates an example in which a UE bandwidth part 610 is configured along the frequency axis, and two control resource sets (control resource set #1 601 and control resource set #2 602) are configured within one slot 620 along the time axis. The control resource sets 601 and 602 may be configured in a specific frequency resource 603 within the entire UE bandwidth part 610 along the frequency axis. One or multiple OFDM symbols may be configured along the time axis, and this may be defined as a control resource set duration 604. Referring to the example illustrated in FIG. 6, control resource set #1 601 is configured to have a control resource set duration corresponding to two symbols, and control resource set #2 602 is configured to have a control resource set duration corresponding to one symbol.

A control resource set in 5G described above may be configured for a UE by a base station through upper layer signaling (for example, system information, master information block (MIB), radio resource control (RRC) signaling). The description that a control resource set is configured for a UE means that information such as a control resource set identity, the control resource set's frequency location, and the control resource set's symbol duration is provided. For example, the control resource set may include the following pieces of information given in Table 15 below:

TABLE 15

| ControlResourceSet ::= | SEQUENCE { |
|---|---|
| -- Corresponds to L1 parameter ‘CORESET-ID’ | |
| controlResourceSetId | |
| ControlResourceSetId, | |
| (control resource set identity)) | |
| frequencyDomainResources | BIT STRING (SIZE |
| (45)), | |
| (frequency domain resource assignment information) | |
| duration | INTEGER |
| (1..maxCoReSetDuration), | |
| (time domain resource assignment information) | |
| cce-REG-MappingType | |
| CHOICE { | |
| (CCE-to-REG mapping type) | |
| interleaved | |
| SEQUENCE { | |
| reg-BundleSize | |
| ENUMERATED {n2, n3, n6}, | |
| (REG bundle size) | |
| precoderGranularity | |
| ENUMERATED {sameAsREG-bundle, allContiguousRBs}, | |
| interleaverSize | |
| ENUMERATED {n2, n3, n6} | |
| (interleaver size) | |
| shiftIndex | |
| INTEGER(0..maxNrofPhysicalResourceBlocks-1) | |
| OPTIONAL | |
| (interleaver shift) | |
| }, | |
| nonInterleaved | NULL |
| }, | |
| tci-StatesPDCCH | |
| SEQUENCE(SIZE (1..maxNrofTCI-StatesPDCCH)) OF TCI-StateId | |
| OPTIONAL, | |
| (QCL configuration information) | |
| tci-PresentInDCI | ENUMERATED |

{enabled}
OPTIONAL, -- Need S
}

In Table 15, tci-StatesPDCCH (simply referred to as transmission configuration indication (TCI) state) configuration information may include information of one or multiple synchronization signal (SS)/physical broadcast channel (PBCH) block index or channel state information reference signal (CSI-RS) index, which is quasi-co-located with a DMRS transmitted in a corresponding control resource set.

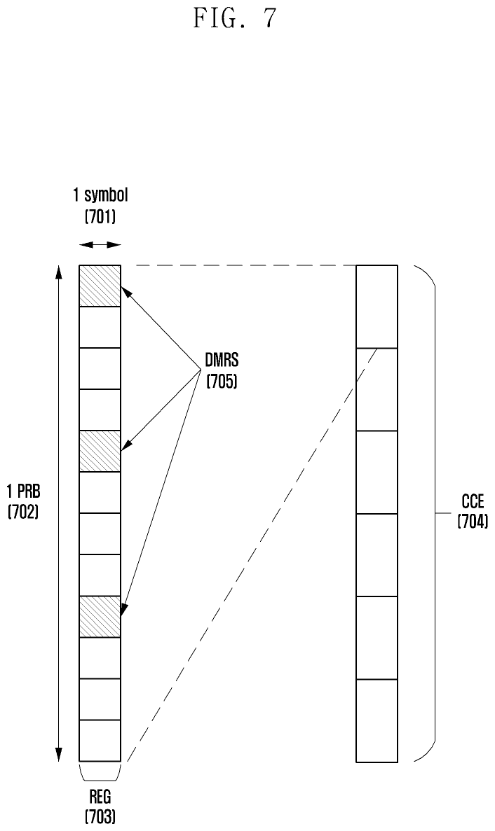

FIG. 7 illustrates an example of the basic unit of time and frequency resources constituting a downlink control channel available in 5G according to an embodiment of the disclosure.

Referring to FIG. 7, the basic unit of time and frequency resources constituting a control channel may be referred to as a resource element group (REG) 703, and the REG 703 may be defined by one OFDM symbol 701 along the time axis and one physical resource block (PRB) 702 (that is, 12 subcarriers) along the frequency axis. The base station may configure a downlink control channel allocation unit by concatenating the REGs 703.

Provided that the basic unit of downlink control channel allocation in 5G is a control channel element (CCE) 704 as illustrated in FIG. 7, one CCE 704 may include multiple REGs 703. A downlink control resource set, once configured, may include multiple CCEs 704, and a specific downlink control channel may be mapped to one or multiple CCEs 704 and then transmitted according to the aggregation level (AL) in the control resource set. The CCEs 704 in the control resource set are distinguished by numbers, and the numbers of CCEs 704 may be allocated according to a logical mapping scheme.

The basic unit of the downlink control channel illustrated in FIG. 7, that is, the REG 703 may include both REs to which DCI is mapped, and an area to which a reference signal (DMRS 705) for decoding the same is mapped. As in FIG. 7, three DRMSs 505 may be transmitted inside one REG 703. The number of CCEs necessary to transmit a PDCCH may be 1, 2, 4, 8, or 16 according to the aggregation level (AL), and different number of CCEs may be used to implement link adaptation of the downlink control channel. For example, in the case of AL=L, one downlink control channel may be transmitted through L CCEs. The UE needs to detect a signal while being no information regarding the downlink control channel, and a search space indicating a set of CCEs has thus been defined for blind decoding. The search space is a set of downlink control channel candidates including CCEs which the UE needs to attempt to decode at a given AL. Since 1, 2, 4, 8, or 16 CCEs constitute a bundle at various ALs, the UE may have multiple search spaces. A search space set may be defined as a set of search spaces at all configured ALs.

Search spaces may be classified into common search spaces and UE-specific search spaces. A group of UEs or all UEs may investigate a common search space of the PDCCH in order to receive cell-common control information such as a paging message or dynamic scheduling regarding system information. For example, PDSCH scheduling allocation information for transmitting an SIB including a cell operator information or the like may be received by investigating the common search space of the PDCCH. In the case of a common search space, a group of UEs or all UEs need to receive the PDCCH, and the same may thus be defined as a pre-promised set of CCEs. Scheduling allocation information regarding a UE-specific PDSCH or PUSCH may be received by investigating the UE-specific search space of the PDCCH. The UE-specific search space may be UE-specifically defined as a function of the UE identity and various system parameters.

In 5G, a parameter regarding a search parameter regarding a PDCCH may be configured for the UE by the base station through upper layer signaling (for example, SIB, MIB, RRC signaling). For example, the base station may configure the number of PDCCH candidates in each aggregation level L, monitoring periodicity for the search space, a monitoring occasion in units of symbols within the slot for the search space, the search space type (the common search space or the UE-specific search space), a combination of the DCI format and the RNTI to be monitored in the search space, the control resource set index for monitoring the search space, and the like for the UE. For example, the parameter may include the following pieces of information given in Table 16:

TABLE 16

| | |
|---|---|
| SearchSpace ::= | SEQUENCE { |

```
        -- Identity of the search space. SearchSpaceId = 0 identifies the
SearchSpace configured via PBCH (MIB) or ServingCellConfigCommon.
        searchSpaceId
  SearchSpaceId,
    (search space identity)
        controlResourceSetId
  ControlResourceSetId,
    (control resource set identity)
```

| | |
|---|---|
| monitoringSlotPeriodicityAndOffset | CHOICE { |

```
    (monitoring slot level cycle)
          sl1
  NULL,
          sl2
  INTEGER (0..1),
          sl4
  INTEGER (0..3),
          sl5
  INTEGER (0..4),
          sl8
  INTEGER (0..7),
          sl10
  INTEGER (0..9),
          sl16
  INTEGER (0..15),
          sl20
  INTEGER (0..19)
        }
```

| | |
|---|---|
| | OPTIONAL, |
| duration(monitoring duration) | INTEGER (2..2559) |
| monitoringSymbolsWithinSlot | BIT |

```
STRING (SIZE (14))
            OPTIONAL,
    (monitoirng symbols within slot)
        nrofCandidates
  SEQUENCE {
    (number of PDCCH candidates per aggregation level)
          aggregationLevel1
  ENUMERATED {n0, n1, n2, n3, n4, n5, n6, n8},
          aggregationLevel2
  ENUMERATED {n0, n1, n2, n3, n4, n5, n6, n8},
          aggregationLevel4
  ENUMERATED {n0, n1, n2, n3, n4, n5, n6, n8},
          aggregationLevel8
  ENUMERATED {n0, n1, n2, n3, n4, n5, n6, n8},
          aggregationLevel16
  ENUMERATED {n0, n1, n2, n3, n4, n5, n6, n8}
        },
        searchSpaceType
  CHOICE {
        (search space type)
          -- Configures this search space as common search space
(CSS) and DCI formats to monitor.
          common
  SEQUENCE {
        (common search space)
      }
          ue-Specific
  SEQUENCE {
        (UE-specific search space)
            -- Indicates whether the UE monitors in this USS for
DCI formats 0-0 and 1-0 or for formats 0-1 and 1-1.
            formats
        ENUMERATED {formats0-0-And-1-0, formats0-1-And-1-1},
            ...
          }
```

According to configuration information, the base station may configure one or multiple search space sets for the UE. According to some embodiments, the base station may configure search space set 1 and search space set 2 for the UE, may configure DCI format A scrambled by an a X-RNTI to be monitored in a common search space in search space set 1, and may configure DCI format B scrambled by a Y-RNTI to be monitored in a UE-specific search space in search space set 2.

According to configuration information, one or multiple search space sets may exist in a common search space or a UE-specific search space sets. For example, search space set #1 and search space set #2 may be configured as the common search space, and search space set #3 and search space set #4 may be configured as a UE-specific search space.

Combinations of DCI formats and RNTIs given below may be monitored in a common search space. Obviously, the example given below is not limiting.
DCI format 0_0/1_0 with CRC scrambled by C-RNTI, CS-RNTI, SP-CSI-RNTI, RA-RNTI, TC-RNTI, P-RNTI, SI-RNTI
DCI format 2_0 with CRC scrambled by SFI-RNTI
DCI format 2_01 with CRC scrambled by INT-RNTI
DCI format 2_2 with CRC scrambled by TPC-PUSCH-RNTI, TPC-PUCCH-RNTI
DCI format 2_03 with CRC scrambled by TPC-SRS-RNTI

Combinations of DCI formats and RNTIs given below may be monitored in a UE-specific search space. Obviously, the example given below is not limiting.
DCI format 0_0/1_0 with CRC scrambled by C-RNTI, CS-RNTI, TC-RNTI
DCI format 1_0/1_1 with CRC scrambled by C-RNTI, CS-RNTI, TC-RNTI

Enumerated RNTIs may follow the definition and usage given below:
Cell RNTI (C-RNTI): used to schedule a UE-specific PDSCH
Temporary cell RNTI (TC-RNTI): used to schedule a UE-specific PDSCH
Configured scheduling RNTI (CS-RNTI): used to schedule a semi-statically configured UE-specific PDSCH
Random access RNTI (RA-RNTI): used to schedule a PDSCH in a random access step
Paging RNTI (P-RNTI): used to schedule a PDSCH in which paging is transmitted
System information RNTI (SI-RNTI): used to schedule a PDSCH in which system information is transmitted
Interruption RNTI (INT-RNTI): used to indicate whether a PDSCH is punctured
Transmit power control for PUSCH RNTI (TPC-PUSCH-RNTI): used to indicate a power control command regarding a PUSCH
Transmit power control for PUCCH RNTI (TPC-PUCCH-RNTI): used to indicate a power control command regarding a PUCCH
Transmit power control for SRS RNTI (TPC-SRS-RNTI): used to indicate a power control command regarding an SRS

The DCI formats enumerated above may follow the definitions given in Table 17 below:

TABLE 17

| DCI format | Usage |
|---|---|
| 0_0 | Scheduling of PUSCH in one cell |
| 0_1 | Scheduling of PUSCH in one cell |
| 1_0 | Scheduling of PDSCH in one cell |
| 1_1 | Scheduling of PDSCH in one cell |
| 2_0 | Notifying a group of UEs of the slot format |
| 2_1 | Notifying a group of UEs of the PRB(s) and OFDM symbol(s) |
| | where UE may assume no transmission is intended for the UE |
| 2_2 | Transmission of TPC commands for PUCCH and PUSCH |
| 2_3 | Transmission of a group of TPC commands for SRS transmissions |
| | by one or more UEs |

In 5G, the search space at aggregation level L in connection with control resource set p and search space set s may be expressed by Equation 1 below:

$$L \cdot \{ ( {Y}_{p , {n}_{s f}^{μ}} + ⌊ \frac{{m}_{s , {n}_{CI}} \cdot {N}_{CCE , p}}{L \cdot {M}_{s , max}^{( L )}} ⌋ + {n}_{CI} ) mod ⌊ \frac{{N}_{CCE , p}}{L} ⌋ \} + i \qquad Equation 1$$

L: aggregation level
n_{CI}: carrier index
N_{CCE,p}: total number of CCEs existing in control resource set p
n_{s,f}^{μ}: slot index
M_{s,max}^{(L)}: number of PDCCH candidates at aggregation level L
m_{s,n}_{_{CI}}=0, . . . , M_{s,max}^{(L)}−1: PDCCH candidate index at aggregation level L
i=0, . . . , L−1
Y_{p,n}_{_{s,f}}_{^{μ}}=(Aₚ·Y_{p,n}_{_{s,f}}_{^{μ}})mod D, Yₚ₋₁=n_{RNTI}≠0, Aₚ=39827 for p mod 3=0, Aₚ=39829 for p mod 3=1, Aₚ=39839 for p mod 3=2, D=65537
n_{RNTI}: UE identity

The Y_{p,n}_{_{s,f}}_{^{μ}} value may correspond to 0 in the case of a common search space.

The Y_{p,n}_{_{s,f}}_{^{μ}} value may correspond to a value changed by the UE's identity (C-RNTI or ID configured for the UE by the base station) and the time index in the case of a UE-specific search space.

In 5G, multiple search space sets may be configured by different parameters (for example, parameters in Table 9), and the group of search space sets monitored by the UE at each timepoint may differ. For example, if search space set #1 is configured at by X-slot cycle, if search space set #2 is configured at by Y-slot cycle, and if X and Y are different, the UE may monitor search space set #1 and search space set #2 both in a specific slot, and may monitor one of search space set #1 and search space set #2 both in another specific slot.

### [PDCCH: Regarding TCI State]

Specific TCI state combinations applicable to a PDCCH DMRS antenna port are given in Table 18 below. The fourth row in Table 18 corresponds to a combination assumed by the UE before RRC configuration, and no configuration is possible after the RRC.

TABLE 18

| Valid | | | DL RS 2 | qcl-Type2 |
|---|---|---|---|---|
| TCI state | DL | | (if | (if |
| Configuration | RS 1 | qcl-Type 1 | configured) | configured) |
| 1 | TRS | QCL-TypeA | TRS | QCL-TypeD |
| 2 | TRS | QCL-TypeA | CSI-RS | QCL-TypeD |
| | | | (BM) | |
| 3 | CSI-RS | QCL-TypeA | | |
| | (CSI) | | | |
| 4 | SS/PBCH | QCL-TypeA | SS/PBCH | QCL-TypeD |
| | Block | | Block | |

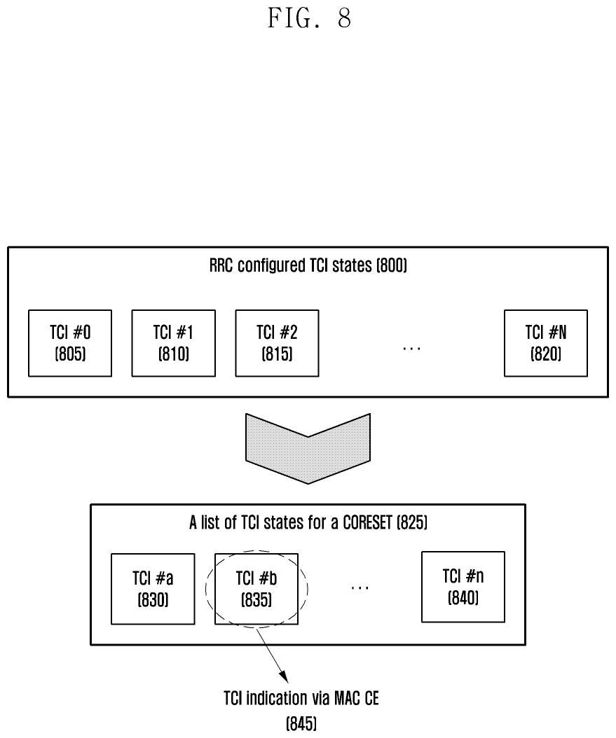

FIG. 8 illustrates an example of a method for allocating a TCI state to a PDCCH in a wireless communication system according to an embodiment of the disclosure.

Referring to FIG. 8, the base station may configure N TCI states 805, 810, 815, . . . , 820 for the UE through RRC signaling 800, and may configure some thereof as TCI states for a CORESET (825). The base station may then indicate one of the TCI states 830, 835, . . . and 840 for the CORESET to the UE through MAC CE signaling (845). The UE then receives a PDCCH, based on beam information included in the TCI state indicated by the MAC CE signaling.

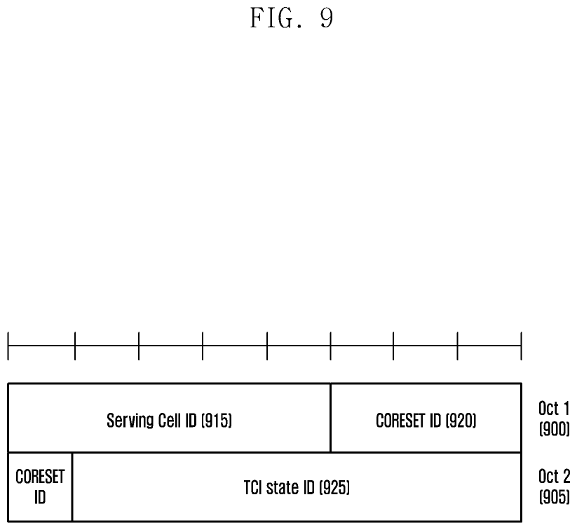

FIG. 9 illustrates a TCI indication MAC CE signaling structure for the PDCCH DMRS according to an embodiment of the disclosure.

Referring to FIG. 9, the TCI indication MAC CE signaling for the PDCCH DMRS is configured by 2 bytes (16 bits), and includes a 5-bit serving cell ID 915, a 4-bit CORESET ID 920, and a 7-bit TCI state ID 925 in octet 1 900 and octet 2 905.

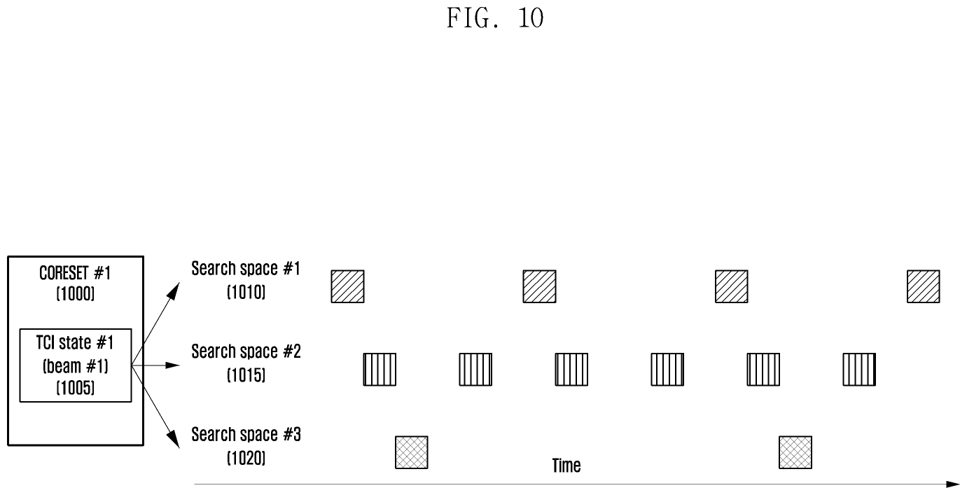

FIG. 10 illustrates an example of beam configuration with regard to a CORESET and a search space according to an embodiment of the disclosure.

Referring to FIG. 10, the base station may indicate one of TCI state lists included in CORESET 1000 configuration through MAC CE signaling (1005). Until a different TCI state is indicated for the corresponding CORESET through different MAC CE signaling, the UE considers that identical QCL information (beam #1) 1005 is all applied to one or more search spaces 1010, 1015, and 1020 connected to the CORESET. The above-described PDCCH beam allocation method has a problem in that it is difficult to indicate a beam change faster than MAC CE signaling delay, and the same beam is unilaterally applied to each CORESET regardless of search space characteristics, thereby making flexible PDCCH beam operation difficult. Following embodiments of the disclosure provide more flexible PDCCH beam configuration and operation methods. Although multiple distinctive examples will be provided for convenience of description of embodiments of the disclosure, they are not mutually exclusive, and can be combined and applied appropriately for each situation.

The base station may configure one or multiple TCI states for the UE with regard to a specific control resource set, and may activate one of the configured TCI states through a MAC CE activation command. For example, if {TCI state #0, TCI state #1, TCI state #2} are configured as TCI states for control resource set #1, the base station may transmit an activation command to the UE through a MAC CE such that TCI state #0 is assumed as the TCI state regarding control resource set #1. Based on the activation command regarding the TCI state received through the MAC CE, the UE may correctly receive the DMRS of the corresponding control resource set, based on QCL information in the activated TCI state.

With regard to a control resource set having a configured index of 0 (control resource set #0), if the UE has failed to receive a MAC CE activation command regarding the TCI state of control resource set #0, the UE may assume that the DMRS transmitted in control resource set #0 has been QCL-ed with a SS/PBCH block identified in the initial access process, or in a non-contention-based random access process not triggered by a PDCCH command.

With regard to a control resource set having a configured index value other than 0 (control resource set #X), if the UE has no TCI state configured regarding control resource set #X, or if the UE has one or more TCI states configured therefor but has failed to receive a MAC CE activation command for activating one thereof, the UE may assume that the DMRS transmitted in control resource set #X has been QCL-ed with a SS/PBCH block identified in the initial access process.

### [PDSCH: Regarding Frequency Resource Allocation]

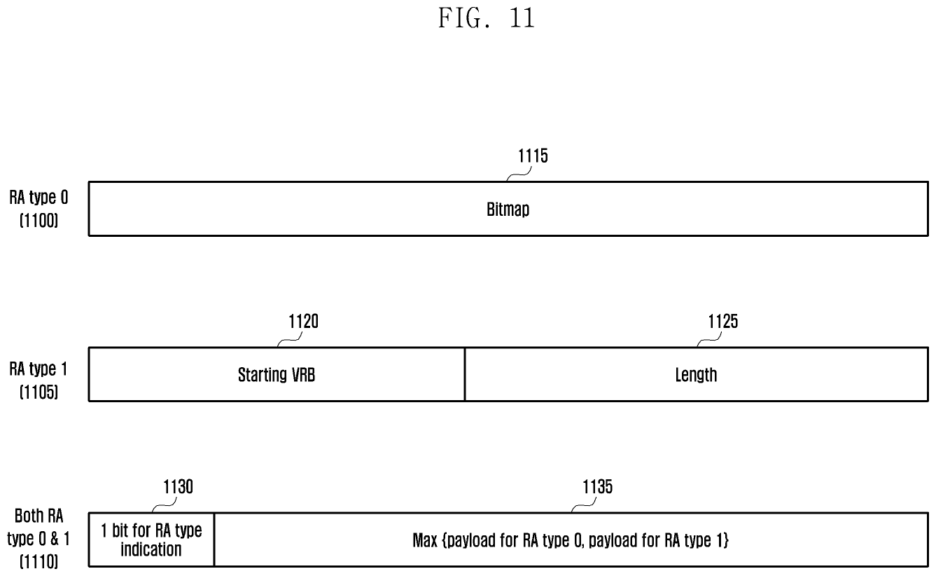

FIG. 11 illustrates an example of allocation of frequency-domain resources of a physical downlink shared channel (PDSCH) in a wireless communication system according to an embodiment of the disclosure.

FIG. 11 illustrates three frequency domain resource allocation methods of type 0 1100, type 1 1105, and dynamic switch 1110 which can be configured through an upper layer in an NR wireless communication system.

Referring to FIG. 11, in case that a UE is configured to use only resource type 0 through higher layer signaling (indicated by reference numeral 1100), some downlink control information (DCI) for allocating a PDSCH to the UE has a bitmap configured by NRBG bits. The conditions for this will be described later. As used herein, NRBG refers to the number of resource block groups (RBGs) determined according to the BWP size allocated by a BWP indicator and upper layer parameter rbg-Size, as in Table 19 below, and data is transmitted in RBGs indicated as “1” by the bitmap.

TABLE 19

| Bandwidth Part Size | Configuration 1 | Configuration 2 |
|---|---|---|
| 1-36 | 2 | 4 |
| 37-72 | 4 | 8 |
| 73-144 | 8 | 16 |
| 145-275 | 16 | 16 |

In the case 13-05 in which the UE is configured to use only resource type 1 through upper layer signaling, partial DCI includes frequency domain resource allocation information including ┌log₂(N_{RB}^{DL,BWP}(N_{RB}^{DL,BWP}+1)/2┐ bits. The conditions for this will be described again later. The base station may thereby configure a starting VRB 1120 and the length 1125 of a frequency domain resource allocated continuously therefrom.

In the case of the dynamic switch 1110 in which the UE is configured to use both resource type 0 and resource type 1 through upper layer signaling, partial DCI for allocating a PDSCH to the corresponding UE includes frequency domain resource allocation information including as many bits as the larger value 1135 between the payload 1115 for configuring resource type 0 and the payload 1120 and 1125 for configuring resource type 1. The conditions for this will be described again later. One bit may be added to the foremost part (MSB) 1130 of the frequency domain resource allocation information inside the DCI. If the bit has the value of “0”, use of resource type 0 may be indicated, and if the bit has the value of “1”, use of resource type 1 may be indicated.

### [PDSCH/PUSCH: Regarding Time Resource Allocation]

Hereinafter, a time domain resource allocation method for a data channel in the next-generation mobile communication system (the 5G or NR system) will be described.

The base station may configure a table about time domain resource allocation information for a downlink data channel (physical downlink shared channel (PDSCH)) and an uplink data channel (physical uplink shared channel (PUSCH)) for the UE through higher layer signaling (e.g., RRC signaling). A table including up to maxNrofDL-Allocations=16 entries may be configured for the PDSCH, and a table including up to maxNrofUL-Allocations=16 entries may be configured for the PUSCH. In an embodiment, the time domain resource allocation information may include PDCCH-to-PDSCH slot timing (corresponding to a slot-unit time interval between a timepoint at which a PDCCH is received and a timepoint at which a PDSCH scheduled by the received PDCCH is transmitted; labeled K0), PDCCH-to-PUSCH slot timing (corresponding to a slot-unit time interval between a timepoint at which a PDCCH is received and a timepoint at which a PUSCH scheduled by the received PDCCH is transmitted; labeled K2), information regarding the location and length of the start symbol by which a PDSCH or PUSCH is scheduled inside a slot, the mapping type of a PDSCH or PUSCH, and the like. For example, information such as in Table 20 or Table 21 below may be transmitted from the base station to the UE.

```
TABLE 20
    PDSCH-TimeDomainResourceAllocationList information element
    PDSCH-TimeDomainResourceAllocationList ::= SEQUENCE
(SIZE(1..maxNrofDL-Allocations)) OF PDSCH-TimeDomainResourceAllocation
    PDSCH-TimeDomainResourceAllocation ::= SEQUENCE
```

| | |
|---|---|
| k0 | INTEGER(0..32) |

```
  OPTIONAL, -- Need S
      (PDCCH-to-PDSCH timing, slot unit)
```

| | |
|---|---|
| mappingType | ENUMERATED {typeA, typeB}, |

(PDSCH mapping type)

| | |
|---|---|
| startSymbolAndLength | INTEGER (0..127) |

```
      (Start symbol and length of PDSCH)
    }
```

```
TABLE 21
    PUSCH-TimeDomainResourceAllocation information element
    PUSCH-TimeDomainResourceAllocationList ::= SEQUENCE
(SIZE(1..maxNrofUL-Allocations)) OF PUSCH-TimeDomainResourceAllocation
    PDSCH-TimeDomainResourceAllocation ::= SEQUENCE
```

| | |
|---|---|
| k2 | INTEGER(0..32) |

```
  OPTIONAL, -- Need S
      (PDCCH-to-PUSCH timing, slot unit)
```

| | |
|---|---|
| mappingType | ENUMERATED {typeA, typeB}, |

(PUSCH mapping type)

| | |
|---|---|
| startSymbolAndLength | INTEGER (0..127) |

```
      (Start symbol and length of PUSCH)
    }
```

The base station may notify the UE of one of the entries in the table for the time domain resource allocation information described above through L1 signaling (e.g., DCI) (for example, it may be indicated by a field “time domain resource allocation” in DCI). The UE may acquire time domain resource allocation information regarding a PDSCH or PUSCH, based on the DCI acquired from the base station.

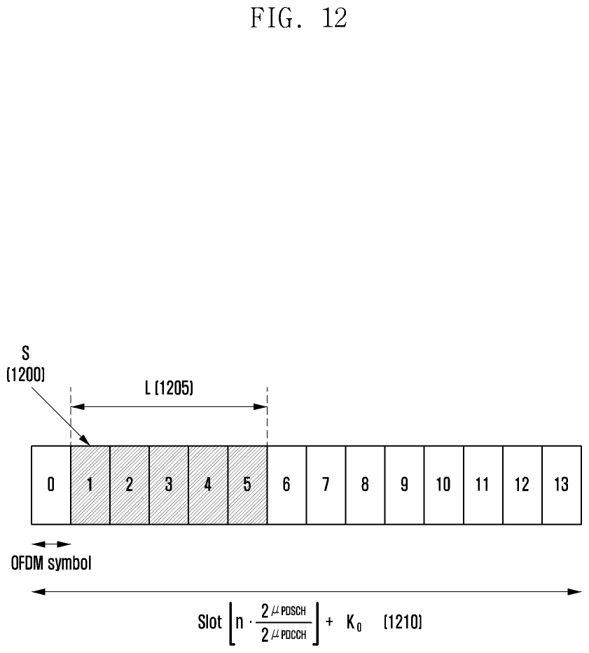

FIG. 12 illustrates an example of time domain resource allocation with regard to a PDSCH in a wireless communication system according to an embodiment of the disclosure.

Referring to FIG. 12, the UE may indicate the time domain location of a PDSCH resource according to the subcarrier spacing (SCS) (μPDSCH, μPDCCH) of a data channel and a control channel configured by using an upper layer, the scheduling offset (K0) value, and the start location 1200 and length 1205 of an OFDM symbol inside one slot 1210 dynamically indicated through DCI.

### [PDSCH: TCI State Activation MAC-CE]

A list of TCI states regarding a PDSCH may be indicated through an upper layer list such as RRC (1300). The list of TCI states may be indicated by tci-StatesToAddModList and/or tci-StatesToReleaseList inside a BWP-specific PDSCH-Config IE, for example. Next, a part of the list of TCI states may be activated through a MAC-CE (1320). Among the TCI states activated through the MAC-CE, a TCI state for a PDSCH may be indicated by DCI (1340). The maximum number of activated TCI states may be determined by the capability reported by the UE. Reference numeral 1350 illustrates an example of MAC-CE structure for PDSCH TCI state activation/deactivation.

The meaning of respective fields inside the MAC CE and values configurable for respective fields are as given in Table 22 below:

TABLE 22

| | |
|---|---|
| - | Serving Cell ID: This field indicates the identity of the Serving Cell for |
| | which the MAC CE applies. The length of the field is 5 bits. If the indicated |
| | Serving Cell is configured as part of a simultaneousTCI-UpdateList1 or |
| | simultaneousTCI-UpdateList2 as specified in TS 38.331 [5], this MAC CE |
| | applies to all the Serving Cells configured in the set simultaneousTCI- |
| | UpdateList1 or simultaneousTCI-UpdateList2, respectively; |
| - | BWP ID: This field indicates a DL BWP for which the MAC CE applies as |
| | the codepoint of the DCI bandwidth part indicator field as specified in TS |
| | 38.212 [9]. The length of the BWP ID field is 2 bits. This field is ignored if |
| | this MAC CE applies to a set of Serving Cells; |
| - | Tᵢ (TCI state ID): If there is a TCI state with TCI-StateId i as specified in TS |
| | 38.331 [5], this field indicates the activation/deactivation status of the TCI |
| | state with TCI-StateId i, otherwise MAC entity shall ignore the Ti field. The |
| | Ti field is set to 1 to indicate that the TCI state with TCI-StateId i shall be |
| | activated and mapped to the codepoint of the DCI Transmission |
| | Configuration Indication field, as specified in TS 38.214 [7]. The Ti field is |
| | set to 0 to indicate that the TCI state with TCI-StateId i shall be deactivated |
| | and is not mapped to the codepoint of the DCI Transmission Configuration |
| | Indication field. The codepoint to which the TCI State is mapped is |
| | determined by its ordinal position among all the TCI States with Ti field set |
| | to 1, i.e. the first TCI State with Tᵢ field set to 1 shall be mapped to the |
| | codepoint value 0, second TCI State with Ti field set to 1 shall be mapped to |
| | the codepoint value 1 and so on. The maximum number of activated TCI |
| | states is 8; |
| - | CORESET Pool ID: This field indicates that mapping between the activated |
| | TCI states and the codepoint of the DCI Transmission Configuration |
| | Indication set by field Ti is specific to the ControlResourceSetId configured |
| | with CORESET Pool ID as specified in TS 38.331 [5]. This field set to 1 |
| | indicates that this MAC CE shall be applied for the DL transmission |
| | scheduled by CORESET with the CORESET pool ID equal to 1, otherwise, |
| | this MAC CE shall be applied for the DL transmission scheduled by |
| | CORESET pool ID equal to 0. If the coresetPoolIndex is not configured for |
| | any CORESET, MAC entity shall ignore the CORESET Pool ID field in this |
| | MAC CE when receiving the MAC CE. If the Serving Cell in the MAC CE |
| | is configured in a cell list that contains more than one Serving Cell, the |
| | CORESET Pool ID field shall be ignored when receiving the MAC CE. |

### [Regarding UE Capability Report]

In LTE and NR, a UE may perform a procedure in which, while being connected to a serving base station, the UE reports capability supported by the UE to the corresponding base station. This will be referred to as a UE capability report in the following description.

The base station may transfer a UE capability enquiry message to the UE in a connected state so as to request a capability report. The message may include a UE capability request with regard to each radio access technology (RAT) type of the base station. The RAT type-specific request may include supported frequency band combination information and the like. In addition, in the case of the UE capability enquiry message, UE capability with regard to multiple RAT types may be requested through one RRC message container transmitted by the base station, or the base station may transfer a UE capability enquiry message including multiple UE capability requests with regard to respective RAT types. That is, multiple capability enquiries may be included in one message, and may configure a UE capability information message corresponding thereto and report the same multiple times. In next-generation mobile communication systems, a UE capability request may be made regarding multi-RAT dual connectivity (MR-DC), such as NR, LTE, E-UTRA-NR dual connectivity (EN-DC). In addition, the UE capability enquiry message is transmitted initially after the UE is connected to the base station, in general, but may be requested in any condition if needed by the base station.

Upon receiving the UE capability report request from the base station in the above step, the UE configures UE capability according to band information and RAT type required by the base station. The method in which the UE configures UE capability in an NR system is summarized below:

1. If the UE receives a list regarding LTE and/or NR bands from the base station at a UE capability request, the UE constructs band combinations (BCs) regarding EN-DC and NR standalone (SA). That is, the UE configures a candidate list of BCs regarding EN-DC and NR SA, based on bands received from the base station at a request through FreqBandList. In addition, bands have priority in the order described in FreqBandList.

2. If the base station has set “eutra-nr-only” flag or “eutra” flag and requested a UE capability report, the UE removes everything related to NR SA BCs from the configured BC candidate list. Such an operation may occur only if an LTE base station (evolved node B (eNB)) requests “eutra” capability.

3. The UE then removes fallback BCs from the BC candidate list configured in the above step. As used herein, a fallback BC refers to a BC that can be obtained by removing a band corresponding to at least one secondary cell (SCell) from a specific BC, and since a BC before removal of the band corresponding to at least one SCell can already cover a fallback BC, the same can be omitted. This step is applied in MR-DC as well, that is, LTE bands are also applied. BCs remaining after this step constitute the final “candidate BC list”.

4. The UE selects BCs appropriate for the requested RAT type from the final “candidate BC list” and selects BCs to report. In this step, the UE configures supportedBandCombinationList in a determined order. That is, the UE configures BCs and UE capability to report according to a preconfigured rat-Type order (nr->eutra-nr->eutra). In addition, the UE configures featureSetCombination regarding the configured supportedBandCombinationList and configures a list of “candidate feature set combinations” from a candidate BC list from which a list regarding fallback BCs (including capability of the same or lower step) is removed. The “candidate feature set combinations” include all feature set combinations regarding NR and EUTRA-NR BCS, and are obtainable from feature set combinations of containers of UE-NR-Capabilities and UE-MRDC-Capabilities.

5. In addition, if the requested RAT type is eutra-nr and has an influence, featureSetCombinations is included on both containers of UE-MRDC-Capabilities and UE-NR-Capabilities. However, the feature set of NR is included only in UE-NR-Capabilities.

After the UE capability is configured, the UE transfers a UE capability information message including the UE capability to the base station. The base stations performs scheduling and transmission/reception management appropriate for the UE, based on the UE capability received from the UE.

### [Related to NC-JT]

According to an embodiment of the disclosure, in order to receive a PDSCH from a plurality of TRPs, the UE may use non-coherent joint transmission (NC-JT).

Unlike the conventional system, the 5G wireless communication system supports not only a service requiring a high transmission rate but also both a service having a very short transmission delay and a service requiring a high connection density. In a wireless communication network including a plurality of cells, transmission and reception points (TRPs), or beams, cooperative communication (coordinated transmission) between respective cells, TRPs, or/and beams may satisfy various service requirements by increasing the strength of a signal received by the UE or efficiently controlling interference between the cells, TRPs, or/and beams.

Joint transmission (JT) is a representative transmission technology for the cooperative communication and may increase the strength of a signal received by the UE or throughput by transmitting signals to one UE through different cells, TRPs, or/and beams. At this time, a channel between each cell, TRP, or/and beam and the UE may have different characteristics, and particularly, non-coherent joint transmission (NC-JT) supporting non-coherent precoding between respective cells, TRPs, or/and beams may need individual precoding, MCS, resource allocation, and TCI indication according to the channel characteristics for each link between each cell, TRP, or/and beam and the UE.

The NC-JT may be applied to at least one of a downlink data channel (PDSCH), a downlink control channel (PDCCH), an uplink data channel (PUSCH), and an uplink control channel (PUCCH). In PDSCH transmission, transmission information such as precoding, MCS, resource allocation, and TCI may be indicated through DL DCI, and should be independently indicated for each cell, TRP, or/and beam for the NC-JT transmission. This is a main factor that increases payload required for DL DCI transmission, which may have a bad influence on reception performance of a PDCCH for transmitting the DCI. Accordingly, in order to support JT of the PDSCH, it is required to carefully design a tradeoff between an amount of DCI information and reception performance of control information.

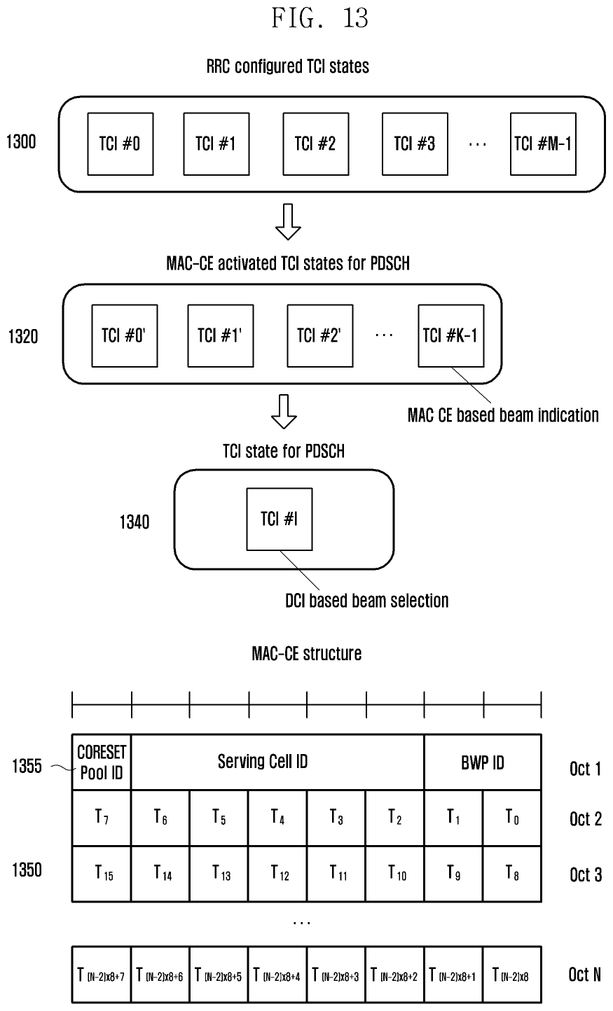

FIG. 13 illustrates a process for beam configuration and activation with regard to a PDSCH according to an embodiment of the disclosure.

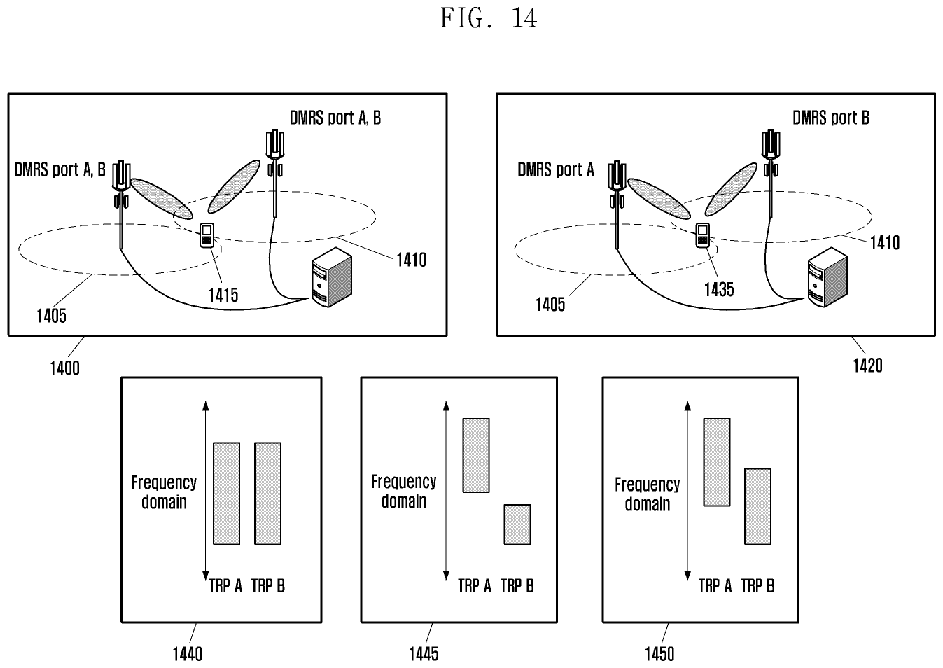

FIG. 14 illustrates a configuration of antenna ports and an example of resource allocation to transmit a PDSCH through cooperative communication in a wireless communication system according to an embodiment of the disclosure.

Referring to FIG. 14, an example for PDSCH transmission is described for each scheme of joint transmission (JT), and examples for allocating radio resources for each TRP are described.

Referring to FIG. 14, an example 1400 of coherent joint transmission (C-JT) supporting coherent precoding between respective cells, TRPs, and/or beams is illustrated.

In the case of C-JT, a TRP A 1405 and a TRP B 1410 transmit single data (PDSCH) to a UE 1415, and a plurality of TRPs may perform joint precoding. This may mean that the TRP A 1405 and the TPR B 1410 transmit DMRSs through the same DMRS port in order to transmit the same PDSCH. For example, the TRP A 1405 and the TPR B 1410 may transmit DMRSs to the UE through a DMRS port A and a DMRS port B, respectively. In this case, the UE may receive one piece of DCI information for receiving one PDSCH demodulated on the basis of the DMRSs transmitted through the DMRS port A and the DMRS port B.

FIG. 14 illustrates an example 1420 of non-coherent joint transmission (NC-JT) supporting non-coherent precoding between respective cells, TRPs, or/and beams for PDSCH transmission.

In the case of NC-JT, the TRP A 1405 and the TRP B 1410 transmit the PDSCH to a UE 1435 for each cell, TPR, and/or beam, and individual precoding may be applied to each PDSCH. Respective cells, TRPs, and/or beams may transmit different PDSCHs or different PDSCH layers to the UE, thereby improving throughput compared to single cell, TRP, or/and beam transmission. Further, respective cells, TRPs, and/or beams may repeatedly transmit the same PDSCH to the UE, thereby improving reliability compared to single cell, TRP, or/and beam transmission. For convenience of description, the cell, TRP, or/and beam are commonly called a TRP.

At this time, various radio resource allocations such as the case 1440 in which frequency and time resources used by a plurality of TRPs for PDSCH transmission are all the same, the case 1445 in which frequency and time resources used by a plurality of TRPs do not overlap at all, and the case 1450 in which some of the frequency and time resources used by a plurality of TRPs overlap each other may be considered.

In order to support NC-JT, DCI in various forms, structures, and relations may be considered to simultaneously allocate a plurality of PDSCHs to one UE.

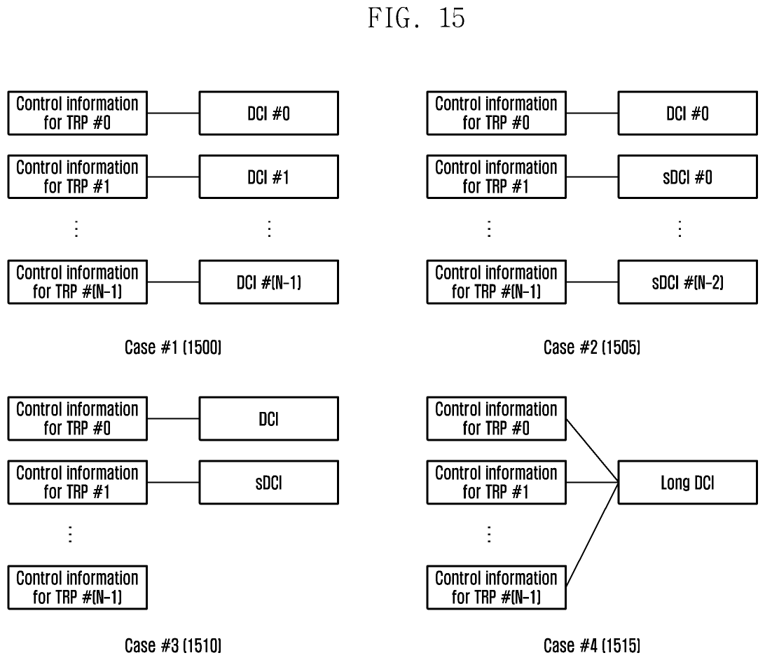

FIG. 15 illustrates an example of a configuration of downlink control information (DCI) for NC-JT in which respective TRPs transmit different PDSCHs or different PDSCH layers to the UE in a wireless communication system according to an embodiment of the disclosure.

Referring to FIG. 15, case #1 1500 is an example in which control information for PDSCHs transmitted from (N−1) additional TRPs is transmitted independently from control information for a PDSCH transmitted by a serving TRP in a situation where (N−1) different PDSCHs are transmitted from the (N−1) additional TRPs (TRP #1 to TRP #(N−1)) other than the serving TRP (TRP #0) used for single PDSCH transmission. That is, the UE may acquire control information for PDSCHs transmitted from different TRPs (TRP #0 to TRP #(N−1)) through independent DCI (DCI #0 to DCI #(N−1)). Formats between the independent DCI may be the same as or different from each other, and payload between the DCI may also be the same as or different from each other. In case #1, a degree of freedom of PDSCH control or allocation can be completely guaranteed, but when respective pieces of DCI are transmitted by different TRPs, a difference between DCI coverages may be generated and reception performance may deteriorate.

Case #2 1505 is an example in which pieces of control information (DCI) for PDSCHs of (N−1) additional TRPs are transmitted and each piece of the DCI is dependent on control information for the PDSCH transmitted from the serving TRP in a situation where (N−1) different PDSCHs are transmitted from (N−1) additional TRPs (TRP #1 to TRP #(N−1)) other than the serving TRP (TRP #0) used for single PDSCH transmission.

For example, DCI #0 that is control information for a PDSCH transmitted from the serving TRP (TRP #0) may include all information elements of DCI format 1_0, DCI format 1_1, and DCI format 1_2, but shortened DCI (hereinafter, referred to as sDCI) (sDCI #0 to sDCI #(N−2)) that are control information for PDSCHs transmitted from the cooperative TRPs (TRP #1 to TRP #(N−1)) may include only some of the information elements of DCI format 1_0, DCI format 1_1, and DCI format 1_2. Accordingly, the sDCI for transmitting control information of PDSCHs transmitted from cooperative TPRs has smaller payload compared to the normal DCI (nDCI) for transmitting control information related to the PDSCH transmitted from the serving TRP, and thus can include reserved bits compared to the nDCI.

In case #2, a degree of freedom of each PDSCH control or allocation may be limited according to content of information elements included in the sDCI, but reception capability of the sDCI is better than the nDCI, and thus a probability of the generation of difference between DCI coverages may become lower.

Case #3 1510 is an example in which one piece of control information for PDSCHs of (N−1) additional TRPs is transmitted and the DCI is dependent on control information for the PDSCH transmitted from the serving TRP in a situation in which (N−1) different PDSCHs are transmitted from (N−1) additional TRPs (TRP #1 to TRP #(N−1)) other than the serving TRP (TRP #0) used for single PDSCH transmission.

For example, in the case of DCI #0 that is control information for the PDSCH transmitted from the serving TRP (TRP #0), all information elements of DCI format 1_0, DCI format 1_1, and DCI format 1_2 may be included, and in the case of control information for PDSCHs transmitted from cooperative TRPs (TRP #1 to TRP #(N−1)), only some of the information elements of DCI format 1_0, DCI format 1_1, and DCI format 1_2 may be gathered in one “secondary” DCI (sDCI) and transmitted. For example, the sDCI may include at least one piece of HARQ-related information such as frequency domain resource assignment and time domain resource assignment of the cooperative TRPs and the MCS. In addition, information that is not included in the sDCI such as a BWP indicator and a carrier indicator may follow DCI (DCI #0, normal DCI, or nDCI) of the serving TRP.

In case #3 1510, a degree of freedom of PDSCH control or allocation may be limited according to content of the information elements included in the sDCI but reception performance of the sDCI can be controlled, and case #3 1510 may have smaller complexity of DCI blind decoding of the UE compared to case #1 1500 or case #2 1505.

Case #4 1515 is an example in which control information for PDSCHs transmitted from (N−1) additional TRPs is transmitted in DCI (long DCI) that is the same as that of control information for the PDSCH transmitted from the serving TRP in a situation in which different (N−1) PDSCHs are transmitted from the (N−1) additional TRPs (TRP #1 to TRP #(N−1)) other than the serving TRP (TRP #0) used for single PDSCH transmission. That is, the UE may acquire control information for PDSCHs transmitted from different TRPs (TRP #0 to TRP #(N−1)) through single DCI. In case #4 1515, complexity of DCI blind decoding of the UE may not be increased, but a degree of freedom of PDSCH control or allocation may be low since the number of cooperative TRPs is limited according to long DCI payload restriction.

In the following description and embodiments, the sDCI may refer to various pieces of supplementary DCI such as shortened DCI, secondary DCI, or normal DCI (DCI formats 1_0 and 1_1) including PDSCH control information transmitted in the cooperative TRP, and unless a specific restriction is mentioned, the corresponding description may be similarly applied to the various pieces of supplementary DCI.

In the following description and embodiments, case #1 1500, case #2 1505, and case #3 1510 in which one or more pieces of DCI (or PDCCHs) are used to support NC-JT may be classified as multiple PDCCH-based NC-JT and case #4 1515 in which single DCI (or PDCCH) is used to support NC-JT may be classified as single PDCCH-based NC-JT. In multiple PDCCH-based PDSCH transmission, a CORESET for scheduling DCI of the serving TRP (TRP #0) is separated from CORESETs for scheduling DCI of cooperative TRPs (TRP #1 to TRP #(N−1)). A method of distinguishing the CORESETs may include a distinguishing method through a higher-layer indicator for each CORESET and a distinguishing method through a beam configuration for each CORESET. Further, in single PDCCH-based NC-JT, single DCI schedules a single PDSCH having a plurality of layers instead of scheduling a plurality of PDSCHs, and the plurality of layers may be transmitted from a plurality of TRPs. At this time, association between a layer and a TRP transmitting the corresponding layer may be indicated through a transmission configuration indicator (TCI) indication for the layer.

In embodiments of the disclosure, the “cooperative TRP” may be replaced with various terms such as a “cooperative panel” or a “cooperative beam” when actually applied.

In embodiments of the disclosure, “the case in which NC-JT is applied” may be variously interpreted as “the case in which the UE simultaneously receives one or more PDSCHs in one BWP”, “the case in which the UE simultaneously receives PDSCHs on the basis of two or more transmission configuration indicator (TCI) indications in one BWP”, and “the case in which the PDSCHs received by the UE are associated with one or more DMRS port groups” according to circumstances, but is used by one expression for convenience of description.

In the disclosure, a wireless protocol structure for NC-JT may be variously used according to a TRP development scenario. For example, when there is no backhaul delay between cooperative TRPs or there is a small backhaul delay, a method (CA-like method) using a structure based on MAC layer multiplexing similarly to S10 of FIG. 5 is possible. On the other hand, when the backhaul delay between cooperative TRPs is too large to be ignored (for example, when a time of 2 ms or longer is needed to exchange information such as CSI, scheduling, and HARQ-ACK between cooperative TRPs), a method (DC-like method) of securing characteristics robust to a delay through an independent structure for each TRP from an RLC layer similarly to S20 of FIG. 5 is possible.

The UE supporting C-JT and/or NC-JT may receive a C-JT and/or NC-JT-related parameter or a setting value from a higher-layer configuration and set an RRC parameter of the UE on the basis thereof. For the higher-layer configuration, the UE may use a UE capability parameter, for example, tci-StatePDSCH. The UE capability parameter, for example, tci-StatePDSCH may define TCI states for PDSCH transmission, the number of TCI states may be configured as 4, 8, 16, 32, 64, and 128 in FR1 and as 64 and 128 in FR2, and a maximum of 8 states which can be indicated by 3 bits of a TCI field of the DCI may be configured through a MAC CE message among the configured numbers. A maximum value 128 means a value indicated by maxNumberConfiguredTCIstatesPerCC within the parameter tci-StatePDSCH which is included in capability signaling of the UE. As described above, a series of configuration processes from the higher-layer configuration to the MAC CE configuration may be applied to a beamforming indication or a beamforming change command for at least one PDSCH in one TRP.

### [Multi-DCI-Based Multi-TRP]

As an embodiment of the disclosure, a multi-DCI-based multi-TRP transmission method is described. The multi-DCI-based multi-TRP transmission method may configure a downlink control channel for NC-JT transmission on the basis of a multi-PDCCH.

In NC-JT based on multiple PDCCHs, there may be a CORESTE or a search space separated for each TRP when DCI for scheduling the PDSCH of each TRP is transmitted. The CORESET or the search space for each TRP can be configured like in at least one of the following cases.
A configuration of a higher-layer index for each CORESET: CORESET configuration information configured by a higher layer may include an index value, and a TRP for transmitting a PDCCH in the corresponding CORESET may be identified by the configured index value for each CORESET. That is, in a set of CORESETs having the same higher-layer index value, it may be considered that the same TRP transmits the PDCCH or the PDCCH for scheduling the PDSCH of the same TRP is transmitted. The index for each CORESET may be named CORESETPoolIndex, and it may be considered that the PDCCH is transmitted from the same TRP in CORESETs in which the same CORESETPoolIndex value is configured. In the CORESET in which the same CORESETPoolIndex value is not configured, it may be considered that a default value of CORESETPoolIndex is configured, and the default value may be 0.
   In the disclosure, when the number of types of CORESETPoolIndex of each of a plurality of CORESETs included in higher-layer signaling PDCCH-Config is larger than 1, that is, when respective CORESETs have different CORESETPoolIndex, the UE may consider that the BS can use a multi-DCI-based multi-TRP transmission method.
   Unlike this, in the disclosure, when the number of types of CORESETPoolIndex of each of a plurality of CORESETs included in higher-layer signaling PDCCH-Config is 1, that is, when all CORESETs have the same CORESETPoolIndex of 0 or 1, the UE may consider that the BS performs transmission using a single-TRP without using the multi-DCI-based multi-TRP transmission method.
A configuration of multiple PDCCH-Config: a plurality of PDCCH-Config is configured in one BWP, and each PDCCH-Config may include a PDCCH configuration for each TRP. That is, a list of CORESETs for each TRP and/or a list of search spaces for each TRP may be included in one PDCCH-Config, and one or more CORESETs and one or more search spaces included in one PDCCH-Config may be considered to correspond to a specific TRP.
CORESET beam/beam group configuration: a TRP corresponding to the corresponding CORESET may be identified through a beam or a beam group configured for each CORESET. For example, when the same TCI state is configured in a plurality of CORESETs, it may be considered that the corresponding CORESETs are transmitted through the same TRP or a PDCCH for scheduling a PDSCH of the same TRP is transmitted in the corresponding CORESET.
Search space beam/beam group configuration: a beam or a beam group may be configured for each search space, and accordingly a TRP for each search space may be identified. For example, when the same beam/beam group or TCI state is configured in a plurality of search spaces, it may be considered that the same TRP transmits the PDCCH in the corresponding search space or a PDCCH for scheduling a PDSCH of the same TRP is transmitted in the corresponding search space.

As described above, by separating the CORESETs or search spaces for each TRP, it is possible to divide PDSCHs and HARQ-ACK for each TRP and accordingly to generate an independent HARQ-ACK codebook for each TRP and use an independent PUCCH resource.

The configuration may be independent for each cell or each BWP. For example, while two different CORESETPoolIndex values may be configured in the PCell, no CORESETPoolIndex value may be configured in a specific SCell. In this case, it may be considered that NC-JT transmission is configured in the PCell, but NC-JT is not configured in the SCell in which no CORESETPoolIndex value is configured.

A PDSCH TCI state activation/deactivation MAC-CE which can be applied to the multi-DCI-based multi-TRP transmission method may follow FIG. 13 above. When the UE does not receive a configuration of CORESETPoolIndex for each of all CORESETs within higher-layer signaling PDCCH-Config, the UE may ignore a CORESET Poll ID field 1355 within the corresponding MAC-CE 1350. If the UE can support the multi-DCI-based multi-TRP transmission method, that is, if respective CORESETS within higher-layer signaling PDCCH-Config have different CORESETPoolIndex, the UE may activate a TCI state within DCI included in PDCCHs transmitted in CORESETs having CORESETPoolIndex which is the same as a value of the CORESET Poll ID field 1355 within the corresponding MAC-CE 1350. For example, when the value of the CORESET Poll ID field 1355 within the corresponding MAC-CE 1350 is 0, a TCI state within DCI included in PDCCHs transmitted by the CORESETs having CORESETPoolIndex of 0 may follow activation information of the corresponding MAC-CE.

When the UE receives a configuration indicating that the multi-DCI-based multi-TRP transmission method can be used from the BS, that is, the number of types of CORESETPoolIndex of a plurality of CORESETs included in higher-layer signaling PDCCH-Config is larger than 1 or respective CORESETs have different CORESETPoolIndex, the UE may know that there are the following restrictions on PDSCHs scheduled by PDCCHs within respective CORESETs having different two CORESETPollIndex.

1) When PDSCHs indicated by PDCCHs within respective CORESETs having different two CORESETPollIndex completely or partially overlap, the UE may apply TCI states indicated by the respective PDCCHs to different CDM groups. That is, two or more TCI states may not be applied to one CDM group.

2) When PDSCHs indicated by PDCCHs within respective CORESETs having different two CORESETPollIndex completely or partially overlap, the UE may expect that the numbers of actual front loaded DMRS symbols of respective PDSCHs, the numbers of actual additional DMRS symbols, locations of actual DMRS symbols, and DMRS types are not different.

3) The UE may expect that bandwidth parts indicated by PDCCHs within respective CORESETs having different two CORESETPoolIndex are the same and subcarrier spacings are also the same.

4) The UE may expect that information on PDSCH scheduled by PDCCHs within respective CORESETs having different two CORESETPoolIndex are completely included in respective PDCCHs.

### [Single-DCI-Based Multi-TRP]

As an embodiment of the disclosure, a single-DCI-based multi-TRP transmission method is described. The single-DCI-based multi-TRP transmission method may configure a downlink control channel for NC-JT transmission on the basis of a single PDCCH.

In single DCI-based multi-TRP transmission method, PDSCHs transmitted by a plurality of TRPs may be scheduled by one piece of DCI. At this time, as a method of indicating the number of TRPs transmitting the corresponding PDSCHs, the number of TCI states may be used. That is, single PDCCH-based NC-JT transmission may be considered when the number of TCI states indicated by DCI for scheduling the PDSCHs is 2, and single-TRP transmission may be considered when the number of TCI states is 1. The TCI states indicated by the DCI may correspond to one or two TCI states among TCI states activated by the MAC CE. When the TCI states of DCI correspond to two TCI states activated by the MAC CE, a TCI codepoint indicated by the DCI is associated with the TCI states activated by the MAC CE, in which case the number of TCI states activated by the MAC CE, corresponding to the TCI codepoint, may be 2.

In another example, when at least one of all codepoints of the TCI state field within DCI indicate two TCI states, the UE may consider that the BS can perform transmission on the basis of the single-DCI-based multi-TRP method. At this time, at least one codepoint indicating two TCI states within the TCI state field may be activated through an enhanced PDSCH TCI state activation/deactivation MAC-CE.

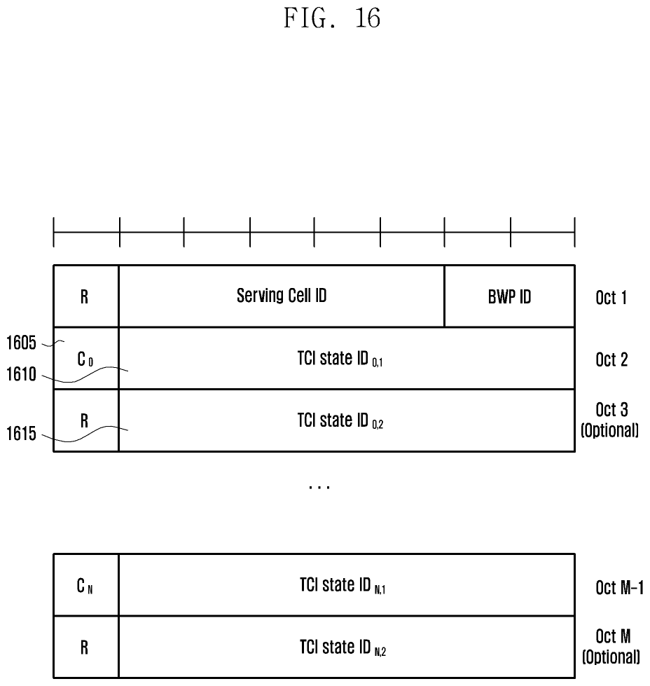

FIG. 16 illustrates an enhanced PDSCH TCI state activation/deactivation MAC-CE format according to an embodiment of the disclosure. The meaning of each field within the MAC CE and a value configurable in each field are as shown in Table 23 below.

```
TABLE 23
  Serving Cell ID: This field indicates the identity of the Serving Cell for
which the MAC CE applies. The length of the field is 5 bits. If the indicated
Serving Cell is configured as part of a simultaneousTCI-UpdateList1 or
simultaneousTCI-UpdateList2 as specified in TS 38.331 [5], this MAC CE applies
to all the Serving Cells configured in the set simultaneousTCI-UpdateList1 or
simultaneousTCI-UpdateList2, respectively;
  BWP ID: This field indicates a DL BWP for which the MAC CE applies as
the codepoint of the DCI bandwidth part indicator field as specified in TS 38.212
[9]. The length of the BWP ID field is 2 bits;
  Cᵢ: This field indicates whether the octet containing TCI state ID_{i,2} is present.
If this field is set to “1”, the octet containing TCI state ID_{i,2} is present. If this field is
set to “0”, the octet containing TCI state ID_{i,2} is not present;
  TCI state ID_{i,j}: This field indicates the TCI state identified by TCI-StateId as
specified in TS 38.331 [5], where i is the index of the codepoint of the DCI
Transmission configuration indication field as specified in TS 38.212 [9] and TCI
state ID_{i,j} denotes the j-th TCI state indicated for the i-th codepoint in the DCI
Transmission Configuration Indication field. The TCI codepoint to which the TCI
States are mapped is determined by its ordinal position among all the TCI
codepoints with sets of TCI state ID_{i,j} fields, i.e., the first TCI codepoint with TCI
state ID_{0,1} and TCI state ID_{0,2} shall be mapped to the codepoint value 0, the second
TCI codepoint with TCI state ID_{1,1} and TCI state ID_{1,2} shall be mapped to the
codepoint value 1 and so on. The TCI state ID_{i,2} is optional based on the indication
of the Cᵢ field. The maximum number of activated TCI codepoint is 8 and the
maximum number of TCI states mapped to a TCI codepoint is 2.
  R: Reserved bit, set to “0”.
```

Referring to FIG. 16, if a value of a C0 field 1605 is 1, the corresponding MAC-CE may include a TCI state ID0,2 field 1615 in addition to a TCI state ID0,1 field 1610. This means that a TCI state ID0,1 and a TCI state ID0,1 are activated for a zeroth codepoint of the TCI state field included within the DCI, and when the BS indicates the corresponding codepoint to the UE, the UE may receive an indication of two TCI states. If a value of the field C0 1605 is 0, the corresponding MAC-CE cannot include the TCI state ID0,2 field 1615, which means that one TCI state corresponding to the TCI state ID0, 1 is activated for the zeroth codepoint of the TCI state field included in the DCI.

The configuration may be independent for each cell or each BWP. For example, while a maximum number of activated TCI states corresponding to one TCI codepoint is 2 in the PCell, a maximum number of activated TCI states corresponding to one TCI codepoint may be 1 in a specific SCell. In this case, it may be considered that NC-JT transmission is configured in the PCell but NC-JT is not configured in the SCell.

### [Method of Distinguishing Single-DCI-Based Multi-TRP PDSCH Repetitive Transmission Schemes (Time Division Multiplexing (TDM)/Frequency Division Multiplexing (FDM)/Space Division Multiplexing (SDM))]

Subsequently, a method of distinguishing single-DCI-based multi-TRP PDSCH repetitive transmission schemes is described. The UE may receive an indication of different single-DCI-based multi-TRP PDSCH repetitive transmission schemes (for example, TDM, FDM, and SDM) from the BS according to a value indicated by a DCI field and a higher-layer signaling configuration. Table 24 below shows a method of distinguishing single or multi-TRP-based schemes indicated to the UE according to a specific DCI field value and a higher-layer signaling configuration.

TABLE 24

| | | | repetitionNumber | | |
|---|---|---|---|---|---|
| | Number | Number of | configuration | Related to | Transmission |
| | of TCI | CDM | and indication | repetitionScheme | scheme |
| Combination | states | groups | condition | configuration | indication to UE |
| 1 | 1 | ≥1 | Condition 2 | Not configured | Single-TRP |
| 2 | 1 | ≥1 | Condition 2 | Configured | Single-TRP |
| 3 | 1 | ≥1 | Condition 3 | Configured | Single-TRP |
| 4 | 1 | 1 | Condition 1 | Configured or | Single-TRP TDM |
| | | | | not configured | scheme B |
| 5 | 2 | 2 | Condition 2 | Not configured | Multi-TRP SDM |
| 6 | 2 | 2 | Condition 3 | Not configured | Multi-TRP SDM |
| 7 | 2 | 2 | Condition 3 | Configured | Multi-TRP SDM |
| 8 | 2 | 1 | Condition 3 | Configured | Multi-TRP FDM |
| | | | | | scheme A/FDM |
| | | | | | scheme B/TDM |
| | | | | | scheme A |
| 9 | 2 | 1 | Condition 1 | Not configured | Multi-TRP TDM |
| | | | | | scheme B |

In Table 24, each column may be described below.
the number of TCI states (second column): means the number of TCI states indicated by a TCI state field within DCI and may be 1 or 2.
the number of CDM groups (third column): means the number of different CDM groups of DRMS ports indicated by an antenna port field within DCI. The number of CDM groups may be 1, 2, or 3.
repetitionNumber configuration and indication condition (fourth column): has three conditions according to whether repetitionNumber for all TDRA entries which can be indicated by a time domain resource allocation field within DCI is configured and whether an actually indicated TDRA entry has a repetitionNumber configuration.
Condition 1: case in which at least one of all TDRA entries which can be indicated by the time domain resource allocation field includes the configuration for repetitionNumber and includes the configuration of repetitionNumber having the TDRA entry larger than 1, indicated by the time domain resource allocation field within DCI.
Condition 2: case in which at least one of all TDRA entries which can be indicated by the time domain resource allocation field includes the configuration for repetitionNumber and the TDRA entry indicated by the time domain resource allocation field within DCI does not include the configuration for repetitionNumber.
Condition 3: case in which all TDRA entries which can be indicated by the time domain resource allocation field do not include the configuration for repetitionNumber.
Related to a repetitionScheme configuration (fifth column): means whether repetitionScheme which is higher-layer signaling is configured. RepetitionScheme which is higher-layer signaling may receive a configuration of one of ‘tdmSchemeA’, and ‘fdmSchemeA’, ‘fdmSchemeB’.
Transmission scheme indicated to UE (sixth column): means single or multiple-TRP schemes indicated according to each combination (first column) expressed by Table 24 above.
Single-TRP: means single-TRP-based PDSCH transmission. When the UE receives a configuration of pdsch-AggegationFactor within higher-layer signaling PDSCH-config, the UE may receive scheduling of single TRP-based PDSCH repetitive transmission a number of times received through the configuration. Otherwise, the UE may receive scheduling of single TRP-based PDSCH single transmission.
Single-TRP TDM scheme B: means time resource division-based PDSCH repetitive transmission between single TRP-based slots. The UE repeatedly transmits a PDSCH on a time dimension a number of times corresponding to the number of slots of repetitionNumber larger than 1 configured in the TDRA entry indicated by the time domain resource allocation field according to condition 1 related to repetitionNumber. At this time, a start symbol and a symbol length of the PDSCH indicated by the TDRA entry is equally applied to every slot corresponding to repetitionNumber and the same TCI state is applied to each PDSCH repetitive transmission. The corresponding scheme is similar to a slot aggregation scheme in that the PDSCH repetitive transmission between slots is performed in time resources but is different therefrom in that a repetitive transmission indication is dynamically determined on the basis of the time domain resource allocation field within DCI.
Multi-TRP SDM: means a multi-TRP-based space resource division PDSCH transmission scheme. This is a method of dividing a layer and performing reception from each TRP and may increase reliability of PDSCH transmission in that transmission can be performed at a lowered coding rate through an increase in the number of layers even though it is not the repetitive transmission scheme. The UE may receive a PDSCH by applying each of two TCI states indicated through the TCI state field within DCI to two CDM groups indicated by the BS.
Multi-TRP FDM scheme A: means a multi-TRP-based frequency resource division PDSCH transmission scheme and is a scheme having one PDSCH transmission occasion and capable of performing transmission with higher reliability by increasing frequency resources and lowering a coding rate even though is not the repetitive transmission such as multi-TRP SDM. Multi-TRP FDM scheme A may apply two TCI states indicated through the TCI state field within DCI to frequency resources which do not overlap each other. When the PRB bundling size is determined as a wideband and the number of RBs indicated by the frequency domain resource allocation field is N, the UE may receive first ceil (N/2) RBs by applying a first TC state and receive the remaining floor (N/2) RBs by applying a second TCI state. Here, ceil(.) and floor(.) are operators indicating rounding up and rounding down at the first decimal place. If the PRB bundling size is determined as 2 or 4, even-numbered PRGs are received by applying a first TCI state and odd-numbered PRGs are received by applying a second TCI state.
Multi-TRP FDM scheme B: means a multi-TRP-based frequency resource division PDSCH repetitive transmission scheme and has two PDSCH transmission occasions to repeatedly transmit a PDSCH at each occasion. Multi-TRP FDM scheme B may also apply two TCI states indicated through the TCI state field within DCI to frequency resources which do not overlap each other. If the PRB bundling size is determined as a wideband and the number of RBs indicated by the frequency domain resource allocation field is N, the UE may receive first ceil (N/2) RBs by applying a first TC state and receive the remaining floor (N/2) RBs by applying a second TCI state. Here, ceil(.) and floor(.) are operators indicating rounding up and rounding down at the first decimal place. When the PRB bundling size is determined as 2 or 4, even-numbered PRGs are received by applying a first TCI state and odd-numbered PRGs are received by applying a second TCI state.
Multi-TRP TDM scheme A: means a PDSCH repetitive transmission scheme within a multi-TRP-based time resource division slot. The UE has two PDSCH transmission occasion within one slot, and a first reception occasion may be determined on the basis of a start symbol and a symbol length of the PDSCH indicated through the time domain resource allocation field within DCI. A start symbol of a second reception occasion of the PDSCH may be an occasion to which a symbol offset by higher-layer signaling StartingSymbolOffsetK from the last symbol of the first transmission occasion, and the transmission occasion corresponding to the symbol length indicated therefrom may be determined. If higher-layer signaling StartingSymbolOffsetK is not configured, the symbol offset may be considered as 0.
Multi-TRP TDM scheme B: means a PDSCH repetitive transmission scheme between multi-TRP-based time resource division slots. The UE has one PDSCH transmission occasion within one slot and may receive repetitive transmission on the basis of a start symbol and a symbol length of the same PDSCH during slots corresponding to repetitionNumber indicated by the time domain resource allocation field within DCI. If repetitionNumber is 2, the UE may receive PDSCH repetitive transmission of first and second slots by applying first and second TCI states, respectively. If repetitionNumber is larger than 2, the UE may use different TCI state schemes according to configured higher-layer signaling tciMapping. If tciMapping is configured as cyclicMapping, first and second TCI states may be applied to first and second PDSCH transmission occasions, respectively, and the same TCI state application method is equally applied to the remaining PDSCH transmission occasions. If tciMapping is configured as sequentialMapping, a first TCI state may be applied to first and second PDSCH transmission occasions, a second TCI state may be applied to third and fourth PDSCH transmission occasions, and the same TCI state application method may be equally applied to the remaining PDSCH transmission occasions.

Hereinafter, the disclosure is described in more detail with reference to the above description. The above description may be applied to the disclosure described below. The operations/functions/terms described above may be applied to the disclosure described below.

Hereinafter, a plurality of embodiments described in the disclosure are not independent, and one or more embodiments can be applied simultaneously or complexly.

### First Embodiment: Multi-TCI State Indication and Activation Method Based on Unified TCI Scheme

As embodiment of the disclosure, a multi-TCI state indication and activation method based on a unified TCI scheme is described. Operations of the UE and the BS in this embodiment may be combined with operations of the UE and the BS in other embodiments of the disclosure. The multi-TCI state indication and activation method may mean the case where the number of indicated joint TCI states expands to two or more and the case where the maximum number of each of DL TCI states and UL TCI states included in one separate TCI state set expands two or more. The multi-TCI state indication and activation method may include one or more of a TCI state indication and activation method in the case where the number of indicated joint TCI states is two or more or a TCI state indication and activation method in the case where the maximum number of each of DL TCI states and UL TCI states included in one indicated separate TCI state set is two or more. If one separate TCI state set includes up to two DL TCI states and two UL TCI states, the total number of combinations of DL TCI states and UL TCI states which the one separate TCI state set can have may be 8 (for example, {DL,UL}={0,1}, {0,2}, {1,0}, {1,1}, {1,2}, {2,0}, {2,1}, {2,2}. A number is the number of TCI states). Alternatively, the multi-TCI state indication and activation method may include a TCI state indication and activation method in the case where the number of indicated separate TCI state sets is two or more.

If the UE receives an indication of multiple TCI states based on a medium access control-control element (MAC-CE) from the BS, the UE may receive two or more joint TCI states or one separate TCI state set from the BS through the corresponding MAC-CE. That is, the UE may receive the MAC-CE including information on two or more joint TCI states or information on one separate TCI state set from the BS. That BS may schedule reception of a PDSCH including the corresponding MAC-CE to the UE through a PDCCH. The UE may transmit a PUCCH including hybrid automatic repeat request-acknowledgement) (HARQ-ACK) information indicating whether the PDSCH including the corresponding MAC-CE has been successfully received. The UE may determine an uplink transmission beam or transmission filter and a downlink reception beam or reception filter, based on the two or more joint TCI states or the one separate TCI state set indicated from 3 ms after corresponding PUCCH transmission.

If the UE receives an indication of multiple TCI states from the BS, based on DCI format 1_1 or 1_2, respective codepoints in one TCI state field within corresponding DCI format 1_1 or 1_2 may indicate two or more joint TCI states or two or more separate TCI state sets. For example, the BS may indicate two or more joint TCI states to the UE, based on respective codepoints, or the BS may indicate two or more separate TCI state sets to the UE, based on respective TCI states fields. At this time, the UE may receive the MAC-CE from the BS and activate two or more joint TCI states or two or more separate TCI state sets corresponding to respective codepoints in one TCI state field within corresponding DCI format 1_1 or 1_2. That BS may schedule reception of a PDSCH including the corresponding MAC-CE to the UE through a PDCCH. The UE may transmit a PUCCH including HARQ-ACK information indicating whether the PDSCH including the corresponding MAC-CE has been successfully received. The UE may activate TCI state information included in the MAC-CE from 3 ms after corresponding PUCCH transmission. The PDCCH scheduling the PDSCH including the corresponding MAC-CE may be a PDCCH including DCI format 1_1 or 1_2 indicating the corresponding multiple DCI states or a separate PDCCH.

If the UE receives an indication of multiple TCI states from the BS, based on DCI format 1_1 or 1_2, two or more TCI state fields may exist (or may be included) in corresponding DCI format 1_1 or 1_2, and one of the two or more joint TCI states or the two or more separate TCI state sets may be indicated based on each TCI state field. For example, two or more TCI fields may be included in one DCI format indicated to the UE by the BS, and two or more joint TCI states may be indicated based on each TCI states field included in the one DCI format or two or more separate TCI state sets may be indicated based on each TCI state field. At this time, the UE may receive the MAC-CE from the BS and activate joint TCI states or separate TCI state sets corresponding to respective codepoints in two or more TCI state fields within corresponding DCI format 1_1 or 1_2. That BS may schedule reception of a PDSCH including the corresponding MAC-CE to the UE through a PDCCH. The UE may transmit a PUCCH including HARQ-ACK information indicating whether the PDSCH including the corresponding MAC-CE has been successfully received. The UE may activate TCI state information included in the MAC-CE from 3 ms after corresponding PUCCH transmission. The PDCCH scheduling the PDSCH including the corresponding MAC-CE may be a PDCCH including DCI format 1_1 or 1_2 indicating the corresponding multiple DCI states or a separate PDCCH. The UE may receive a configuration indicating whether one or more additional TCI state fields exist (or are included) through higher-layer signaling. For example, information indicating whether there is an additional TCI state field configured in the UE by the BS may be included in higher-layer signaling, and it may be identified whether the additional TCI state field is included in a DCI format, based on a value of the corresponding information. Alternatively, it may be identified whether the additional TCI state field is included in the DCI format according to whether the information on the existence of the additional TCI state field configured in the UE by the BS is included in higher-layer signaling. For example, it may be identified that the additional TCI state field is included in the DCI format when the corresponding information configured in the UE by the BS is included in higher-layer signaling, and it may be identified that the additional TCI state field is not included in the DCI format when the corresponding information is not included in higher-layer signaling. The length of bits of the additional TCI field may be the same as that of the existing TCI state field or may be controlled based on higher-layer signaling. For example, information on the length of bits of the additional TCI state field configured in the UE by the BS may be included in higher-layer signaling. Alternatively, the length of the bits of the additional TCI state field may be identified according to the corresponding information when the information on the length of bits of the additional TCI state field configured in the UE by the BS is included in higher-layer signaling, and the length of the bits of the additional TCI state field may be the same as that of the existing TCI state field when the information is not included.

The UE may receive a transmission/reception beam-related indication through a unified TCI scheme by using one scheme among the joint TCI states and the separate TCI states configured by the BS. The UE may receive a configuration indicating whether to use one of the joint TCI states and the separate TCI states from the BS through higher layer signaling. For the separate TCI state indication, the UE may receive a configuration such that the length of bits of the TCI state field within DCI format 1_1 or 1_2 becomes a maximum of 4 through higher-layer signaling.

MAC-CEs used to activate or indicate the plurality of joint TCI states and separate TCI states may separately exist for each of the joint and separate TCI state schemes. Alternatively, TCI states may be activated or indicated based on one of the joint or separate TCI state schedules using one MAC-CE. Alternatively, MAC-CEs used for the MAC-CE-based indication scheme and the MAC-CE-based activation scheme may share one MAC-CE format, or individual MAC-CE formats may be used. According to the disclosure, various MAC-CE formats for activating and indicating a plurality of joint or separate TCI states may be considered, and various examples therefor are described with drawings described below. For convenience of description, the case where two or more TCI states are activated or indicated is considered in various examples with reference to drawings described below, but the disclosure may be similarly applied to the case where three or more TCI states are activated or indicated.

As embodiment of the disclosure, a multi-TCI state indication and activation method based on a unified TCI scheme is described. The UE may receive scheduling of a PDSCH including MAC-CEs which can be configured by a combination of at least one of the following various MAC-CE formats from the BS and analyze each codepoint in a TCI state field within DCI format 1_1 or 1_2 after three slots for transmitting HARQ-ACK for the corresponding PDSCH to the BS, based on information within the MAC-CEs received from the BS. That is, the UE may activate each entry of the MAC-CE received from the BS in each codepoint in the TCI state field within DCI format 1_1 or 1_2.

Referring back to FIG. 17, if the UE receives the configuration of two different CORESETPoolIndex through higher-layer signaling and the configuration of UL-TCIState or UL-TCIState that is higher-layer signaling, the BS and the UE may expect that an R field 1730 existing in the first octet is analyzed as a field indicating a CORESET Pool ID in FIG. 17 corresponding to one of the MAC-CE formats indicating unified TCI state activation. If the corresponding CORESET Pool ID is configured as 0, the UE may consider that the corresponding MAC-CE can be applied to each codepoint in the TCI state field within the PDCCH transmitted in the CORESET corresponding to CORESETPoolIndex 0. If the corresponding CORESET Pool ID is configured as 1, the UE may consider that the corresponding MAC-CE can be applied to each codepoint in the TCI state field within the PDCCH transmitted in the CORESET corresponding to CORESETPoolIndex 1.

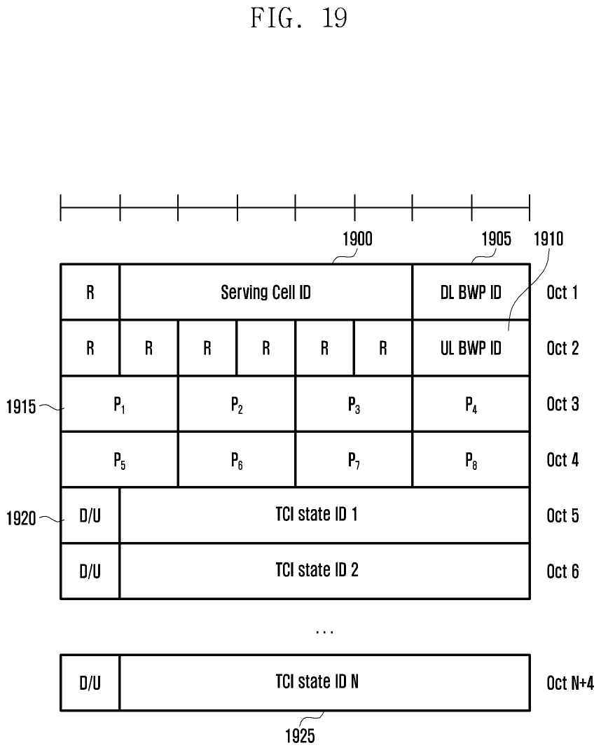

FIG. 19 illustrates another MAC-CE format for activating and indicating a plurality of joint TCI states, or separate DL or UL TCI states in a wireless communication system according to an embodiment of the disclosure. The meaning of each field within the corresponding MAC-CE format is described below.
Serving cell ID 1900: this field may indicate a service cell to which the corresponding MAC-CE is applied. The length of this field may be 5 bits. If the serving cell indicated by this field is included in one or more of simultaneousU-TCI-UpdateList1, simultaneousU-TCI-UpdateList2, simultaneousU-TCI-UpdateList3, or simultaneousU-TCI-UpdateList4 which is higher layer signaling, the corresponding MAC-CE may be applied to all serving cells included in a list of one or more of simultaneousU-TCI-UpdateList1, simultaneousU-TCI-UpdateList2, simultaneousU-TCI-UpdateList3, and simultaneousU-TCI-UpdateList4 including the serving cell indicated by this field.
DL BWP ID 1905: this field may indicate a DL BWP to which the corresponding MAC-CE is applied. The meaning of each codepoint in this field may correspond to each codepoint of a bandwidth part indicator within DCI. The length of this field may be 2 bits.
UL BWP ID 1910: this field may indicate a UL BWP to which the corresponding MAC-CE is applied. The meaning of each codepoint in this field may correspond to each codepoint of a bandwidth part indicator within DCI. The length of this field may be 2 bits.
Pi 1915: this field may indicate whether each codepoint in the TCI state field within DCI format 1_1 or 1_2 has a plurality of TCI states or one TCI state.

If the UE can configure unifiedTCI-StateType-r17 in MIMOparam-r17 within ServingCellConfig corresponding to higher-layer signaling for one of joint and separate, the UE may analyze this field as follows regardless of which one is configured between two pieces of configuration information.

If a value of Pᵢ is “00”, it may mean that a corresponding i^{th} codepoint has a single TCI state, which may imply that the corresponding codepoint includes the joint TCI state or one of the separate DL TCI state or the separate UL TCI state.

If the value of Pᵢ is “01”, it means that the corresponding i^{th} codepoint has two TCI states, which may imply that the corresponding codepoint includes one of two joint TCI states, one separate DL TCI state and one separate UL TCI state, two separate DL TCI states, or two separate UL TCI states.

If the value of Pᵢ is “10”, it means that the corresponding i^{th} codepoint has three TCI states, which may imply that the corresponding codepoint includes one separate DL TCI state and two separate UL TCI state, or two separate DL TCI states and one separate UL TCI state.

If the value of Pᵢ is “11”, it means that the corresponding i^{th} codepoint has four TCI states, which may imply that the corresponding codepoint includes two separate DL TCI states and two separate UL TCI states.

If the UE can configure unifiedTCI-StateType-r17 in MIMOparam-r17 within ServingCellConfig corresponding to higher-layer signaling for one of joint, separate, and mixed mode, the UE may analyze this field as follows regardless of a configured value among available configuration values. The mixed mode may be expressed as one configuration value having the meaning that the general mixed mode of the joint TCI state and the separate DL or UL TCI state is possible and/or expressed as a plurality of configuration values such as “1joint+1DL” and “1joint+1UL”, and thus may be configured to indicate a specific combination of the specific number of joint TCI states and the specific number of separate DL or UL TCI states.

If the value of Pᵢ is “00”, it means that the corresponding i^{th} codepoint has a single TCI state, which may imply that the corresponding codepoint includes the joint TCI state or one of the separate DL TCI state or the separate UL TCI state.

If the value of Pᵢ is “01”, it means that the corresponding i^{th} codepoint has two TCI states, which may imply that the corresponding codepoint includes one of two joint TCI states, one joint TCI state and one separate DL TCI state, one joint TCI state and one separate UL TCI state, one separate DL TCI state and one separate UL TCI state, two separate DL TCI states, or two separate UL TCI states. If the UE receives a configuration of a value indicating that unifiedTCI-State Type-r17 in MIMOparam-r17 within ServingCellConfig corresponding to higher-layer signaling means that the general mixed mode of the joint TCI state and the separate DL or UL TCI state is possible like the mixed mode, both of one joint TCI state and one separate DL TCI state, and one joint TCI state and one separate UL TCI state may be possible. If the UE receives a configuration of one of “1joint+1DL” and “1joint+1UL” through unifiedTCI-State Type-r17 in MIMOparam-r17 within ServingCellConfig corresponding to higher-layer signaling, only the case corresponding to a configuration value of unifiedTCI-State Type-r17 may be possible between one joint TCI state and one separate DL TCI state, and one joint TCI state and one separate UL TCI state.

If the value of Pᵢ is “10”, it means that the corresponding i^{th} codepoint has three TCI states, which may imply that the corresponding codepoint includes one separate DL TCI state and two separate UL TCI states, or two separate DL TCI states and one separate UL TCI state.

If the value of Pᵢ is “11”, it means that the corresponding i^{th} codepoint has four TCI states, which may imply that the corresponding codepoint includes two separate DL TCI states and two separate UL TCI states.

The corresponding field may be 2 bits.
D/U 1920: this field may indicate whether a TCI state ID field within the same octet is a joint TCI state, a separate DL TCI state, or a separate UL TCI state. If this field is 1, the TCI state ID field within the same octet may be the joint TCI state or the separate DL TCI state and, if this field is 0, the TCI state ID field within the same octet may be the separate UL TCI state.
TCI state ID 1925: this field may indicate a TCI state that can be detected by a TCI-StateId corresponding to higher layer signaling. If a D/U field is configured as 1, this field may be used to express the TCI-StateId that can be expressed by 7 bits. If the D/U field is configured as 0, a most significant bit (MSB) of this field may be considered as being reserved, and the remaining 6 bits may be used to express the UL-TCIState-Id corresponding to higher layer signaling. The maximum of TCI states that can be activated may be 8 in the case of the joint TCI state and 16 in the case of the separate DL or UL TCI state.
R: indicates a reserved bit and may be configured as 0.

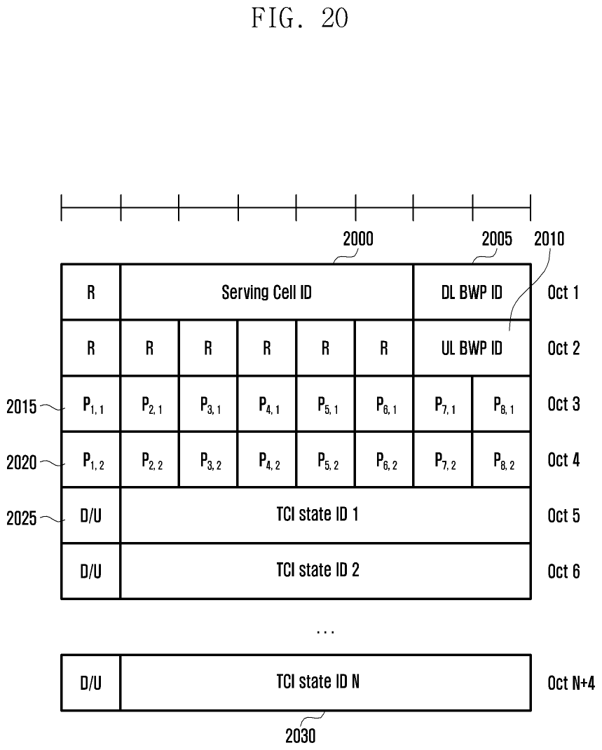

FIG. 20 illustrates another MAC-CE format for activating and indicating a plurality of joint TCI states, or separate DL or UL TCI states in a wireless communication system according to an embodiment of the disclosure. The meaning of each field within the corresponding MAC-CE format is described below.

Serving cell ID 2000: this field may indicate a service cell to which the corresponding MAC-CE is applied. The length of this field may be 5 bits. If the serving cell indicated by this field is included in one or more of simultaneousU-TCI-UpdateList1, simultaneousU-TCI-UpdateList2, simultaneousU-TCI-UpdateList3, or simultaneousU-TCI-UpdateList4 which is higher layer signaling, the corresponding MAC-CE may be applied to all serving cells included in a list of one or more of simultaneousU-TCI-UpdateList1, simultaneousU-TCI-UpdateList2, simultaneousU-TCI-UpdateList3, and simultaneousU-TCI-UpdateList4 including the serving cell indicated by this field.
DL BWP ID 2005: this field may indicate a DL BWP to which the corresponding MAC-CE is applied. The meaning of each codepoint in this field may correspond to each codepoint of a bandwidth part indicator within DCI. The length of this field may be 2 bits.
UL BWP ID 2010: this field may indicate a UL BWP to which the corresponding MAC-CE is applied. The meaning of each codepoint in this field may correspond to each codepoint of a bandwidth part indicator within DCI. The length of this field may be 2 bits.
P_{i,1} 2015, P_{i,2} 2020: these two fields may indicate whether each codepoint in the TCI state field within DCI format 1_1 or 1_2 has a plurality of TCI states or one TCI state. In the description of this embodiment, an octet (October 3) including P_{i,1} 2015 may be named a third octet, and an octet (October 4) including P_{i,2} 2020 may be named a fourth octet.

For the case where unifiedTCI-State Type-r17 in MIMOparam-r17 within ServingCellConfig corresponding to higher-layer signaling can be configured for one of joint and separate or configured for one of joint, separate, and mixed mode, the UE may omit a fourth octet including P_{1,2}, P_{2,2}, . . . , P_{8,2} fields (for example, interpretation for the fourth octet may be omitted, the fourth octet may be ignored, the fourth octet may be omitted (not included) in the MAC-C, or the fourth octet may not be transmitted) in FIG. 20 and only P_{1,2} may be interpreted as follows when unifiedTCI-State Type-r17 corresponding to higher-layer signaling is configured as joint. The mixed mode may be expressed as one configuration value having the meaning that the general mixed mode of the joint TCI state and the separate DL or UL TCI state is possible and/or expressed as a plurality of configuration values such as “1joint+1DL” and “1joint+1UL”, and thus may be configured to indicate a specific combination of the specific number of joint TCI states and the specific number of separate DL or UL TCI states.

If a value of P_{i,1} is “0”, it may mean that the corresponding i^{th} codepoint has one TCI state, which may imply that the corresponding codepoint includes one joint TCI state.

If the value of P_{i,1} is “1”, it may mean that the corresponding i^{th} codepoint has two TCI states, which may imply that the corresponding codepoint includes two joint TCI states.

For the case where unifiedTCI-State Type-r17 in MIMOparam-r17 within ServingCellConfig corresponding to higher-layer signaling can be configured for one of joint and separate or configured for one of joint, separate, and mixed mode, if the UE receives a configuration of unifiedTCI-StateType-r17 corresponding to higher-layer signaling as separate, the UE may consider P_{i,1} of the third octet and P_{i,2} of the fourth octet as one field of 2 bits and make interpretation as follows. The mixed mode may be expressed as one configuration value having the meaning that the general mixed mode of the joint TCI state and the separate DL or UL TCI state is possible and/or expressed as a plurality of configuration values such as “1joint+1DL” and “1joint+1UL”, and thus may be configured to indicate a specific combination of the specific number of joint TCI states and the specific number of separate DL or UL TCI states.

If the value of P_{i,1} and the value of P_{i,2} are “0” and “0”, it means that the corresponding i^{th} codepoint has a single TCI state, which may imply that the corresponding codepoint includes the one of the separate DL TCI state or the separate UL TCI state.

If the value of P_{i,1} and the value of P_{i,2} are “0” and “1”, respectively, it means that the corresponding i^{th} codepoint has two TCI states, which may imply that the corresponding codepoint includes one of one separate DL TCI state and one separate UL TCI state, two separate DL TCI states, or two separate UL TCI states.

If the value of P_{i,1} and the value of P_{i,2} are “1” and “0”, respectively, it means that the corresponding i^{th} codepoint has three TCI states, which may imply that the corresponding codepoint includes one separate DL TCI state and two separate UL TCI states, or two separate DL TCI states and one separate UL TCI state.

If the value of P_{i,1} and the value of P_{i,2} are “1” and “1”, it means that the corresponding i^{th} codepoint has four TCI states, which may imply that the corresponding codepoint includes two separate DL TCI states and two separate UL TCI states.

If unifiedTCI-State Type-r17 in MIMOparam-r17 within ServingCellConfig corresponding to higher-layer signaling can be configured for one of joint, separate, and mixed mode, the UE may interpret P_{i,1} of the third octet as follows and the fourth octet may not be transmitted (for example, the fourth octet may not be transmitted, the fourth octet may be omitted (not be included) in the MAC-CE, interpretation for the fourth octet may be omitted, or the fourth octet may be ignored) when the UE receives a configuration of unifiedTCI-StateType-r17 corresponding to higher-layer signaling as mixed mode. The mixed mode may be expressed as one configuration value having a meaning that the general mixed mode of the joint TCI state and the separate DL or UL TCI state is possible.

If a value of P_{i,1} is “0”, it may mean that the corresponding i^{th} codepoint includes one joint TCI state and one separate DL TCI state.

If the value of P_{i,1} is “1”, it may mean that the corresponding i^{th} codepoint includes one joint TCI state and one separate UL TCI state.

If unifiedTCI-State Type-r17 in MIMOparam-r17 within ServingCellConfig corresponding to higher-layer signaling can be configured for one of joint, separate, and mixed mode, the UE may interpret P_{i,1} of the third octet and P_{i,2} of the fourth octet when unifiedTCI-StateType-r17 corresponding to higher-layer signaling is configured as the mixed mode. The mixed mode may be expressed as one configuration value having a meaning that the general mixed mode of the joint TCI state and the separate DL or UL TCI state is possible.

If the value of P_{i,1} is “0”, it may mean that the corresponding i^{th} codepoint includes only one joint TCI state. That is, since the mixed mode is not used, the value of P_{i,2} may be ignored.

If the value of P_{i,1} is “1”, it may mean that the corresponding i^{th} codepoint includes one of one separate UL TCI state and one separate DL TCI state in addition to one joint TCI state. That is, the mixed mode can be used for the corresponding codepoint, and one separate UL TCI state may be additionally used if the value of P_{i,2} is “0” and one separate UL TCI state may be additionally used if the value of P_{i,2} is “1”.
D/U 2025: this field may indicate whether a TCI state ID field within the same octet is a joint TCI state, a separate DL TCI state, or a separate UL TCI state. If this field is 1, the TCI state ID field within the same octet may be the joint TCI state or the separate DL TCI state and, if this field is 0, the TCI state ID field within the same octet may be the separate UL TCI state.
TCI state ID 2030: this field may indicate a TCI state that can be detected by a TCI-StateId corresponding to higher layer signaling. If a D/U field is configured as 1, this field may be used to express the TCI-StateId that can be expressed by 7 bits. If the D/U field is configured as 0, a most significant bit (MSB) of this field may be considered as being reserved, and the remaining 6 bits may be used to express the UL-TCIState-Id corresponding to higher layer signaling. The maximum of TCI states that can be activated may be 8 in the case of the joint TCI state and 16 in the case of the separate DL or UL TCI state.
R: indicates a reserved bit and may be configured as 0.

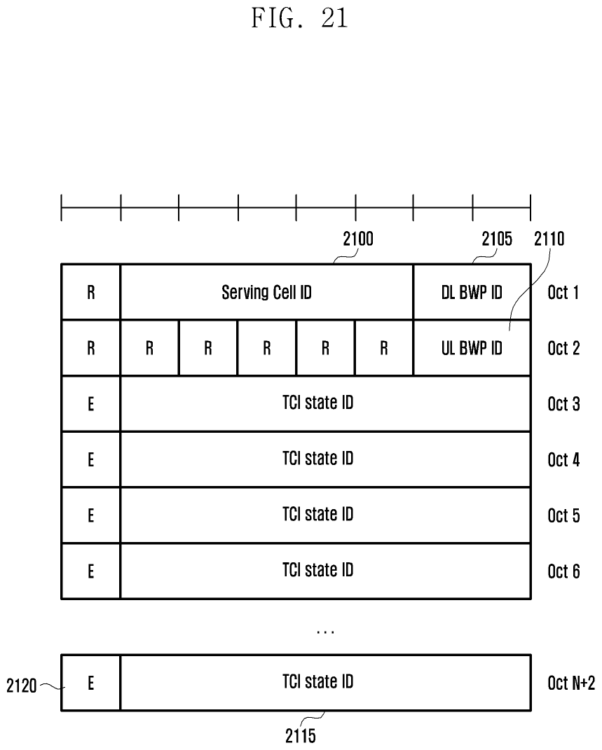

FIG. 21 illustrates another MAC-CE format for activating and indicating a plurality of joint TCI states or separate DL or UL TCI states in a wireless communication system according to an embodiment of the disclosure. The meaning of each field within the corresponding MAC-CE format is described below.
Serving cell ID 2100: this field may indicate a service cell to which the corresponding MAC-CE is applied. The length of this field may be 5 bits. If the serving cell indicated by this field is included in one or more of simultaneousU-TCI-UpdateList1, simultaneousU-TCI-UpdateList2, simultaneousU-TCI-UpdateList3, or simultaneousU-TCI-UpdateList4 which is higher layer signaling, the corresponding MAC-CE may be applied to all serving cells included in a list of one or more of simultaneousU-TCI-UpdateList1, simultaneousU-TCI-UpdateList2, simultaneousU-TCI-UpdateList3, and simultaneousU-TCI-UpdateList4 including the serving cell indicated by this field.
DL BWP ID 2105: this field may indicate a DL BWP to which the corresponding MAC-CE is applied. The meaning of each codepoint in this field may correspond to each codepoint of a bandwidth part indicator within DCI. The length of this field may be 2 bits.
UL BWP ID 2110: this field may indicate a UL BWP to which the corresponding MAC-CE is applied. The meaning of each codepoint in this field may correspond to each codepoint of a bandwidth part indicator within DCI. The length of this field may be 2 bits.
TCI state ID 2115: this field may indicate a TCI state that can be detected by a TCI-StateId corresponding to higher-layer signaling. If an E field is configured as 1, this field may be used to express the TCI-StateId that can be expressed by 7 bits. If the E field is configured as 0, 7 bits of this field may be considered as reserved bits.

If the UE receives a configuration of a joint TCI state scheme for the corresponding cell through higher-layer signaling, the UE may receive activation of a maximum of two joint TCI states per codepoint in the TCI state field within DCI through the corresponding MAC-CE, and thus the UE may analyze two octets per codepoint in the TCI state field within DCI through the corresponding MAC-CE and receive activation of one or two joint TCI states. For example, the UE may apply information which can be obtained through two octets (for example, October 3 and October 4) from the third octet (for example, October 3) of the corresponding MAC-CE to a first codepoint in the TCI state field within DCI and then sequentially apply two octets to the next codepoint in the similar way. Accordingly, the TCI state field within DCI may include a maximum of 8 codepoints through 3 bits and the UE may expect that two octets are always included in the corresponding MAC-CE for each codepoint in the TCI state field within DCI, and thus a total length of the corresponding MAC-CE may be a maximum of 18 octets. Further, the UE may have 4 bits of the TCI state field within DCI through additional higher-layer signaling (for example, the UE may receive a configuration of 4 bits as the length of the TCI state field within DCI) in which case the TCI state field within DCI may include a maximum of 16 codepoints and the UE may expect that two octets are always included in the corresponding MAC-CE for each codepoint in the TCI state field within DCI, and thus the total length of the corresponding MAC-CE may be a maximum of 34 octets. That is, the total length of the corresponding MAC-CE may vary depending on the corresponding length of the TCI state field within DCI. For example, the total length of the corresponding MAC-CE may be a maximum of 18 octets when the TCI state field within DCI is 3 bits, and the total length of the corresponding MAC-CE may be a maximum of 34 octets when the TCI state field within DCI is 4 bits. Through the corresponding MAC-CE, the UE may receive activation of each of a first TCI state and a second TCI state which can be activated for respective codepoints in the TCI state field within DCI through a TCI state ID field existing in a first octet and a second octet of the two octets corresponding to the corresponding codepoints. At this time, when the UE receives scheduling from the BS by using a multi-TRP transmission/reception scheme, the UE may understand that the first TCI state is TCI state information corresponding to a first TRP and understand that the second TCI state is TCI state information corresponding to a second TRP.

For a an arbitrary codepoint in the TCI state field within DCI, if the UE identifies/checks that a value of the E field within the octet corresponding to the first TCI state is 1 and a value of the E field within the octet corresponding to the second TCI state is 0 through the corresponding MAC-CE, the UE may know the first TCI state of the corresponding codepoint, based on information on the TCI state ID field existing in the corresponding octet within the MAC-CE and may consider that there is no activation indication of the second TCI state through the MAC-CE. That is, if the UE receive an indication of the corresponding codepoint from the BS through DCI, the UE may consider that the corresponding codepoint includes only information on the first TCI state and does not include information on the second TCI state.

For a an arbitrary codepoint in the TCI state field within DCI, if the UE identifies/checks that a value of the E field within the octet corresponding to the first TCI state is 0 and a value of the E field within the octet corresponding to the second TCI state is 1 through the corresponding MAC-CE, the UE may consider that there is no activation indication of the first TCI state through the MAC-CE and consider that the second TCI state can be known based on information on the TCI state ID field existing in the corresponding octet within the MAC-CE. That is, if the UE receive an indication of the corresponding codepoint from the BS through DCI, the UE may consider that the corresponding codepoint includes only information on the second TCI state and does not include information on the first TCI state.

For a an arbitrary codepoint in the TCI state field within DCI, if the UE identifies/checks that a value of the E field within the octet corresponding to the first TCI state is 1 and a value of the E field within the octet corresponding to the second TCI state is 1 through the corresponding MAC-CE, the UE may consider that the first TCI state and the second TCI state of the corresponding codepoint can be known based on information on the TCI state ID field existing in the corresponding octet within the MAC-CE. That is, if the UE receive an indication of the corresponding codepoint from the BS through DCI, the UE may consider that the corresponding codepoint includes information on both the first TCI state and the second TCI state.

If the UE receives a configuration of a separate TCI state scheme for the corresponding cell through higher-layer signaling, the UE may receive activation of a maximum of two DL TCI states and a maximum of two UL TCI states per codepoint in the TCI state field within DCI through the corresponding MAC-CE, and thus the UE may analyze four octets per codepoint in the TCI state field within DCI through the corresponding MAC-CE and receive activation of the DL TCI state and the UL TCI state. For example, the UE may apply information which can be obtained through four octets (for example, October 3 to October 6) from the third octet (for example, October 3) of the corresponding MAC-CE to the first codepoint in the TCI state field within DCI and then sequentially apply four octets to the next codepoint in the similar way. Accordingly, the TCI state field within DCI may include a maximum of 8 codepoints through 3 bits and the UE may expect that four octets are always included in the corresponding MAC-CE for each codepoint in the TCI state field within DCI, and thus a total length of the corresponding MAC-CE may be a maximum of 34 octets. Further, the UE may have 4 bits of the TCI state field within DCI through additional higher-layer signaling (for example, the UE may receive a configuration of 4 bits as the length of the TCI state field within DCI) in which case the TCI state field within DCI may include a maximum of 16 codepoints and the UE may expect that four octets are always included in the corresponding MAC-CE for each codepoint in the TCI state field within DCI, and thus the total length of the corresponding MAC-CE may be a maximum of 66 octets. That is, the total length of the corresponding MAC-CE may vary depending on the corresponding length of the TCI state field within DCI. For example, the total length of the corresponding MAC-CE may be a maximum of 34 octets when the TCI state field within DCI is 3 bits, and the total length of the corresponding MAC-CE may be a maximum of 66 octets when the TCI state field within DCI is 4 bits. Through the corresponding MAC-CE, the UE may receive activation of each of the first DL TCI state and the second DL TCI state which can be activated for each codepoint in the TCI state field within DCI through the TCI state ID field existing in the first octet and the second octet among four octets corresponding to the corresponding codepoint and receive activation of each of the first UL TCI state and the second UL TCI state through the TCI state ID field existing in the third octet and the fourth octet among the four octets corresponding to the corresponding codepoint. At this time, when the UE receives scheduling from the BS by using a single or multi-TRP transmission/reception scheme, the UE may understand that the first DL TCI state and the first UL TCI state are TCI state information corresponding to the first TRP and understand that the second DL TCI state and the second UL TCI state are TCI state information corresponding to the second TRP. In the disclosure, the terms of the first (DL/UL) TCI state, the second (DL/UL) TCI state, and TCI in a specific order (for example, corresponding to different TRPs) are terms used for convenience in order to distinguish different TCI states and are not limited to interpretation indicating the relationship of the order between the two.

For example, for a an arbitrary codepoint in the TCI state field within DCI, if the UE identifies that a value of the E field within the octet corresponding to the first TCI state is 1 and a value of the E field within the octet corresponding to the second TCI state, the third TCI state, and the fourth TCI state is 0 through the corresponding MAC-CE, the UE may know the first DL TCI state of the corresponding codepoint, based on information on the TCI state ID field existing in the corresponding octet within the MAC-CE and consider that there is no activation indication of the second DL TCI state, the first UL TCI state, and the second UL TCI state through the MAC-CE. That is, if the UE receive an indication of the corresponding codepoint from the BS through DCI, the UE may consider that the corresponding codepoint includes only information on the first DL TCI state and does not include information on the second DL TCI state, the first UL TCI state, and the second UL TCI state. As described above, through the values of the E field existing in four octets corresponding to a an arbitrary codepoint in the TCI state field within DCI, the UE may know that a combination of one or more of the first DL TCI state, the second DL TCI state, the first UL TCI state, and the second UL TCI state is indicated in the corresponding codepoint and indication information of the remainder is not included/indicated within the corresponding MAC-CE.
E 2120: this field may indicate information that determines whether the TCI state ID field within the same octet indicates a TCI state or is a reserved field. The TCI state ID field within the same octet may indicate the TCI state if this field is 1, and the TCI state ID field within the same octet may be the reserved field if this field is 0.
R: indicates a reserved bit and may be configured as 0.

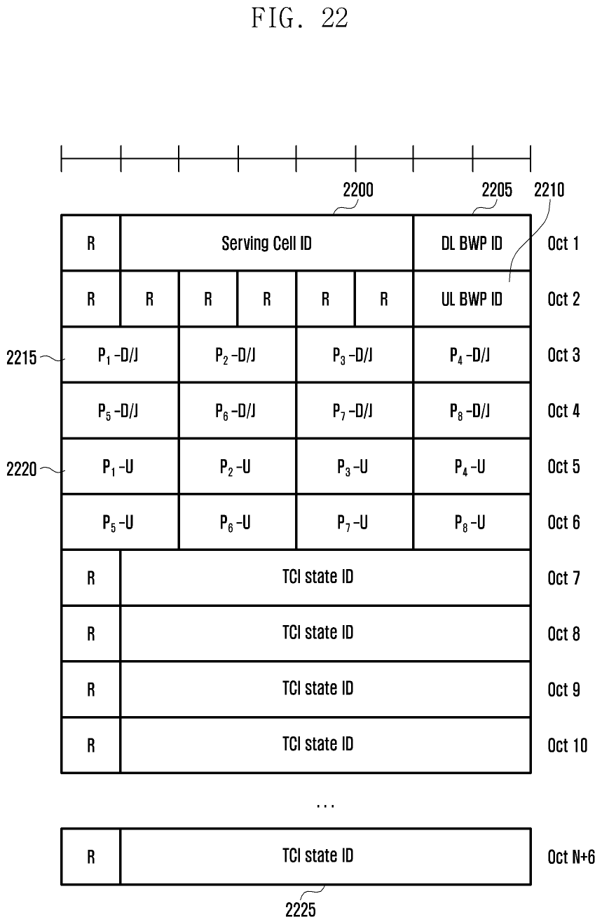

FIG. 22 illustrates another MAC-CE format for activating and indicating a plurality of joint TCI states, or separate DL or UL TCI states in a wireless communication system according to an embodiment of the disclosure. The meaning of each field within the corresponding MAC-CE format is described below.
Serving cell ID 2200: this field may indicate a service cell to which the corresponding MAC-CE is applied. The length of this field may be 5 bits. If the serving cell indicated by this field is included in one or more of simultaneousU-TCI-UpdateList1, simultaneousU-TCI-UpdateList2, simultaneousU-TCI-UpdateList3, or simultaneousU-TCI-UpdateList4 which is higher layer signaling, the corresponding MAC-CE may be applied to all serving cells included in a list of one or more of simultaneousU-TCI-UpdateList1, simultaneousU-TCI-UpdateList2, simultaneousU-TCI-UpdateList3, and simultaneousU-TCI-UpdateList4 including the serving cell indicated by this field.
DL BWP ID 2205: this field may indicate a DL BWP to which the corresponding MAC-CE is applied. The meaning of each codepoint in this field may correspond to each codepoint of a bandwidth part indicator within DCI. The length of this field may be 2 bits.
UL BWP ID 2210: this field may indicate a UL BWP to which the corresponding MAC-CE is applied. The meaning of each codepoint in this field may correspond to each codepoint of a bandwidth part indicator within DCI. The length of this field may be 2 bits.
Pi-D/J 2215: this field may indicate whether there is an indication for the first DL TCI state or the first joint TCI state, or the second TCI state or the second joint TCI state in the ith codepoint in the TCI state field within DCI. The UE may define the TCI state field within DCI as 3 bits (the length of the TCI state field within DCI may be defined as 4 bits) in which case the UE may have this field to correspond to all codepoints, and thus two octets may be used within the corresponding MAC-CE. Further, the UE may have the TCI state field within DCI as 4 bits (for example, the UE may receive a configuration of the length of the TCI state field within DCI as 4 bits) through additional higher-layer signaling in which case the TCI state field within DCI may include a maximum of 16 codepoints and, in this even, four octets may be used within the corresponding MAC-CE. That is, the number of octets used as this field may vary depending on the length of the TCI state field within DCI. For example, two octets may be used when the TCI state field within DCI is 3 bits, and four octets may be used when the TCI state field within DCI is 4 bits.

If the UE receives a configuration of the joint TCI state scheme for the corresponding cell through higher-layer signaling, a first bit in this field may indicate whether an indication for the first joint TCI state is included in the ith codepoint and a second bit may indicate whether an indication for the second joint TCI state is included in the ith codepoint.

If the UE receives a configuration of the separate TCI state scheme for the corresponding cell through higher-layer signaling, a first bit in this field may indicate whether an indication for the first DL TCI state is included in the ith codepoint and a second bit may indicate whether an indication for the second DL TCI state is included in the ith codepoint.
Pi-U 2220: this field may indicate whether there is an indication for the first UL TCI state or the second UL TCI state in the ith codepoint in the TCI state field within DCI. This field may exist only for the case where the UE receives a configuration of the separate TCI state scheme for the corresponding cell through higher-layer signaling, and, if the UE receives a configuration of the joint TCI state scheme for the corresponding cell through higher-layer signaling, this field may not exist. The UE may define the TCI state field within DCI as 3 bits (the length of the TCI state field within DCI may be defined as 3 bits) in which case the UE may have this field to correspond to all codepoints, and thus two octets may be used within the corresponding MAC-CE. Further, the UE may have the TCI state field within DCI as 4 bits (for example, the UE may receive a configuration of the length of the TCI state field within DCI as 4 bits) through additional higher-layer signaling in which case the TCI state field within DCI may include a maximum of 16 codepoints and, in this even, four octets may be used within the corresponding MAC-CE. That is, the number of octets used as this field may vary depending on the length of the TCI state field within DCI. For example, two octets may be used when the TCI state field within DCI is 3 bits, and four octets may be used when the TCI state field within DCI is 4 bits.
TCI state ID 2225: this field may indicate a TCI state that can be detected by a TCI-StateId corresponding to higher layer signaling.

If the UE receives a configuration of the joint TCI state scheme for the corresponding cell through higher-layer signaling, the UE may receive activation of a maximum of two joint TCI states per codepoint in the TCI state field within DCI through the corresponding MAC-CE. The UE may analyze the Pi-D/J field and consider octets having the TCI state ID field corresponding to the number of 1 as activation information for the ith codepoint in the TCI state within DCI.

If the Pi-D/J field is 10, the UE may assume that the number of octets including activated TCI state ID information in the ith codepoint in the TCI state field within DCI is one and assume that the TCI state ID field existing in the corresponding one octet is applied to the first joint TCI state.

If the Pi-D/J field is 01, the UE may assume that the number of octets including activated TCI state ID information in the ith codepoint in the TCI state field within DCI is one and assume that the TCI state ID field existing in the corresponding one octet is applied to the second joint TCI state.

If the Pi-D/J field is 11, the UE may assume that the number of octets including activated TCI state ID information in the ith codepoint in the TCI state field within DCI is two in the corresponding MAC-CE and assume that the TCI state ID fields existing in the corresponding two octets are applied to the first joint TCI state and the second joint TCI state, respectively.

If the UE receives a configuration of the separate TCI state scheme for the corresponding cell through higher-layer signaling, the UE may receive activation of a maximum of two DL TCI states and a maximum of two UL TCI states per codepoint in the TCI state field within DCI through the corresponding MAC-CE. The UE may analyze the Pi-D/J field and the Pi-U field and consider octets having the TCI state ID field corresponding to the number of 1 in the two fields as activation information for the ith codepoint in the TCI state within DCI.

If the Pi-D/J field is 10 and the Pi-U field is 00, the UE may assume that the number of octets including activated TCI state ID information in the ith codepoint in the TCI state field within DCI is one and assume that the TCI state ID field existing in the corresponding one octet is applied to the first DL TCI state.

If the Pi-D/J field is 01 and the Pi-U field is 10, the UE may assume that the number of octets including activated TCI state ID information in the ith codepoint in the TCI state field within DCI is two in the corresponding MAC-CE and assume that the TCI state ID field existing in the first octet is applied to the second DL TCI state and the TCI state ID field existing in the second octet is applied to the first UL TCI state.

Similar to this, the UE may detect a bitmap of the Pi-D/J field and the Pi-U field to assume that the number of octets applied to the ith codepoint in the TCI state field within DCI is determined according to the total number of 1, and may detect which DL TCI state and UL TCI state information is included in the ith codepoint according to the location of 1 in the Pi-D/J field and the Pi-U field.
R: indicates a reserved bit and may be configured as 0.

unifiedTCI-State Type-r17 in MIMOparam-r17 within ServingCellConfig corresponding to higher-layer signaling may be defined as a new parameter like unifiedTCI-State Type-r18 in MIMOparam-r18 corresponding to higher-layer signaling, or the existing parameter may be reused.

If the UE receives a configuration of SSB-MTCAdditionalPCI corresponding to higher-layer signaling from the BS, the UE may assume that some of all TCI states configured by higher-layer signaling are connected to a physical cell ID (PCID) of the serving cell. The UE may assume that the remainders of all TCI states configured by higher-layer signaling are connected to PCIDs different from that of the serving cell (PCIDs different from the PCID of the serving cell). At this time, all of the TCI states connected to the PCIDs different from that of the serving cell may be connected to the same PCID, or some thereof may be connected to a specific PCID and the remainders may be connected to other PCIDs. That is, the remaining TCI states except for the TCI states connected to the PCID of the serving cell among all TCI states configured by higher-layer signaling may be connected to PCIDs different from that of the serving cell. In this case, the PCIDs different from the PCID of the serving cell may be connected to at least some of the remaining TCI states, and the number of different PCIDs may be two or more different PCIDs. At this time, it may be assumed that TCI states and PCIDs are connected/correspond in m-to-one correspondence (m being 1 or a natural number larger than 1 (larger than or equal to 2)). That is, one PCID may be connected/correspond to at least one TCI state, and one TCI state may be connected/correspond to one PCID. If the UE receives activation of one or two TCI states for at least one codepoint in the TCI state fields within PDCCHs from the BS, the UE may assume that one of the following examples is possible for one or two TCI states activated in each codepoint.
[TCI state field activation example 1] one TCI state connected to a PCID of the serving cell may be activated in a an arbitrary codepoint.
[TCI state field activation example 2] one TCI state connected to a PCID different from that of the serving cell may be activated in a an arbitrary codepoint.
[TCI state field activation example 3] two TCI states connected to the PCID of the serving cell may be activated in a an arbitrary codepoint.
[TCI state field activation example 4] two TCI states may be activated in a an arbitrary codepoint, and one of the two TCI states may be connected to the PCID of the serving cell and the other one may be connected to a PCID different from that of the serving cell.
[TCI state field activation example 5] two TCI states connected to PCIDs different from that of the serving cell may be activated in a an arbitrary codepoint, and the two PCIDs may be the same as each other.
[TCI state field activation example 6] two TCI states connected to PCIDs different from that of the serving cell may be activated in a an arbitrary codepoint, and the two PCIDs may be different from each other.

If the UE receives an indication of a plurality of TCI states or an activation indication through the MAC-CE defined in FIGS. 19 and 20, the UE may expect that the plurality of TCI states is connected to the PCID of the serving cell or PCIDs different form that of the serving cell in at least one of the examples (for example, at least one of [TCI state field activation example 1] to [TCI state field activation example 6]). If some or all of the plurality of TCI states are connected to PCIDs different from that of the serving cell, the UE may expect that there are fields expressing an additional serving cell ID and uplink and downlink bandwidth part IDs connected thereto in the MAC-CE defined in FIGS. 19 and 20.

### Second Embodiment: Method of Partially and Entirely Applying Multiple TCI State Indications Based on a Unified TCI Scheme

As an embodiment of the disclosure, a method of partially and entirely applying multiple TCI state indications based on a unified TCI scheme is described in detail. Operations of the UE and the BS in this embodiment may be combined with operations of the UE and the BS in other embodiments of the disclosure.

If the UE receives a configuration of a joint TCI state scheme within a specific cell from the BS through higher-layer signaling, the UE may receive activation of information on each codepoint in the TCI state field within DCI through the MAC-CE transmitted from the BS as described above. When the UE receives a configuration of the joint TCI state scheme, the UE may receive activation information for each codepoint in the TCI state field within DCI through the MAC-CE. At this time, the UE may identify information on whether each codepoint in the TCI state field includes one or a plurality of joint TCI states through reception of the MAC-CE. Further, the UE may identify whether each codepoint includes a first joint TCI state, a second joint TCI state, or both of them. For example, the UE may receive activation information indicating that the first joint TCI state is included and the second joint TCI state is not included in a an arbitrary codepoint in the TCI state field within DCI through the MAC-CE. In another example, the UE may receive activation information indicating that the first joint TCI state is not included and the second joint TCI state is included in a an arbitrary codepoint in the TCI state field within DCI through the MAC-CE. In another example, the UE may receive activation information indicating that the first joint TCI state and the second joint TCI state are included in a an arbitrary codepoint in the TCI state field within DCI through the MAC-CE.

The UE may follow the indicated TCI state from a specific time according to the beam application time, depending on a codepoint which the TCI state field within DCI transmitted from the BS means. For example, from the first slot after OFDM symbols corresponding to a beam application time (OFDM symbols configured as the beam application time or the beam application time) from the last symbol of transmission of a PUCCH including positive ACK information for the corresponding DCI after the UE receives the DCI, the following two methods may be used to indicate how to apply one or a plurality of TCI states included in codepoints indicated through the TCI state fields within the corresponding DCI.

In the following description, as described above, a time at which multiple TCI states indicated to the UE through the DCI by the BS are applied is named as a beam application time, and the beam application time may be defined from the first slot after OFDM symbols corresponding to the beam application time (OFDM symbol configured as the beam application time or the beam application time) from the last symbol of transmission of the PUCCH including positive ACK information for the corresponding DCI after the UE receives the DCI as described above.

### [Method of Partially Applying Multiple TCI State Indications]

The UE may use a method of partially applying multiple TCI state indications from the BS. The partial application may mean that the UE distinguishes first TCI state and second TCI state indications and partially applies the same. For example, when the UE receives DCI from the BS, and the corresponding DCI includes only indication information for the first TCI state and does not include indication information for the second TCI state, the UE may apply the first TCI state included in the indicated codepoint to slots, starting at the first slot after OFDM symbols corresponding to the beam application time (OFDM symbols configured as the beam application time or the beam application time) after PUCCH transmission for the corresponding DCI. In this case, since there is no indication information for the second TCI state in the UE, the UE may use the corresponding second TCI state if the UE had the second TCI state already indicated and applied by the BS in the past, and may still not use the second TCI state if the UE had no indication for the second TCI state from the BS in the past. As described above, the UE may apply the TCI state including indication information and may not perform any operation for the TCI state location which does not include indication information.

### [Method of Entirely Applying Multiple TCI State Indications]

The UE may use a method of entirely applying multiple TCI state indications from the BS. The entire application may mean that the UE entirely applies indications for the first TCI state and the second TCI state as one indication. For example, when the UE receives DCI from the BS, and the corresponding DCI includes only indication information for the first TCI state and does not include indication information for the second TCI state, the UE may understand the corresponding indication from the BS as performance of uplink and downlink transmission and reception using only the first TCI state. That is, the UE may apply the first TCI state included in the indicated codepoint to slots, starting at the first slot after OFDM symbols corresponding to the beam application time (OFDM symbols configured as the beam application time or the beam application time) after PUCCH transmission for the corresponding DCI and may not use the second TCI state after the beam application time. If the UE had the second TCI state already applied in the past, the UE may not use the corresponding second TCI state after the beam application time. That is, if the indication of the codepoints in the TCI state fields which the UE receives from the BS do not include indication information for the first TCI state or the second TCI state, the corresponding indication may mean that the corresponding first TCI state or second TCI state is not used.

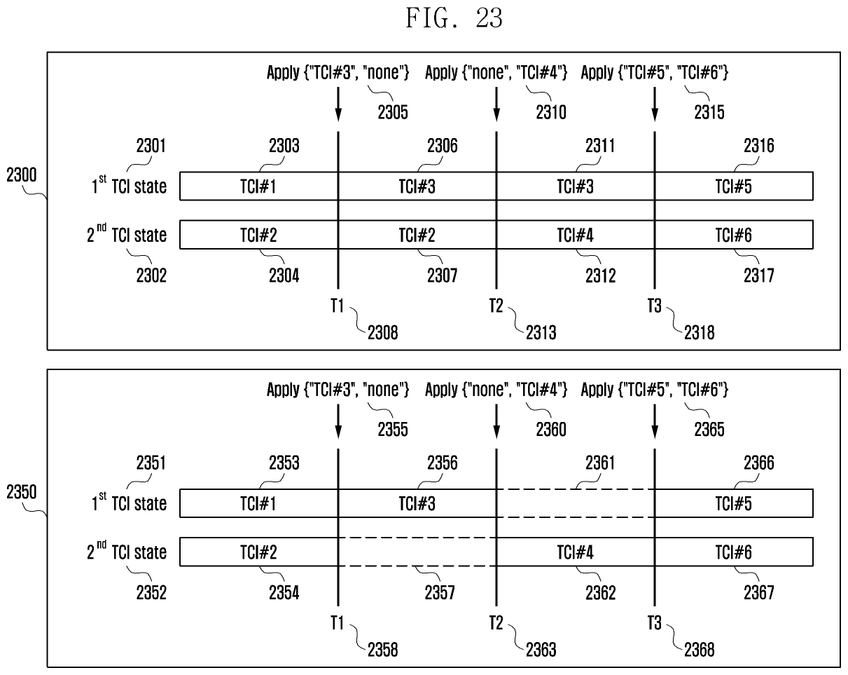

FIG. 23 illustrates a partial application method 2300 and an entire application method 2350 for multiple TCI state indications based on a unified TCI scheme in a wireless communication system according to an embodiment of the disclosure.

First, the method 2300, in which the UE uses the [Method of partially applying multiple TCI state indications] from the BS, is described.
The UE may receive an indication of TCI #1 2303 for a first TCI state 2301 and TCI #2 2304 for a second TCI state 2302 and apply the same before a time point T1 2308.
Thereafter, the UE may receive an additional TCI state indication from the BS and apply corresponding indication information 2305 at the time point T1 2308 after the beam application time. For example, the corresponding indication may indicate/include TCI #3 for the first TCI state 2301 and there may no indication information for the second TCI state 2302 (does not include indication information) (in FIG. 23, the case where there is no indication information is expressed as none). In this case, the UE may replace TCI #1 2303 previously applied to the first TCI state 2301 with TCI #3 2306 and use TCI #3 2306. Unlike this, since the second TCI state 2302 is not included in TCI state indication information received from the BS, the UE may apply previously applied TCI #2 2304 even after the time point T1 2308 as indicated by reference numeral 2307.
Thereafter, the UE may receive an additional TCI state indication from the BS and apply corresponding indication information 2310 at a time point T2 2313 after the beam application time. For example, there is no indication information for the first TCI state 2301 (indication information is not included), and the corresponding indication may indicate/include TCI #4 for the second TCI state 2302. In this case, the UE may replace TCI #2 2307 previously applied to the second TCI state 2302 with TCI #4 2312 and use TCI #4 2312. Unlike this, since the first TCI state 2301 is not included in TCI state indication information from the BS, the UE may apply previously applied TCI #3 2306 even after the time point T2 2313 as indicated by reference numeral 2311.
Thereafter, the UE may receive an additional TCI state indication from the BS and apply corresponding indication information 2315 at a time point T3 2318 after the beam application time. For example, the corresponding indication may indicate/include TCI #5 for the first TCI state 2301 and indicate/include TCI #6 for the second TCI state 2302. In this case, the UE may replace TCI #3 2311 previously applied to the first TCI state 2301 with TCI #5 2316 and use TCI #5 2316 and replace TCI #4 2312 previously applied to the second TCI state 2302 with TCI #6 2317 and use TCI #6 2317.

Subsequently, the method 2350, in which the UE uses the [Method of entirely applying multiple TCI state indications] from the BS, is described.
The UE may receive an indication of TCI #1 2353 for a first TCI state 2351 and TCI #2 2354 for a second TCI state 2352 and apply the same before a time point T1 2358.
Thereafter, the UE may receive an additional TCI state indication from the BS and apply corresponding indication information 2355 at the time point T1 2358 after the beam application time. For example, the corresponding indication may indicate/include TCI #3 for the first TCI state 2351 and there may no indication information for the second TCI state 2352 (does not include indication information) (in FIG. 23, the case where there is no indication information is expressed as none). In this case, the UE may replace TCI #1 2353 previously applied to the first TCI state 2301 with TCI #3 2356 and use TCI #3 2356. Unlike this, since the second TCI state 2352 is not included in TCI state indication information received from the BS, the UE may not use previously applied TCI #2 2304 after the time point T1 2308 as indicated by reference numeral 2357. That is, the UE may use only the first TCI state and cannot use the second TCI state from the time point T1 2358. Like the second TCI state, the case where the TCI state previously applied to the second TCI state is not used through the application of indications from the BS may be named a reset. According to the corresponding indication having no indication information for the second TCI state 2352, the second TCI state 2352 may be reset.
Thereafter, the UE may receive an additional TCI state indication from the BS and apply corresponding indication information 2360 at a time point T2 2363 after the beam application time. For example, there is no indication information for the first TCI state 2351 (indication information is not included), and the corresponding indication may indicate/include TCI #4 for the second TCI state 2352. In this case, the UE may apply TCI #4 2362 to the (reset) second TCI state 2352 having no applied TCI state due to the previous indication and use TCI #4 2362. Unlike this, since the first TCI state 2351 is not included in TCI state indication information received from the BS, the UE may not use previously applied TCI #3 2356 after the time point T2 2363 as indicated by reference numeral 2361, and consider that the first TCI state is reset. That is, the UE may use only the second TCI state and cannot use the first TCI state from the time point T2 2363.
Thereafter, the UE may receive an additional TCI state indication from the BS and apply corresponding indication information 2365 at a time point T3 2368 after the beam application time. For example, the corresponding indication may indicate/include TCI #5 for the first TCI state 2351 and indicate/include TCI #6 for the second TCI state 2352. In this case, the UE may apply TCI #5 2366 to the (reset) first TCI state 2351 having no applied TCI state due to the previous indication and use TCI #5 2366. Further, the UE may replace TCI #4 2362 previously applied to the second TCI state 23-52 with TCI #6 2367 and use TCI #6 2367.

The UE may receive a configuration of one of the method of partially or entirely applying multiple TCI state indications from the BS through higher-layer signaling, receive activation thereof through the MAC-CE, receive a dynamic configuration thereof through L1 signaling, follow the definition fixed to the standard, or receive a notification thereof through a combination of one or more of higher-layer signaling, the MAC-CE, and L1 signaling. The UE may use one configured/activated/indicated/notified/defined method between the partial application method and the entire application method.

The methods of partially and entirely applying multiple TCI state indications may be similarly applied to the case where the UE receives the MAC-CE (for example, the MAC-CE defined in FIGS. 19, 20, 21, and 22) defined for the multiple TCI state indications from the BS and the corresponding MAC-CE includes only information on one codepoint in the TCI state field.

The UE may report one of the [Method of partially applying multiple TCI state indications] and the [Method of entirely applying multiple TCI state indications] as a UE capability. At this time, the corresponding UE capability may be an individual UE capability or a single UE capability and a value supported by the UE, and the UE may report one of the [Method of partially applying multiple TCI state indications] and the [Method of entirely applying multiple TCI state indications] to the BS. For example, the report on the corresponding UE capability may include one or more of a UE capability for the [Method of partially applying multiple TCI state indications] (whether it is supported by the UE) or a UE capability for the [Method of entirely applying multiple TCI state indications] (whether it is supported by the UE). The report on the corresponding UE capability may include information on at least one method supported by the UE among the [Method of partially applying multiple TCI state indications] or the [Method of entirely applying multiple TCI state indications]. Further, if one of the [Method of partially applying multiple TCI state indications] and the [Method of entirely applying multiple TCI state indications] is fixedly defined in the standard and used when a plurality of unified TCI states is indicated and applied, the operation itself of reporting a basic UE capability that means that the UE can indicate a plurality of unified TCI states may be defined to allow the BS to identify that the corresponding UE automatically supports the corresponding function.

Although the embodiment has described only the case where the UE receives the configuration of the joint TCI state scheme within a specific cell through higher-layer signaling, the embodiment may be similarly applied to the case where the UE receives a configuration of a separate TCI state scheme within a specific cell through higher-layer signaling.

### Third Embodiment: Reset Method when Partially Application is Made to Multiple TCI State Indications Based on a Unified TCI Scheme

As an embodiment of the disclosure, a reset method when the partial application is made to multiple TCI state indications based on the unified TCI scheme is described. Operations of the UE and the BS in this embodiment may be combined with operations of the UE and the BS in other embodiments of the disclosure.

For the TCI state in the specific order (for example, the first TCI state or the second TCI state), if the UE identifies that indication information for the first TCI state or the second TCI state is not included in the TCI state field indicated by the BS, the reset may refer to a situation where the UE does not use the TCI state previously applied to the first TCI state or the second TCI state through the application of the corresponding indications from the BS. Accordingly, when the UE uses the [Method of entirely applying multiple TCI state indications], the TCI state in a specific order can be reset as described above, and the UE may consider that indication information for the TCI state in the specific order (for example, the first TCI state or the second TCI state) being not included in a specific codepoint in the TCI state field within DCI means the reset. This may have a meaning that the UE may receive only scheduling information for communication with a specific TRP by a TCI state field indication through DCI from the BS in which case the UE may use only the TCI state in the corresponding specific order (for example, the first TCI state) and may not use the TCI state in the remaining specific order (for example, the second TCI state).

The reset method according to an embodiment may reduce burden of buffers of the UE and burden of power consumption that may be generated when buffering is always performed using two TCI states in downlink reception of the UE. Further, in an aspect of scheduling by the BS, it may be efficient to indicate only one TCI state rather than to indicate a plurality of TCI states to the UE, and indicate scheduling from a TRP corresponding to the corresponding TCI state in a satiation where single TRP scheduling is more suitable than multi-TRP scheduling due to a blockage state where a signal from a specific TRP is blocked by an obstacle, a state where a channel state is not good, or a state where path attenuation is very large, and in this case, the reset method according to an embodiment may be applied.

Unlike this, when the [Method of partially applying multiple TCI state indications] is used, the multiple TCI state indicates are partially applied as described above, and thus the UE may maintain the use of the corresponding first TCI state or second TCI state and may not make any change even though, with respect to a TCI state in a specific order (for example, for the first TCI state or the second TCI state), the UE identifies that indication information for the first TCI state or the second TCI state is not included in the TCI state field indicated by the BS. In another meaning, when the [Method of partially applying multiple TCI state indications] is used, the UE cannot reset, which may cause power consumption of the UE and increase burden of buffer storage.

In the following description, various methods for supporting the reset method of the [Method of partially applying multiple TCI state indications] are described. Based on a combination of one or more of the following various methods, the reset method of the [Method of partially applying multiple TCI state indications] may be supported.

### [Method 3-1] Method Based on TCI Selection Field

The UE may define a TCI selection field as 2 bits in order to support a dynamic switching function for single or multi-TRP-based PDSCH scheduling according to scheduling DCI in a unified TCI scheme. The size of the TCI selection field may be defined as 2 bits in order to support the dynamic switching function for single or multi-TRP-based PDSCH scheduling according to scheduling DCI in the unified TCI scheme. The existing single DCI-based single and multi-TRP PDSCH schedulings may be distinguished by the number of TCI states indicated by TCI state fields, but in the unified TCI scheme, a TCI state of a PDSCH that schedules scheduling DCI cannot be directly indicated, and thus the TCI selection field may be defined as 1 bit or 2 bits in DCI format 1-1 or 1_2 and used for the dynamic switching between the single and multi-TRP-based PDSCH schedulings. At this time, for example, the UE may receive an indication of a separate TCI state set including two joint TCI states or two DL TCI states through the PDCCH or the MAC-CE, based on the unified TCI scheme and consider a situation after the beam application time corresponding to the indicated TCI state. That is, since the UE has been already received the indication of two TCI states and the beam application time has passed, the UE may assume a situation in which the application to the indicated TCI state is possible. Further, the TCI selection field within DCI may exist according to whether there is a configuration of higher-layer signaling corresponding to a UE capability report that may include information on whether the dynamic switching between the single DCI-based single and multi-TRP-based PDSCH scheduling can be performed in the unified TCI scheme. For example, when the UE capability report indicates that the UE can perform the dynamic switching, the TCI selection field may be included in the DCI. Otherwise, the TCI selection field may not be included in the DCI.
If a value of the TCI selection field is “00”, the UE may consider it as scheduling for a single TRP-based PDSCH which can be received using a first TCI state among the indicated TCI states.
If the value of the TCI selection field is “01”, the UE may consider it as scheduling for a single TRP-based PDSCH which can be received using a second TCI state among the indicated TCI states.
If the value of the TCI selection field is “10”, the UE may consider it as scheduling for a multi-TRP-based PDSCH which can be received using the indicated two TCI states. At this time, when the UE receives scheduling of time domain multiplexing (TDM)-based multi-TRP PDSCH repetitive transmission, the order of TCI state mapping may be considered from the first TCI state. That is, if the UE receives an indication of a TDRA entry including repetitionNumber of a value larger than or equal to 2 through a time domain resource allocation (TDRA) field within DCI, receives a configuration of slotBased for RepetitionSchemeConfig-r16 corresponding to higher-layer signaling, and receives a configuration of cyclicMapping for tciMapping corresponding to higher-layer signaling within slotBased, the UE may receive a PDSCH by applying first and second TCI states to odd-numbered and even-numbered PDSCH reception locations, respectively. That is, the UE may apply the first TCI state to the odd-numbered PDSCH reception location and apply the second TCI state to the even-numbered PDSCH reception location. For example, in the case of four PDSCH repetitive transmissions, the UE may apply the first TCI state to first and third PDSCHs and apply the second TCI state to second and fourth PDSCHs and receive the PDSCHs. Further, if the UE receives an indication of a TDRA entry including repetitionNumber of a value larger than or equal to 2 through a time domain resource allocation field within DCI, receives a configuration of slotBased for RepetitionSchemeConfig-r16 corresponding to higher-layer signaling, receives a configuration of sequentialMapping for tciMapping corresponding to higher-layer signaling within slotBased, the UE may apply the first TCI state to first two PDSCH reception locations and apply the second TCI state to next two PDSCH reception locations, and the operation may be repeated. For example, in the case of six PDSCH repetitive transmissions, the UE may apply the first TCI state to first, second, fifth, and sixth PDSCHs and apply the second TCI state to third and fourth PDSCHs and receive the PDSCHs.
If the value of the TCI selection field is “11”, the UE may consider a combination of one or more of [Method 3-1-1] to [Method 3-1-3] corresponding to the following detailed methods through which the reset can be supported. When the UE receives an indication of “11” from the BS through the TCI selection field, the UE may apply a combination of one or more of the following detailed methods after the beam application time, apply the combination after decoding for DCI including the corresponding TCI selection field, or apply the combination after a value of timeDurationForQCL reported as a UE capability from the last symbol of DCI including the corresponding TCI selection field, and/or a new application time for applying the indication for the reset may be defined and the application may be performed after the corresponding application time. When the UE receives “11” of the TCI selection field from the BS and receives scheduling of a PDSCH through DCI including the corresponding TCI selection field, there is no information on a dynamic TCI state selection and switching scheme in PDSCH reception that is the original role of the TCI selection field (that is, there is no information on which TCI state is applied to the corresponding PDSCH to perform reception among already applied multiple TCI states), the UE may always operate based on the first TCI state or operate based on the second TCI state, or operate based on one of the first and second TCI states according to a fixed rule. Alternatively, the UE may consider that the role of the TCI selection field is replaced according to which order of the TCI state is indicated by the codepoint indicated through the TCI state field within the corresponding DCI. For example, when the UE receives “11” of the value of the TCI selection field within DCI from the BS, a PDSCH scheduled to the UE through the same DCI may be received always using the first TCI state among the TCI states already applied to the UE. In another example, when the UE receives “11” of the value of the TCI selection field within DCI from the BS and TCI state fields indicated to the UE through the same DCI includes indication information for the first TCI state but does not include indication information for the second TCI state, a PDSCH scheduled to the UE through the same DCI may be received using the first TCI state.

[Method 3-1-1] if the UE receives “11” of a TCI selection field value from the BS, the UE may reset a TCI state in an order that does not include TCI state indication information in a codepoint indicated by a TCI state field within DCI including the corresponding TCI selection field. For example, if TCI #1 is not included in a first TCI state and indication information is not included in a second TCI state through the TCI state field, the UE may reset the second TCI state.

[Method 3-1-2] if the UE receives “11” of the TCI selection field value from the BS, the UE may always reset one of the first or second TCI state. The UE may receive a configuration of a rule indicating that one of the first TCI state and the second TCI state can be reset from the BS through higher-layer signaling, receive activation thereof through the MAC-CE, receive an indication thereof through L1 signaling, or receive a notification thereof by a combination of one or more of higher-layer signaling, the MAC-CE, and L1 signaling, or may follow something fixedly defined in the standard. The UE may reset one of the first TCI state or the second TCI state that is configured/activated/indicated/notified/defined.

[Method 3-1-3] if the UE receives “11” of the TCI selection field value from the BS, the UE may receive an indication of a change between the [Method of partially applying multiple TCI state indications] and the [Method of entirely applying multiple TCI state indications]. For example, it may be understood that the change between the partial application method and the entire application method may be indicated by a field different from the TCI selection field within the same DCI, indicated based on signaling different from that of DCI including the TCI selection field, indicated by reception of “11” as the TCI selection field value without separate signaling/information. That is, when the BS transmits “11” as the TCI selection field value, the UE receiving the same may understand that the indication of the change between the partial application method and the entire application method is received. That is, if the UE operates in the [Method of partially applying multiple TCI state indications] before receiving “11” as the TCI selection field value from the BS, the UE may change the method to the [Method of entirely applying multiple TCI state indications]. If the UE operates in the [Method of entirely applying multiple TCI state indications] before receiving “11” as the TCI selection field value from the BS, the UE may change the method to the [Method of partially applying multiple TCI state indications]. Accordingly, although the UE does not reset a TCI state in a specific order only through reception of “11” as the TCI selection field value, if the UE receives an indication of the change from the Method of partially applying multiple TCI state indications] to the [Method of entirely applying multiple TCI state indications], the UE may receive information indicating the reset of the TCI state in the specific order according to a TCI state indication to be received from the BS later.

### [Method 3-2] Addition of Indicator Having Meaning of Reset to TCI State Field Codepoint

The BS may add an indicator having the meaning of reset to a TCI state in a specific order within a codepoint of the TCI state field in DCI. For example, the UE may receive an indication of TCI #1 for a first TCI state and reset for a second TCI state as a first codepoint in the TCI state field. For comparison, the UE may assume that TCI #1 is not included in the first TCI state and indication information is not included in the second TCI state as a second codepoint in the TCI state field. In this case, if the UE receives an indication of the first codepoint for the TCI state field from the BS, the UE may reset the second TCI state after the beam application time. If the UE receives an indication of the second codepoint for the TCI state field from the BS, the UE may use the TCI state, which was applied before the beam application time, for the second TCI state after the beam application time without any change. To this end, the UE may expect that a scheme (indicator) indicating reset is included as well as the indication of the TCI state ID within the MAC-CE. For example, in the case of the MAC-CE in FIG. 21, if the E field within the octet including the TCI state ID field is 0 and all of 7 bits in the TCI state ID field are 0, it may mean that there is no indication information for the TCI state in the corresponding order. If the E field within the octet including the TCI state ID field is 1 and all of the 7 bits in the TCI state ID field are 1, it may mean an indicator having a meaning of reset for the TCI state in the corresponding order (or indication of reset for the TCI state in the corresponding order). In another example, in the case of the MAC-CE in FIG. 22, if the R field within the octet including the TCI state ID field is 1, it may mean an indicator having a meaning of reset for the TCI state in the corresponding order (or indication of reset for the TCI state in the corresponding order).

[Method 3-3] Reset in Case where TCI State which is the Same as Previously Applied TCI State is Indicated Through TCI State Field

When a TCI state which is the same as the previously indicated and applied TCI state is indicated for a TCI state in the same order through the TCI state field within DCI received from the BS, the UE may reset the TCI state in the corresponding order. For example, in the state where the UE receives an indication of TCI #1 for a first TCI state and TCI #2 for a second TCI state from the BS through the TCI state field within DCI and applies the same after the beam application time, if the UE receives an additional indication of TCI #3 for the first TCI state and TCI #2 for the second TCI state from the BS through the TCI state field within DCI, the UE may apply TCI #3, not TCI #1, to the first TCI state after the beam application time and reset the second TCI state after the beam application time since the UE receives the indication of TCI #2 that is the same as the previously applied TCI state for the second TCI state.

### [Method 3-4] Reset According to Activation State of TCI State Field Through MAC-CE

The UE may reset a TCI state in a specific order according to an activation state of a TCI state field within DCI through a MAC-CE received from the BS. For example, if the UE identifies that codepoints of all TCI state fields include indication information for the first TCI state but do not include indication information for the second TCI state from the BS through the MAC-CE, the UE may reset the second TCI state after 3 ms from transmission of a PUCCH including HARQ-ACK information for the corresponding MAC-CE that is a time point at which the corresponding MAC-CE is applied. In another example, if the UE identifies that codepoints of all TCI state fields include indication information for the second TCI state but do not include indication information for the first TCI state from the BS through the MAC-CE, the UE may reset the first TCI state after 3 ms from transmission of a PUCCH including HARQ-ACK information for the corresponding MAC-CE that is a time point at which the corresponding MAC-CE is applied. Unlike this, if codepoints of all TCI state fields do not include indication information for a TCI state corresponding to one order from the BS through the MAC-CE, the UE may identify that the reset is not indicated to the codepoint of the activated TCI state through the corresponding MAC-CE.

[Method 3-5] Case where there is No Candidate Beam Reference Signal (RS) in BFR for Each TRP

If the UE does not receive a configuration through SSB-MTCAdditionalPCI corresponding to higher-layer signaling, that is, when all TRPs have a physical cell ID which is the same as a physical cell ID of the serving cell, the UE and the BS may operate in an intra-cell multi-TRP environment.

In this method, a beam failure detection (BFD) RS set and a candidate beam RS may be assumed as follows. The UE may receive a configuration of two BFD RS sets and two candidate beam RS sets. A first BFD RS set may be connected to a first candidate beam RS set, and a second BFD RS set may be connected to a second candidate beam RS set. The UE may receive a configuration of the first BFD RS set and the second BFD RS set from the BS through failureDetectionSet1 and failureDetectionSet2 corresponding to higher-layer signaling. If the UE does not receive the configuration of the first BFD RS set and the second BFD RS set from the BS through failureDetectionSet1 and failureDetectionSet2 corresponding to higher-layer signaling, the UE may determine the first BFD RS set and the second BFD RS set according to higher-layer signaling for each CORESET or each CORESET group.

In this method, a link recovery request (LRR) for a beam failure recovery request (BFRQ) of the UE may be assumed as follows. If a primary cell (PCell) and a primary secondary cell or primary secondary cell group (SCG) cell (PSCell) is connected to the first BFD RS set and a first candidate beam RS set connected thereto, and the second BFD RS set and a second candidate beam RS set connected thereto, the UE may report that the number of LRRs which can be configured by the BS through higher-layer signaling is two through twoLRRcapacity corresponding to a UE capability report to the BS. The UE having not reported this may receive configuration information for a first LRR from the BS through schedulingRequestID-BFR corresponding to higher-layer signaling, and the UE having reported this may additionally receive configuration information for a second LRR from the BS through schedulingRequestID-BFR2 corresponding to higher-layer signaling. If the UE receives only the configuration for the first LRR from the BS through higher-layer signaling, the UE may perform PUCCH transmission for the LRR for the first BFD RS set and the second BFD RS set. If the UE receives the configuration for the first LRR and the second LRR from the BS through higher-layer signaling, the UE may use configuration information of the first LRR for the first BFD RS set and use configuration information of the second LRR for the second BFD RS set.

When the beam failure situation of the first BFD RS set, the second BFD RS set, or both of them is identified as described above, the UE may transmit the LRR to the BS and the BS may transmit PUCCH 1-1 corresponding thereto to the UE to indicate second PUSCH scheduling information. An enhanced BFR MAC-CE or a truncated enhanced BFR MAC-CE may be included in the corresponding second PUSCH. At this time, at least one piece of the following information may be included in the enhanced BFR MAC-CE or the truncated enhanced BFR MAC-CE.
Cell index(es) corresponding to a single BFD RS set having a link quality lower than a reference value
Information indicating whether there is a candidate beam RS selected from a single candidate beam RS set in cell index(es) corresponding to the single BFD RS set, and an index of the candidate beam RS if exists.
Cell index(es) of at least one of the first BFD RS set and the second BFD RS set having a link quality lower than a reference value

BFD RS set index(es) of the first BFD RS set and the second BFD RS set having a link quality lower than a reference value. For example, the BFD RS set index(es) may be included in the enhanced BFR MAC-CE or the truncated enhanced BFR MAC-C together with the cell index(es). For example, the BFD set index(es) may be sub information of the cell index(es).
Information indicating whether there is a candidate beam RS selected from each of the first candidate beam RS set and the second candidate beam RS set within cell index(es) corresponding to the first BFD RS set and the second BFD RS set, and an index of the candidate beam RS for each set if exists

For the serving cell(s) connected to the first BFD RS set and the first candidate beam RS set connected thereto, and the second BFD RS set and the second candidate beam RS set connected thereto, the UE may perform the following operation after 28 symbols from the last symbol of reception of PDCCH 2-1 including a HARQ process ID field and a toggled new data indicator (NDI) field value like PDCCH 1-1 scheduling the second PUSCH.
If there is no candidate beam RS in the enhanced BRF MAC-CE or the truncated enhanced BFR MAC-CE, the UE may make a configuration not to use a TCI state in an order corresponding to the currently failed TRP. For example, if the UE detects a BFD from the second BFD RS set, that is, for the second TRP and a BFRQ according thereto does not include a candidate beam RS, the UE may communicate only with the TRP corresponding to the first TCI state without using the second TCI state after 28 symbols from the last symbol of reception of PDCCH 2-1.

### [Method 3-6] DCI-Based Indication

The UE may receive an indication of a reset for a TCI state in a specific order from the BS through DCI. If the DCI received by the UE is DCI including scheduling information for a PDSCH or a PUSCH, a new field may be defined in the corresponding DCI and thus the corresponding field may indicate the reset. If the DCI received by the UE is DCI that does not include scheduling information for a PDSCH or a PUSCH, a new field may be defined in the corresponding DCI or the reset may be indicated according to reinterpretation for the existing fields. When following a new field or reinterpretation for the existing fields, the UE may apply the reset after the beam application time, apply the reset after decoding of the corresponding DCI, apply the reset after a timeDurationForQCL value reported as a UE capability from the last symbol of the corresponding DCI, and/or a new application time for applying the indication for the reset may be defined and then the reset may be applied after the corresponding application time.

### [Method 3-7] Use of New DCI Format and RNTI

The UE may receive an indication of a reset from the BS through a new DCI format or an RNTI. The new DCI format or the RNTI may be defined/configured for the reset. UE-specific or UE group common DCI may be defined through a new DCI format and a reset for a TCI state in a specific order may be indicated to the UE, and an RNTI scrambled in CRC attached to the existing DCI format may be newly defined and the reset may be indicated. When the UE receives an indication of the reset through the newly defined DCI format or the RNTI, the UE may apply the reset after the beam application time, apply the reset after decoding of the corresponding DCI, apply the reset after a timeDurationForQCL value reported as a UE capability from the last symbol of the corresponding DCI, and/or a new application time for applying the indication for the reset may be defined and then the reset may be applied after the corresponding application time.

### [Method 3-8] Selection of One of Combinations for the Methods

As a reset method of the UE for the [Method of partially applying multiple TCI state indications], the UE may receive a configuration of one of the combinations of one or more of [Method 3-1] to [Method 3-7] from the BS through higher-layer signaling, receive activation thereof through the MAC-CE, receive a dynamic indication thereof through L1 signaling, or receive a notification thereof through a combination of one or more of higher-layer signaling, the MAC-CE, and L1 signaling, or the configuration may be fixedly defined by the standard. The UE may use a combination of at least one of the configured/activated/indicated/notified/defined among [Method 3-1] to [Method 3-7].

As reset methods of the UE for the [Method of partially applying multiple TCI state indications], the combination of at least one of [Method 3-1] to [Method 3-8] may be defined as a UE capability that means supporting of the UE, and higher-layer signaling from the BS corresponding thereto may be defined. The UE may use a combination of at least one of the configured/activated/indicated/notified/defined among [Method 3-1] to [Method 3-8].

The UE using the [Method of partially applying multiple TCI state indications] may receive a MAC-CE (For example, the MAC-CE defined in FIGS. 19, 20, 21, and 22) defined for the multiple TCI state indicates from the BS, and, for the case where the corresponding MAC-CE includes only information for one codepoint in the TCI state field, may receive the reset indication even though the various methods are similarly applied to use the MAC-CE.

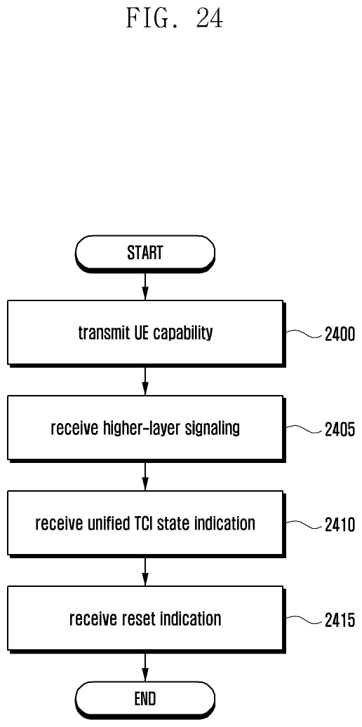

FIG. 24 illustrates an operation of the UE for a reset method when multiple TCI state indications based on a unified TCI scheme are partially applied in a wireless communication system according to an embodiment of the disclosure.

The UE may transmit a UE capability to the BS in operation 2400. At this time, the UE capability that can be included may be information indicating whether a plurality of unified TCI states can be supported, whether [Method of partially applying multiple TCI state indications] and [Method of entirely applying multiple TCI state indications] can be supported, and whether a combination of one or more of [Method 3-1] to [Method 3-8] can be supported.

Thereafter, the UE may receive higher-layer signaling configuration information from the BS in operation 2405. At this time, higher-layer signaling that can be included may be configuration information for the unified TCI state, [Method of partially applying multiple TCI state indications] and [Method of entirely applying multiple TCI state indications], and the combination of one or more of [Method 3-1] to [Method 3-8].

Thereafter, the UE may receive an indication of the unified TIC state from the BS through the TCI state field within DCI in operation 2410. Indication information for the corresponding unified TCI state may be applied to the UE after the beam application time.

If the UE operates in [Method of partially applying multiple TCI state indications], the UE may receive a reset indication from the BS in operation 2415. According to the corresponding reset indication, the UE may reset a TCI state in a specific order and may not use the TCI state in the corresponding order.

A more detailed operation of the UE according to an embodiment may be described based on the above-describe embodiments.

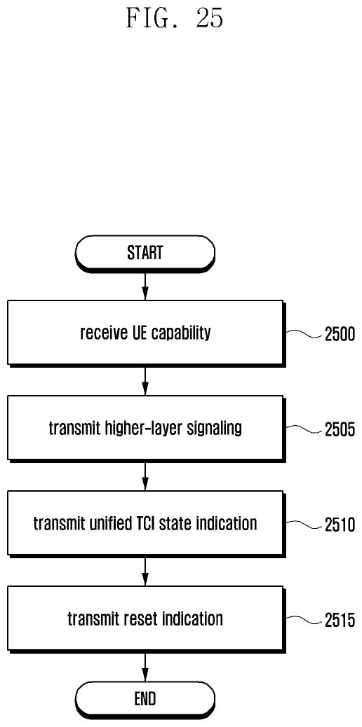

FIG. 25 illustrates an operation of the BS for a reset method when multiple TCI state indications based on a unified TCI scheme are partially applied in a wireless communication system according to an embodiment of the disclosure.

The BS may receive UE capability transmission of the UE in operation 2500. At this time, the UE capability that can be included may be information indicating whether a plurality of unified TCI states can be supported, whether [Method of partially applying multiple TCI state indications] and [Method of entirely applying multiple TCI state indications] can be supported, and whether a combination of one or more of [Method 3-1] to [Method 3-8] can be supported.

Thereafter, the BS may transmit higher-layer signaling configuration information to the UE in operation 2505. At this time, higher-layer signaling that can be included may be configuration information for the unified TCI state, [Method of partially applying multiple TCI state indications] and [Method of entirely applying multiple TCI state indications], and the combination of one or more of [Method 3-1] to [Method 3-8].

Thereafter, the BS may indicate the unified TIC state to the UE through the TCI state field within DCI in operation 2510. Indication information for the corresponding unified TCI state may be applied to the UE after the beam application time.

If the UE operates in [Method of partially applying multiple TCI state indications], the BS may transmit a reset indication to the UE in operation 2515. According to the corresponding reset indication, the BS may allow the UE to reset a TCI state in a specific order, and the BS may consider that the UE does not use the TCI state in the corresponding order.

A more detailed operation of the BS according to an embodiment may be described based on the above-described embodiments.

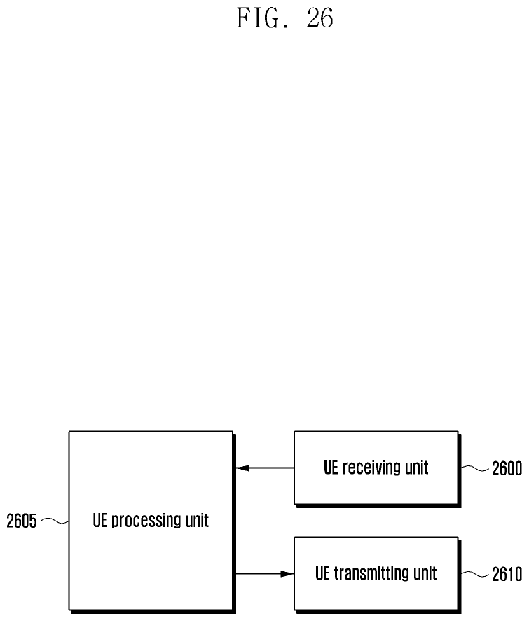

FIG. 26 illustrates the structure of a UE in a wireless communication system according to an embodiment of the disclosure.

Referring to FIG. 26, the UE may include a transceiver, which refers to a UE receiving unit 2600 and a UE transmitting unit 2610 as a whole, memory (not illustrated), and a UE processing unit 2605 (or UE controller or one or more processors). According to the above-described communication methods of the UE, the UE's transceiver 2600 and 2610, memory, and the UE processing unit 2605 may operate. Components of the UE are not limited to the above-described example. For example, the UE may include a larger or smaller number of components than the above-described components. Furthermore, the transceiver, the memory, and the processor may be implemented as a single chip.

The transceiver may transmit/receive signals with the base station. The signals may include control information and data. To this end, the transceiver may include an RF transmitter configured to up-convert and amplify the frequency of transmitted signals, an RF receiver configured to low-noise-amplify received signals and down-convert the frequency thereof, and the like. This is only an embodiment of the transceiver, and the components of the transceiver are not limited to the RF transmitter and the RF receiver.

In addition, the transceiver may receive signals through a radio channel, output the same to the processor, and transmit signals output from the processor through the radio channel.

The memory may store programs and data necessary for the UE's operations. In addition, the memory may store control information or data included in signals transmitted/received by the UE. The memory may include storage media such as a ROM, a RAM, a hard disk, a CD-ROM, and a DVD, or a combination of storage media. In addition, the UE may include multiple memories.

In addition, the processor may control a series of processes such that the UE can operate according to the above-described embodiments. For example, the processor may control components of the UE so as to receive DCI configured in two layers such that multiple PDSCHs are received simultaneously. The UE may include multiple processors, and the processors may perform the UE's component control operations by executing programs stored in the memory.

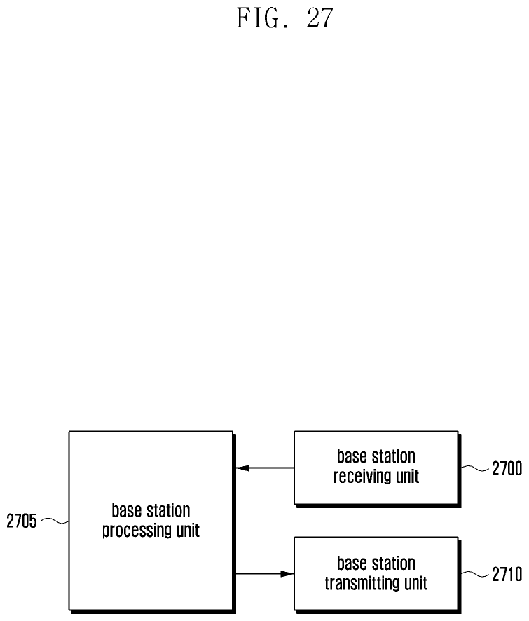

FIG. 27 illustrates the structure of a base station in a wireless communication system according to an embodiment of the disclosure.

Referring to FIG. 27, the base station may include a transceiver, which refers to a base station receiving unit 2700 and a base station transmitting unit 2710 as a whole, memory (not illustrated), and a base station processing unit 2705 (or base station controller or one or more processors). According to the above-described communication methods of the base station, the base station's transceiver 2700 and 2710, memory, and the base station processing unit 2705 may operate. Components of the base station are not limited to the above-described example. For example, the base station may include a larger or smaller number of components than the above-described components. Furthermore, the transceiver, the memory, and the processor may be implemented as a single chip.

The transceiver may transmit/receive signals with the UE. The signals may include control information and data. To this end, the transceiver may include an RF transmitter configured to up-convert and amplify the frequency of transmitted signals, an RF receiver configured to low-noise-amplify received signals and down-convert the frequency thereof, and the like. This is only an embodiment of the transceiver, and the components of the transceiver are not limited to the RF transmitter and the RF receiver.

In addition, the transceiver may receive signals through a radio channel, output the same to the processor, and transmit signals output from the processor through the radio channel.

The memory may store programs and data necessary for the base station's operations. In addition, the memory may store control information or data included in signals transmitted/received by the base station. The memory may include storage media such as a read only memory (ROM), a random access memory (RAM), a hard disk, a compact disc-ROM (CD-ROM), and a digital versatile disc (DVD), or a combination of storage media. In addition, the base station may include multiple memories.

The processor may control a series of processes such that the base station can operate according to the above-described embodiments of the disclosure. For example, the processor may control components of the base station so as to configure DCI configured in two layers including allocation information regarding multiple PDSCHs and to transmit the same. The base station may include multiple processors, and the processors may perform the base station's component control operations by executing programs stored in the memory.

Methods disclosed in the claims and/or methods according to the embodiments described in the specification of the disclosure may be implemented by hardware, software, or a combination of hardware and software.

When the methods are implemented by software, a computer-readable storage medium for storing one or more programs (software modules) may be provided. The one or more programs stored in the computer-readable storage medium may be configured for execution by one or more processors within the electronic device. The at least one program may include instructions that cause the electronic device to perform the methods according to various embodiments of the disclosure as defined by the appended claims and/or disclosed herein.

The programs (software modules or software) may be stored in non-volatile memories including a random access memory and a flash memory, a read only memory (ROM), an electrically erasable programmable read only memory (EEPROM), a magnetic disc storage device, a compact disc-ROM (CD-ROM), digital versatile discs (DVDs), or other type optical storage devices, or a magnetic cassette. Alternatively, any combination of some or all of them may form memory in which the program is stored. Furthermore, a plurality of such memories may be included in the electronic device.

In addition, the programs may be stored in an attachable storage device which may access the electronic device through communication networks such as the Internet, Intranet, Local Area Network (LAN), Wide LAN (WLAN), and Storage Area Network (SAN) or a combination thereof. Such a storage device may access the electronic device via an external port. Furthermore, a separate storage device on the communication network may access a portable electronic device.

In the above-described detailed embodiments of the disclosure, an element included in the disclosure is expressed in the singular or the plural according to presented detailed embodiments. However, the singular form or plural form is selected appropriately to the presented situation for the convenience of description, and the disclosure is not limited by elements expressed in the singular or the plural. Therefore, either an element expressed in the plural may also include a single element or an element expressed in the singular may also include multiple elements.

The embodiments of the disclosure described and shown in the specification and the drawings have been presented to easily explain the technical contents of the disclosure and help understanding of the disclosure, and are not intended to limit the scope of the disclosure. That is, it will be apparent to those skilled in the art that other variants based on the technical idea of the disclosure may be implemented. Furthermore, the above respective embodiments may be employed in combination, as necessary. For example, one embodiment of the disclosure may be partially combined with other embodiments to operate a base station and a terminal. As an example, embodiment 1 and 2 of the disclosure may be combined with each other to operate a base station and a terminal. Moreover, although the above embodiments have been described based on the frequency division duplex (FDD) LTE system, other variants based on the technical idea of the embodiments may also be implemented in other systems such as time division duplex (TDD) LTE, 5G, and NR systems.

In the drawings in which methods of the disclosure are described, the order of the description does not always correspond to the order in which steps of each method are performed, and the order relationship between the steps may be changed or the steps may be performed in parallel.

Alternatively, in the drawings in which methods of the disclosure are described, some elements may be omitted and only some elements may be included therein without departing from the essential spirit and scope of the disclosure.

Furthermore, in methods of the disclosure, some or all of the contents of each embodiment may be implemented in combination without departing from the essential spirit and scope of the disclosure.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device, cause the electronic device to perform a method of the disclosure.

Any such software may be stored in the form of volatile or non-volatile storage such as, for example, a storage device like read only memory (ROM), whether erasable or rewritable or not, or in the form of memory such as, for example, random access memory (RAM), memory chips, device or integrated circuits or on an optically or magnetically readable medium such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method performed by a user equipment (UE) in a communication system, the method comprising:
receiving a medium access control (MAC) control element (CE), wherein the MAC CE maps transmission configuration indication (TCI) states to codepoints of a TCI field in downlink control information (DCI);
receiving the DCI including the TCI field;
identifying, based on the MAC CE, whether at least one of a first TCI state of the UE and a second TCI state of the UE is updated by a codepoint of the TCI field in the received DCI; and
in case that one of the first TCI state and the second TCI state is identified as updated by the codepoint:
updating the one of the first TCI state and the second TCI state that is identified as updated by the codepoint, and
keeping other of the first TCI state and the second TCI state that is identified as not updated by the codepoint.

2. The method of claim 1, wherein each of the codepoints is mapped to (i) one TCI state for the one of the first TCI state and the second TCI state or (ii) two TCI states respectively for the first TCI state and the second TCI state.

3. The method of claim 1, wherein in case that the codepoint is mapped to one TCI state for the one of the first TCI state and the second TCI state:
the one of the first TCI state and the second TCI state is updated as the one TCI state; and
the other of the first TCI state and the second TCI state is kept.

4. The method of claim 1, further comprising:
receiving, via higher layer signaling, a configuration of a unified TCI state type indicating joint or separate,
wherein in case that the configuration of unified TCI state type indicates joint:
the TCI states are joint TCI states for uplink (UL) and downlink (DL) operation, and
the first TCI state and the second TCI state are associated with the joint TCI states.

5. The method of claim 4, wherein in case that the configuration of unified TCI state type indicates separate:
the TCI states include DL TCI states for the DL operation and UL TCI states for UL operation;
the first TCI state is associated with the DL TCI states or the UL TCI states; and
the second TCI state is associated with the DL TCI states or the UL TCI states.

6. The method of claim 1, further comprising:
transmitting a hybrid automatic repeat request acknowledgement (HARQ-ACK) for the DCI on a physical uplink control channel (PUCCH),
wherein the updating of the one of the first TCI state and the second TCI state and keeping of the other of the first TCI state and the second TCI state are applied starting from a first slot that is at least symbols corresponding to a beam application time after a last symbol of the PUCCH.

7. A user equipment (UE) in a communication system, the UE comprising:
a transceiver;
memory storing one or more computer programs; and
one or more processors operably coupled to the transceiver, and the memory,
wherein the one or more computer programs include computer-executable instructions that, when executed by the one or more processors, cause the UE to:
receive a medium access control (MAC) control element (CE), wherein the MAC CE maps transmission configuration indication (TCI) states to codepoints of a TCI field in downlink control information (DCI),
receive the DCI including the TCI field,
identify, based on the MAC CE, whether at least one of a first TCI state of the UE and a second TCI state of the UE is updated by a codepoint of the TCI field in the received DCI, and
in case that one of the first TCI state and the second TCI state is identified as updated by the codepoint:
update the one of the first TCI state and the second TCI state that is identified as updated by the codepoint, and
keep other of the first TCI state and the second TCI state that is identified as not updated by the codepoint.

8. The UE of claim 7, wherein each of the codepoints is mapped to (i) one TCI state for the one of the first TCI state and the second TCI state or (ii) two TCI states respectively for the first TCI state and the second TCI state.

9. The UE of claim 7, wherein in case that the codepoint is mapped to one TCI state for the one of the first TCI state and the second TCI state:
the one of the first TCI state and the second TCI state is updated as the one TCI state; and
the other of the first TCI state and the second TCI state is kept.

10. The UE of claim 7,
wherein the one or more computer programs further include computer-executable instructions that, when executed by the one or more processors, cause the UE to receive, via higher layer signaling, a configuration of a unified TCI state type indicating joint or separate, and
wherein in case that the configuration of unified TCI state type indicates joint:
the TCI states are joint TCI states for uplink (UL) and downlink (DL) operation, and
the first TCI state and the second TCI state are associated with the joint TCI states.

11. The UE of claim 10, wherein in case that the configuration of unified TCI state type indicates separate:
the TCI states include DL TCI states for the DL operation and UL TCI states for UL operation;
the first TCI state is associated with the DL TCI states or the UL TCI states; and
the second TCI state is associated with the DL TCI states or the UL TCI states.

12. The UE of claim 7,
wherein the one or more computer programs further include computer-executable instructions that, when executed by the one or more processors, cause the UE to transmit a hybrid automatic repeat request acknowledgement (HARQ-ACK) for the DCI on a physical uplink control channel (PUCCH), and
wherein the updating of the one of the first TCI state and the second TCI state and the keeping of the other of the first TCI state and the second TCI state are applied starting from a first slot that is at least symbols corresponding to a beam application time after a last symbol of the PUCCH.

13. A method performed by a base station in a communication system, the method comprising:
transmitting, to a user equipment (UE), a medium access control (MAC) control element (CE), wherein the MAC CE maps transmission configuration indication (TCI) states to codepoints of a TCI field in downlink control information (DCI);
transmitting, to the UE, the DCI including the TCI field; and
in case that one of a first TCI state of the UE and a second TCI state of the UE is updated by a codepoint of the TCI field in the transmitted DCI:
updating the one of the first TCI state and the second TCI state that is updated by the codepoint, and
keeping other of the first TCI state and the second TCI state that is not updated by the codepoint.

14. The method of claim 13, wherein each of the codepoints is mapped to (i) one TCI state for the one of the first TCI state and the second TCI state or (ii) two TCI states respectively for the first TCI state and the second TCI state.

15. The method of claim 13, wherein in case that the codepoint is mapped to one TCI state for the one of the first TCI state and the second TCI state:
the one of the first TCI state and the second TCI state is updated as the one TCI state; and
the other of the first TCI state and the second TCI state is kept.

16. The method of claim 13, further comprising:
transmitting, to the UE via higher layer signaling, a configuration of a unified TCI state type indicating joint or separate,
wherein in case that the configuration of unified TCI state type indicates joint:
the TCI states are joint TCI states for uplink (UL) and downlink (DL) operation, and
the first TCI state and the second TCI state are associated with the joint TCI states.

17. A base station in a communication system, the base station comprising:
a transceiver;
memory storing one or more computer programs; and
one or more processors operably coupled to the transceiver, and the memory,
wherein the one or more computer programs include computer-executable instructions that, when executed by the one or more processors, cause the base station to:
transmit, to a user equipment (UE), a medium access control (MAC) control element (CE), wherein the MAC CE maps transmission configuration indication (TCI) states to codepoints of a TCI field in downlink control information (DCI),
transmit, to the UE, the DCI including the TCI field, and
in case that one of a first TCI state of the UE and a second TCI state of the UE is updated by a codepoint of the TCI field in the transmitted DCI:
update the one of the first TCI state and the second TCI state that is updated by the codepoint, and
keep other of the first TCI state and the second TCI state that is not updated by the codepoint.

18. The base station of claim 17, wherein each of the codepoints is mapped to (i) one TCI state for the one of the first TCI state and the second TCI state or (ii) two TCI states respectively for the first TCI state and the second TCI state.

19. The base station of claim 17, wherein in case that the codepoint is mapped to one TCI state for the one of the first TCI state and the second TCI state:
the one of the first TCI state and the second TCI state is updated as the one TCI state; and
the other of the first TCI state and the second TCI state is kept.

20. The base station of claim 17,
wherein the one or more computer programs further include computer-executable instructions that, when executed by the one or more processors, cause the base station to transmit, to the UE via higher layer signaling, a configuration of a unified TCI state type indicating joint or separate, and
wherein in case that the configuration of unified TCI state type indicates joint:
the TCI states are joint TCI states for uplink (UL) and downlink (DL) operation, and
the first TCI state and the second TCI state are associated with the joint TCI states.
